(19) United States
(12) Patent Application Publication
(10) Pub. No.: US 2025/0363391 A1
(43) Pub. Date: Nov. 27, 2025

(54) SYSTEMS AND METHOD FOR GENERATING AND USING ONTOGENETIC ARTIFICIAL INTELLIGENCE DNA

(71) Applicant: Eagle Technology, LLC, Melbourne, FL (US)

(72) Inventors: Wayne Smith, Melbourne Beach, FL (US); Ronda Henning, West Melbourne, FL (US); Kevin Fox, Palm Bay, FL (US); Donna M. Kocak, Satellite Beach, FL (US)

(21) Appl. No.: 18/674,056

(22) Filed: May 24, 2024

(51) Int. Cl. G06N 3/123

(52) U.S. Cl. CPC G06N 3/123

(57) ABSTRACT

Systems and methods for controlling operations of an electronic device. The methods comprising: obtaining, by a processor, a first AI DNA structure and a second AI DNA structure (each of the first and second AI DNA structures comprising at least one branch defined by data objects connected to each other by one or more links, at least one of said data objects in said branch specifying one or more actions of the electronic device that were determined by an ontogenesis engine in view of a stimuli or an impingement action); analyzing, by the processor, human or other AI system, the first AI DNA structure and second AI DNA structure to detect differences therebetween; selectively editing, by the processor, the first AI DNA structure based on the differences; and using the first AI DNA structure, which has been selectively edited, to control, modify or advance AI operations of the ontogenesis engine.

### BACKGROUND

### Statement of the Technical Field

The present disclosure relates to computer systems. More particularly, the present disclosure concerns methods and systems for generating and using ontogenetic artificial intelligence DNA.

### DESCRIPTION OF THE RELATED ART

Many organizations are conducting research and experimentation related to cognitive engines. The idea is to limit, minimize and/or augment human involvement in correlation and increase computer and/or computationally intelligence contributions for routine or mundane tasks such as scrolling through large volumes of real time data.

### SUMMARY

The present disclosure concerns implementing systems and methods for controlling operations of an electronic device. The methods comprise: obtaining, by a processor, a first artificial intelligence DNA structure and a second artificial intelligence DNA structure (wherein each of the first and second artificial intelligence DNA structures comprises at least one branch defined by data objects connected to each other by one or more links, and at least one of said data objects in said branch specifying one or more actions of the electronic device that were determined by an ontogenesis engine in view of a stimuli or an impingement action); analyzing, by the processor, the first artificial intelligence DNA structure and the second artificial intelligence DNA structure to detect any differences therebetween; selectively editing, by the processor, the first artificial intelligence DNA structure based on the differences; and using the first artificial intelligence DNA structure, which has been selectively edited, to control, modify or advance artificial intelligence operations of the ontogenesis engine.

The present document also concerns a system comprising: a processor; and a non-transitory computer-readable storage medium comprising programming instructions that are configured to cause the processor to implement a method controlling operations of an electronic device. The programming instructions comprise instructions to: obtain a first artificial intelligence DNA structure and a second artificial intelligence DNA structure (wherein each of the first and second artificial intelligence DNA structures comprising at least one branch defined by data objects connected to each other by one or more links, at least one of said data objects in said branch specifying one or more actions of the electronic device that were determined by an ontogenesis engine in view of a stimuli or an impingement action); analyze the first artificial intelligence DNA structure and the second artificial intelligence DNA structure to detect any differences therebetween; selectively edit the first artificial intelligence DNA structure based on the differences; and use the first artificial intelligence DNA structure, which has been selectively edited, to control, modify or advance artificial intelligence operations of the ontogenesis engine.

### BRIEF DESCRIPTION OF THE DRAWINGS

The present solution will be described with reference to the following drawing figures, in which like numerals represent like items throughout the figures.

FIG. 1 is an example of a computer network.

FIG. 2 is an example of a module that can be used in the present solution for performing certain manipulations of IDentity Parameters (IDPs).

FIG. 3 is a drawing that is useful for understanding a tool that can be used to help characterize the network in FIG. 1.

FIG. 4 is an example of a dialog box of a graphical user interface that can be used to select dynamic settings for modules in FIG. 1.

FIG. 5 is an example of a dialog box of a graphical user interface that can be used to select a sequence of active states and bypass states associated with each module in FIG. 1.

FIG. 6 is a diagram that is useful for understanding the way in which a mission plan can be communicated to a plurality of modules in the network in FIG. 1.

FIG. 7 is an example of a dialog box of a graphical user interface that can be used to select a mission plan and communicate the mission plan to the modules as shown in FIG. 6.

FIG. 8 is a flowchart that is useful for understanding the operation of a module in FIG. 1.

FIG. 9 is a flowchart that is useful for understanding the operation of a Network Control Software Application (NCSA) in relation to creating and loading mission plans.

FIG. 10 is a block diagram of a computer architecture that can be used to implement the modules in FIG. 1.

FIG. 11 is a block diagram of a computer architecture that can be used to implement the Network Administration Computer (NAC) in FIG. 1.

FIG. 12 is a flowchart that is useful for understanding the operation of a bridge in FIG. 1.

FIG. 13 is a table that is useful for understanding some of the types of IDPs that can be modified.

FIG. 14 is a schematic illustration of an exemplary system employing cyber behavior models to define and manage mission models.

FIG. 15 is a schematic illustration of an exemplary mission objective.

FIG. 16 is a schematic illustration of an exemplary cyber behavior model.

FIG. 17 is a schematic illustration that is useful for understanding how a mission plan is generated based on at least one cyber behavior model.

FIG. 18 is a schematic illustration that is useful for understanding how cyber behavior models are stored in a datastore.

FIG. 19 is a schematic illustration of an exemplary graphical user interface for selecting mission objectives, tactics, tenets and cyber maneuvers.

FIG. 20 is a schematic illustration of an exemplary graphical user interface that is useful for specifying times at which certain behavior classes should be employed.

FIG. 21 is a schematic illustration of an exemplary mission plan.

FIG. 22 is an illustration of an exemplary computer device.

FIG. 23 provides an illustration that is useful for understanding operations performed by an ontogenesis engine.

FIG. 24 provides an illustration of an illustrative module architecture for the ontogenesis engine.

FIG. 25 provides an illustration of an illustrative architecture for an ontogenesis memory object.

FIG. 26 provides a flow diagram of an illustrative method for operating a network system in accordance with the present solution.

FIG. 27 provides an illustration of a system for generating and using ontogenetic artificial intelligence DNA.

FIG. 28 provides an illustration showing groups to which ontogenetic AI DNA structures can be arranged or assigned.

FIG. 29 provides a more detailed illustration of a DNA fabrication engine.

FIG. 30 provides an illustration that is useful for understanding operations of an ontogenetic AI DNA engine.

FIGS. 31-33 each provide illustrations of a DNA AI intelligence structure.

FIG. 34 provides an illustration that is useful for understanding a behavior data object of a DNA AI intelligence structure.

FIG. 35 provides a flow diagram of an illustrative method for operating an AI system.

FIGS. 36A-36B (collectively referred to herein as “FIG. 36”) provides a flow diagram of an illustrative method for fabricating or otherwise creating a DNA AI intelligence structure.

FIG. 37 provides a flow diagram of an illustrative method for controlling operations of an electronic device in accordance with the present solution.

FIG. 38 provides an illustration of an electronic device implementing the present solution.

FIGS. 39-40 provide illustrations that show DNA editing engine(s) in more detail.

FIG. 41 provides an illustration showing an AI DNA intelligence genealogy layer including DNA math for editing and structure with editing demarcations.

FIGS. 42-46 provide illustrations that are useful for understanding editing of a DNA structure by DNA editor(s) of DNA editing engine(s).

FIG. 47 provides a flow diagram of an illustrative method for analyzing and/or editing an AI DNA structure and controlling an AI system using the same.

FIG. 48 provides a block diagram of an illustrative robotic system implementing the present solution.

### DETAILED DESCRIPTION

The present solution is described with reference to the attached figures. The figures are not drawn to scale and they are provided merely to illustrate the instant solution. Several aspects of the present solution are described below with reference to example applications for illustration. It should be understood that numerous specific details, relationships, and methods are set forth to provide a full understanding of the present solution. One having ordinary skill in the relevant art, however, will readily recognize that the present solution can be practiced without one or more of the specific details or with other methods. In other instances, well-known structures or operations are not shown in detail to avoid obscuring the present solution. The present solution is not limited by the illustrated ordering of acts or events, as some acts may occur in different orders and/or concurrently with other acts or events. Furthermore, not all illustrated acts or events are required to implement a methodology in accordance with the present solution.

It should also be appreciated that the terminology used herein is for the purpose of describing particular embodiments only and is not intended to be limiting of the present solution. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Further, unless otherwise defined, all terms (including technical and scientific terms) used herein have the same meaning as commonly understood by one of ordinary skill in the art to which this solution belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Identity Agile Computer Network

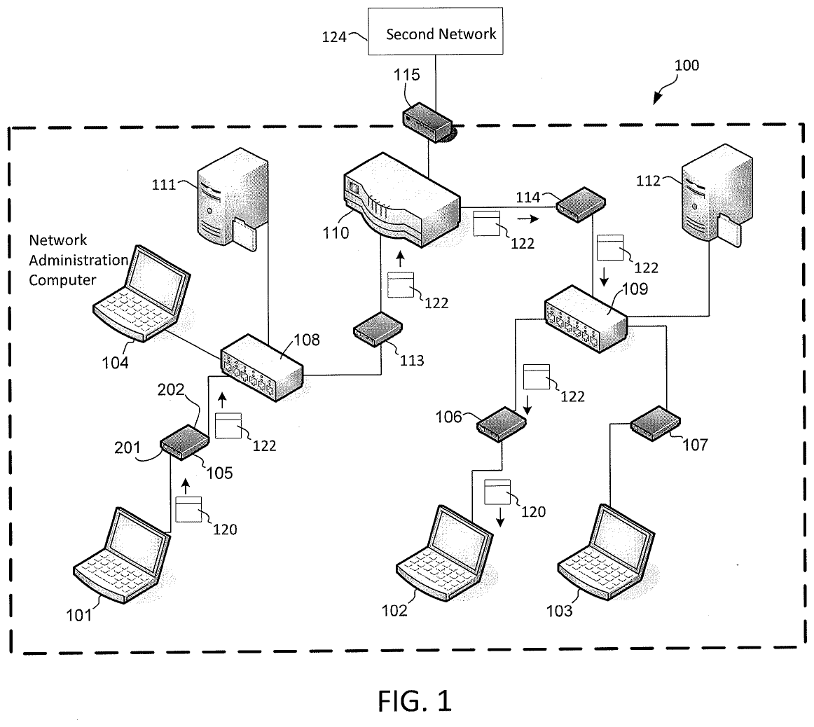

Referring now to FIG. 1, there is shown a diagram of an exemplary network 100 which includes a plurality of computing devices. The computing devices can include client computers 101-103, Network Administration Computer (“NAC”) 104, servers 111, 112, network hubs 108, 109, router 110, and a bridge 115. The client computers can be any type of computing device which might require network services, such as a conventional tablet, notebook, laptop or desktop computer. The router 110 can be a conventional routing device that forwards data packets between computer networks. The hubs 108, 109 are conventional hub devices (e.g. an Ethernet hub) as are well known in the art. Servers 111, 112 can provide various computing services utilized by client computers 101-103. For example, the servers 111, 112 can be file servers which provide a location for shared storage of computer files used by client computers 101-103.

The communication media for the network 100 can be wired, wireless or both, but shall be described herein as a wired network for simplicity and to avoid obscuring the present solution. The network will communicate data using a communication protocol. As is well known in the art, the communication protocol defines the formats and rules used for communicating data throughout the network. The network in FIG. 1 can use any communication protocol or combination of protocols which is now known or known in the future. For example, the network can use the well known Ethernet protocol suite for such communications. Alternatively, the network can make use of other protocols, such as the Internet Protocol Suite (often referred to as TCP/IP), SONET/SDH, or Asynchronous Transfer Mode (“ATM”) communication protocols. In some scenarios, one or more of these communication protocols can be used in combination. Although one network topology is shown in FIG. 1, the present solution is not limited in this regard. Instead, any type of suitable network topology can be used, such as a bus network, a star network, a ring network or a mesh network.

The present solution generally concerns a method for communicating data in a computer network (e.g., in computer network 100), where data is communicated from a first computing device to a second computing device. Computing devices within the network are represented with multiple IDPs. The terms “identity parameters” and “IDPs”, as used herein, can include items such as an IP address, a Media Access Control (“MAC”) address, ports and so on. However, the present solution is not limited in this regard, and IDPs can also include a variety of other information which is useful for characterizing a network node. The various types of IDPs contemplated herein are discussed below in further detail. The present solution involves the use of dynamically controlled behavior models and/or Moving Target Technology (“MTT”) to manipulate one or more of such IDPs for one or more computing devices within the network. This technique disguises communication patterns and network address of such computing devices. The manipulation of IDPs as described herein is generally performed in conjunction with data communications in the network, i.e. when data is to be communicated from a first computer in the network (e.g. client computer 101) to a second computer in the network (e.g., client computer 102). Accordingly, IDPs that are manipulated can include those of a source computing device (the device from which the data originated) and the destination computing device (the device to which the data is being sent). The set of IDPs that are communicated is referred to herein as an IDP set. This concept is illustrated in FIG. 1, which shows that an IDP set 120 is transmitted by client computer 101 as part of a data packet (not shown).

The process according to the inventive arrangements involves selectively modifying at a first location within the computer network, values contained in a data packet or datagram which specify one or more identify parameters of a source and/or destination computing device. The IDPs are modified in accordance with a mission plan. The location where such modification is performed will generally coincide with the location of one of the modules 105-107, 113, 114. Referring once again to FIG. 1, it can be observed that modules 105, 106, 107, 113, 114 are interposed in the network between the various computing devices which comprise nodes in such network. In these locations, the modules intercept data packet communications, perform the necessary manipulations of IDPs, and retransmit the data packets along a transmission path. In alternative scenarios, the modules 105, 106, 107, 113, 114 can perform a similar function, but can be integrated directly into one or more of the computing devices. For example, the modules could be integrated into client computers 101, 102, 103, servers 111, 112, hubs 108, 109 and/or within router 110.

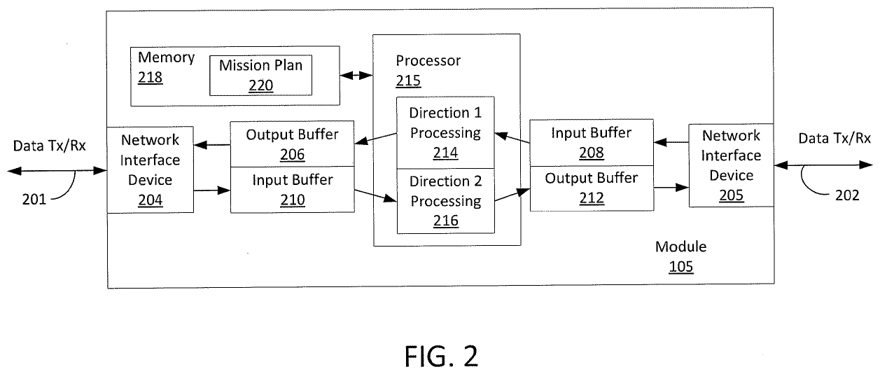

An example of a functional block diagram of a module 105 is shown in FIG. 2. Modules 106-107, 113, 114 can have a similar functional block diagram, but it should be understood that the present solution is not limited in this regard.

As shown in FIG. 2, the module 105 has at least two data ports 201, 202, each of which can correspond to a respective network interface device 204, 205. Data received at port 201 is processed at network interface device 204 and temporarily stored at an input buffer 210. The processor 215 accesses the input data packets contained in input buffer 210 and performs any necessary manipulation of IDPs as described herein. The modified data packets are passed to output buffer 212 and subsequently transmitted from port 202 using network interface device 205. Similarly, data received at port 202 is processed at network interface device 205 and temporarily stored at an input buffer 208. The processor 215 accesses the input data packets contained in input buffer 208 and performs any necessary manipulation of IDPs as described herein. The modified data packets are passed to output buffer 206 and subsequently transmitted from port 201 using network interface device 204. In each module, manipulation of IDPs is performed by processor 215 in accordance with a mission plan 220 stored in a memory 218.

It will be understood from FIG. 2 that a module is preferably configured so that it operates bi-directionally. In such scenarios, the module can implement different modification functions, depending on a source of a particular data packet. The dynamic modification function in each module can be specified in the mission plan in accordance with a source computing device of a particular data packet. Modules can determine a source of data packets by any suitable means. For example, a source address of a data packet can be used for this purpose.

At a selected module within the network 100, processor 215 will determine one or more false IDP values that are to be used in place of the true IDP values. The processor will transform one or more true IDP values to one or more false IDP values which are preferably specified by a pseudorandom function. Following this transformation, the module will forward the modified packet or datagram to the next node of the network along a transmission path. At subsequent points in the communication path, an adversary who is monitoring such network communications will observe false or incorrect information about the identity of computing devices communicating on the network.

In one scenario, the false IDPs that are specified by the pseudorandom function are varied in accordance with the occurrence of one or more trigger events. The trigger event causes the processor 215 to use the pseudorandom function to generate a new set of false IDP values into which the true IDPs are transformed. Accordingly, the trigger event serves as a basis for the dynamic variation of the false IDPs described herein. Trigger events are discussed in more detail below. However, it should be noted that trigger events for selecting a new set of false values for IDPs can be based on the passage of time and/or the occurrence of certain network events. Trigger events can also be initiated by a user command.

The transformation of IDPs described above provides one way to maneuver a computer network 100 for purposes of thwarting a cyber attack, responding to adversarial probing, or thwart adversaries' understanding of a network architecture. In some scenarios, the mission plan 220 implemented by processor 215 will also control certain other aspects of the manner in which computer network can maneuver. For example, the mission plan can specify that a dynamic selection of IDPs are manipulated. The dynamic selection can include a choice of which IDPs are selected for modification, and/or a number of such IDPs that are selected. This variable selection process provides an added dimension of uncertainty or variation which can be used to further thwart an adversary's effort to infiltrate or learn about a computer network 100. As an example of this technique, consider that during a first time period, a module can modify a destination IP address and a destination MAC address of each data packet. During a second time period the module could manipulate the source IP address and a source host name in each data packet. During a third period of time the module could manipulate a source port number and a source user name. Changes in the selection of IDPs can occur synchronously (all selected IDPs are changed at the same time). Alternatively, changes in the selection of IDPs can occur asynchronously (the group of selected IDPs changes incrementally as individual IDPs are added or removed from the group of selected IDPs).

A pseudorandom function is preferably used for determining the selection of identity values that are to be manipulated or transformed into false values. In other words, the module will transform only the IDPs selected by the pseudo-random function. In some scenarios, the selection of IDPs that are specified by the pseudorandom function is varied in accordance with the occurrence of a trigger event. The trigger event causes processor 215 use a pseudorandom function to generate a new selection of IDPs which are to be transformed into false IDPs. Accordingly, the trigger event serves as a basis for the dynamic variation of the selection of IDPs described herein. Notably, the values of the IDPs can also be varied in accordance with pseudorandom algorithm.

The modules are advantageously capable of also providing a third method of maneuvering the computer network for purposes of thwarting a cyber attack. Specifically, the mission plan loaded in each module can dynamically vary the location within the network where the modification or transformation of the IDPs takes place. Consider that modification of IDPs in an IDP set 120 sent from client computer 101 to client computer 102, could occur in module 105. This condition is shown in FIG. 1, where the IDPs contained in IDP set 120 are manipulated in module 105 so that IDP set 120 is transformed to a new or modified IDP set 122. At least some of the IDPs in IDP set 122 are different as compared to the IDPs in IDP set 120. But the location where such transformation occurs is preferably also controlled by the mission plan. Accordingly, manipulation of IDP set 120 could, for example, sometimes occur at module 113 or 114, instead of at module 105. This ability to selectively vary the location where manipulation of IDPs occurs adds a further important dimension to the maneuvering capability of the computer network.

The dynamic variation in the location where IDPs are modified is facilitated by selectively controlling an operating state of each module. To that end, the operational states of each module preferably includes (1) an active state in which data is processed in accordance with a current mission plan, and (2) a by-pass state in which packets can flow through the module as if the module was not present. The location where the dynamic modification is performed is controlled by selectively causing certain modules to be in an active state and certain modules to be in a standby state. The location can be dynamically changed by dynamically varying the current state of the modules in a coordinated manner.

The mission plan can include predefined sequence for determining the locations within the computer network 100 where IDPs are to be manipulated. Locations where IDPs are to be manipulated will change in accordance with the sequence at times indicated by a trigger event. For example, the trigger event can cause a transition to a new location for manipulation or transformation of IDPs as described herein. Accordingly, the trigger event serves as a basis for the occurrence of a change in the location where IDPs are modified, and the predefined sequence determines where the new location will be.

From the foregoing, it will be appreciated that a data packet is modified at a module to include false IDPs. At some point within the computer network, it is necessary to restore the IDPs to their true values, so that the IDPs can be used to properly perform their intended function in accordance with the particular network protocol. Accordingly, the present solution also includes dynamically modifying, at a second location (i.e., a second module), the assigned values for the IDPs in accordance with the mission plan. The modification at the second location essentially comprises an inverse of a process used at the first location to modify the IDPs. The module at the second location can thus restore or transform the false value IDPs back to their true values. In order to accomplish this action, the module at the second location must be able to determine at least (1) a selection of IDP value(s) that is (are) to be transformed, and (2) a correct transformation of the selected IDPs from false values to true values. In effect, this process involves an inverse of the pseudorandom process or processes used to determine the IDP selection and the changes effected to such IDP values. The inverse transformation step is illustrated in FIG. 1, where the IDP set 122 is received at module 106, and the IDP values in IDP set 122 are transformed or manipulated back to their original or true values. In this scenario, module 106 converts the IDP values back to those of IDP set 120.

Notably, a module must have some way of determining the proper transformation or manipulation to apply to each data communication it receives. In some scenarios, this determination is performed by examining at least a source address IDP contained within the received data communication. For example, the source address IDP can include an IP address of a source computing device. Once the true identity of the source computing device is known, the module consults the mission plan (or information derived from the mission plan) to determine what actions it needs to take. For example, these actions could include converting certain true IDP values to false IDP values. Alternatively, these changes could include converting false IDP values back to true IDP values.

Notably, there will be instances where the source address IDP information contained in a received data communication has been changed to a false value. In those circumstances, the module receiving the data communication will not immediately be able to determine the identity of the source of the data communication. However, the module which received the communication can in such instances still identify the source computing device. This is accomplished at the receiving module by comparing the false source address IDP value to a Look-Up-Table (“LUT”) which lists all such false source address IDP values in use during a particular time. The LUT also includes a list of true source address IDP values that correspond to the false source address values. The LUT can be provided directly by the mission plan or can be generated by information contained within the mission plan. In either case, the identification of a true source address IDP value can be easily determined from the LUT. Once the true source address IDP has been determined, then the module which received the data communication can use this information to determine (based on the mission plan) what manipulations to the IDPs are needed.

Notably, the mission plan can also specify a variation in the second location where IDPs are restored to their true values. For example, assume that the IDPs are dynamically modified at a first location comprising module 105. The mission plan can specify that the restoration of the IDPs to their true values occurs at module 106 as described, but can alternatively specify that dynamic modification occur instead at module 113 or 114. In some scenarios, the location where such manipulations occur is dynamically determined by the mission plan in accordance with a predefined sequence. The predefined sequence can determine the sequence of locations or modules where the manipulation of IDPs will occur.

The transition involving dynamic modification at different locations preferably occurs in accordance with a trigger event. Accordingly, the predefined sequence determines the pattern or sequence of locations where data manipulations will occur, and the trigger event serves as a basis for causing the transition from one location to the next. Trigger events are discussed in more detail below; however, it should be noted that trigger events can be based on the passage of time, user control, and/or the occurrence of certain network events. Control over the choice of a second location (i.e., where IDPs are returned to their true values) can be effected in the same manner as described above with regard to the first location. Specifically, operating states of two or more modules can be toggled between an active state and a bypass state. Manipulation of IDPs will only occur in the module which has an active operating state. The module with a bypass operating state will simply pass data packets without modification.

Alternative methods can also be used for controlling the location where manipulation of IDPs will occur. For example, a network administrator can define in a mission plan several possible modules where IDPs can be converted from true values to false values. Upon the occurrence of a trigger event, a new location can be selected from among the several modules by using a pseudorandom function, and using a trigger time as a seed value for the pseudorandom function. If each module implements the same pseudorandom function using the same initial seed values then each module will calculate the same pseudorandom value. The trigger time can be determined based on a clock time, such as a GPS time or system clock time). In this way, each module can independently determine whether it is currently an active location where manipulation of IDPs should occur. Similarly, the network administrator can define in a mission plan several possible modules where dynamic manipulation returns the IDPs to their correct or true values. The selection of which module is used for this purpose can also be determined in accordance with a trigger time and a pseudorandom function as described herein. Other methods are also possible for determining the location or module where IDP manipulations are to occur. Accordingly, the present solution is not intended to be limited to the particular methods described herein.

Notably, varying the position of the first and/or second locations where identity functions are manipulated will often result in varying a physical distance between the first and second location along a network communication path. The distance between the first and second locations is referred to herein as a distance vector. The distance vector can be an actual physical distance along a communication path between the first and second location. However, it is useful to think of the distance vector as representing the number of network nodes that are present in a communication path between the first and second locations. It will be appreciated that dynamically choosing different position for the first and second locations within the network can have the effect of changing the number of nodes between the first and second locations. For example, in FIG. 1 the dynamic modification of IDPs is implemented in selected ones of the modules 105, 106, 107, 113, 114. The modules actually used to respectively implement the dynamic modification is determined as previously described. If module 105 is used for converting IDPs to false values and module 106 is used to convert them back to true values, then there are three network nodes 108, 110, 109 between modules 105 and 106. But if module 113 is used to convert to false values and module 114 is used to convert the IDPs back to true values, then there is only one network node 110 between modules 113 and 114. Accordingly, it will be appreciated that dynamically changing the position of locations where dynamic modification occurs can dynamically vary the distance vector. This variation of the distance vector provides an added dimension of variability to network maneuvering or modification as described herein.

In the present solution, the manipulation of IDP values, the selection of IDPs, and the locations where these IDPs are each defined as a maneuvering parameter. Whenever a change occurs in one of these three maneuvering parameters, it can be said that a network maneuver has occurred. Any time one of these three maneuvering parameters is changed, we can say that a network maneuver has occurred. In order to most effectively thwart an adversary's efforts to infiltrate a computer network 100, network maneuvering is preferably controlled by means of a pseudorandom process as previously described. Those skilled in the art will appreciate that a chaotic process can also be used for performing this function. Chaotic processes are technically different as compared to pseudorandom functions, but for purposes of the present solution, either can be used, and the two are considered equivalent. In some scenarios, the same pseudorandom process can be used for dynamically varying two or more of the maneuvering parameters. However, in some scenarios, two or more different pseudorandom processes are used so that two or more of these maneuvering parameters are modified independently of the others.

### Trigger Events

As noted above, the dynamic changes to each of the maneuvering parameters is controlled by at least one trigger. A trigger is an event that causes a change to occur in relation to the dynamic modifications described herein. Stated differently, it can be said that the trigger causes the network to maneuver in a new way that is different than at a previous time (i.e., before the occurrence of the trigger). For example, during a first period of time, a mission plan can cause an IP address can be changed from value A to value B; but after the trigger event, the IP address can instead be changed from value A to value C. Similarly, during a first period of time a mission plan can cause an IP and MAC address to be modified; but after the trigger event, the mission plan can instead cause a MAC address and username to be modified. As a third example, consider that during a first period of time a mission plan may cause IDPs to be changed when an ID set 120 arrives at module 105; but after the trigger event, can cause the IDPs to instead be changed when and ID set 120 arrives at module 113.

In its simplest form a trigger can be user activated or based on a simple timing scheme. In such scenarios, a clock time in each module could serve as a trigger. For example, a trigger event could be defined as occurring at the expiration of every sixty (60) second time interval. For such an arrangement, one or more of the maneuvering parameters could change every sixty (60) seconds in accordance with a predetermined clock time. In some scenarios, all of the maneuvering parameters can change concurrently so that the changes are synchronized. In a slightly more complex scenario, a time-based trigger arrangement can also be used, but a different unique trigger time interval can be selected for each maneuvering parameter. Thus, false IDP values could be changed at time interval X, a selection of IDPs would change in accordance with a time interval Y, and a location where such changes are performed would occur at time interval Z, where X, Y and Z are different values.

It will be appreciated that in scenarios which rely upon clock time as a trigger mechanism, it is advantageous to provide synchronization as between the clocks in various modules 105, 106, 107, 113, 114 to ensure that packets are not lost or dropped due to unrecognized IDPs. Synchronization methods are well known and any suitable synchronization mechanism can be used for this purpose. For example, the modules could be synchronized by using a highly accurate time reference such as a GPS clock time. Alternatively, a unique wireless synchronization signal could be broadcast to each of the modules from a central control facility.

Other types of triggers are also possible with the present solution. For example, trigger events can be based on the occurrence or detection of potential network security threats. According to the present solution, a potential network security threat can be identified by a network security software suite. Alternatively, the potential network security threat can be identified upon the receipt of a data packet at a module 105, 106, 107, 113, 114 where the packet contains one or more IDPs that are inconsistent with the present state of network maneuvering. Regardless of the basis for identifying a network security threat, the existence of such threat can serve as a trigger event. A trigger event based on a network security threat can cause the same types of network maneuvers as those caused by the time based triggers described above. For example, false IDPs, the selection of IDPs and the locations of IDP transformations could remain stable (i.e., unchanged) except in the case were a network security threat was detected. Such an arrangement might be chosen, for example, in computer networks where frequent network maneuvering is not desirable.

Alternatively, time based trigger events can be combined with trigger events based on potential threats to network security. In such scenarios, a trigger event based on a security threat can have a different effect on the network maneuvering as compared to time based triggers. For example, a security threat-based trigger event can cause strategic or defensive changes in the network maneuvering so as to more aggressively counter such network security threat. The precise nature of such measures can depend on the nature of the threat, but can include a variety of responses. For example, different pseudorandom algorithms can be selected, and/or the number of IDPs selected for manipulation in each IDP set 120 can be increased. In systems that already make use of time based triggers, the response can also include increasing a frequency of network maneuvering. Thus, more frequent changes can be made with respect to (1) the false IDP values, (2) the selection of IDPs to be changed in each IDP set, and/or (3) the position of the first and second locations where IDPs are changed. Accordingly, the network maneuvering described herein provides a method for identifying potential network security threats and responding to same.

### Mission Plans

According to the present solution, the network maneuvering described herein is controlled in accordance with a mission plan. A mission plan is a schema that defines and controls maneuverability within the context of a network and a security model. As such, the mission plan can be represented as a data file that is communicated from the NAC 104 to each module 105-107, 113-114. The mission plan is thereafter used by each module to control the manipulation of IDPs and coordinate its activities with the actions of the other modules in the network.

The mission plan can be modified from time to time by a network administrator to update or change the way in which the network maneuvers to thwart potential adversaries. As such, the mission plan provides a network administrator with a tool that facilitates complete control over the time, place and manner in which network maneuvering will occur within the network. Such update ability allows the network administrator to tailor the behavior of the computer network to the current operating conditions and more effectively thwart adversary efforts to infiltrate the network. Multiple mission plans can be defined by a user and stored so that they are accessible to modules within the network. For example, the multiple mission plans can be stored at NAC 104 and communicated to modules as needed. Alternatively, a plurality of mission plans can be stored on each module and can be activated as necessary or desirable to maintain security of the network. For example, if the network administrator determines or suspects that an adversary has discovered a current mission plan for a network, the administrator may wish to change the mission plan. Effective security procedures can also dictate that the mission plan be periodically changed.

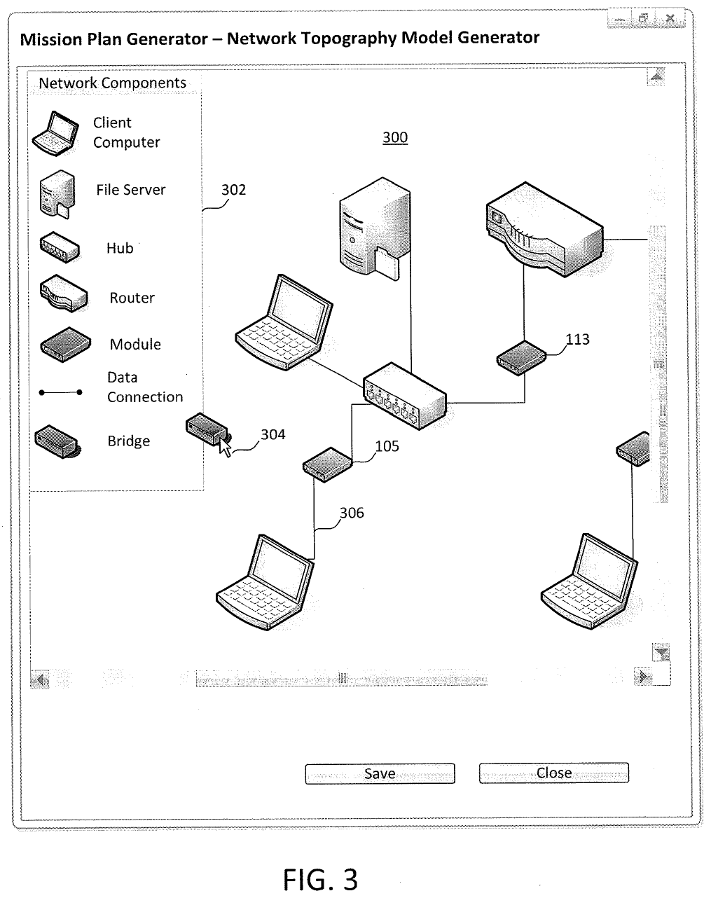

The process of creating a mission plan can begin by modeling the network 100. The creation of the model is facilitated by a Network Control Software Application (“NCSA”) executing on a computer or server at the network command center. For example, in the scenario shown in FIG. 1, the NCSA can execute on NAC 104. The network model preferably includes information which defines data connections and/or relationships between various computing devices included in the network 100. The NCSA will provide a suitable interface which facilitates entry of such relationship data. In some scenarios, the NCSA can facilitate entry of data into tables which can be used to define the mission plan. However, in some scenarios, a Graphic User Interface (“GUI”) is used to facilitate this process. Referring now to FIG. 3, the NCSA can include a network topography model generator tool. The tool is used to assist the network administrator in defining the relationship between each of the various components of the networks. The network topography tool provides a workspace 300 in which an administrator can drag and drop network components 302 by using a cursor 304. The network administrator can also create data connections 306 between various network components 302. As part of this modeling process, the network administrator can provide network address information for the various network components, including the modules 105-107, 113, 114.

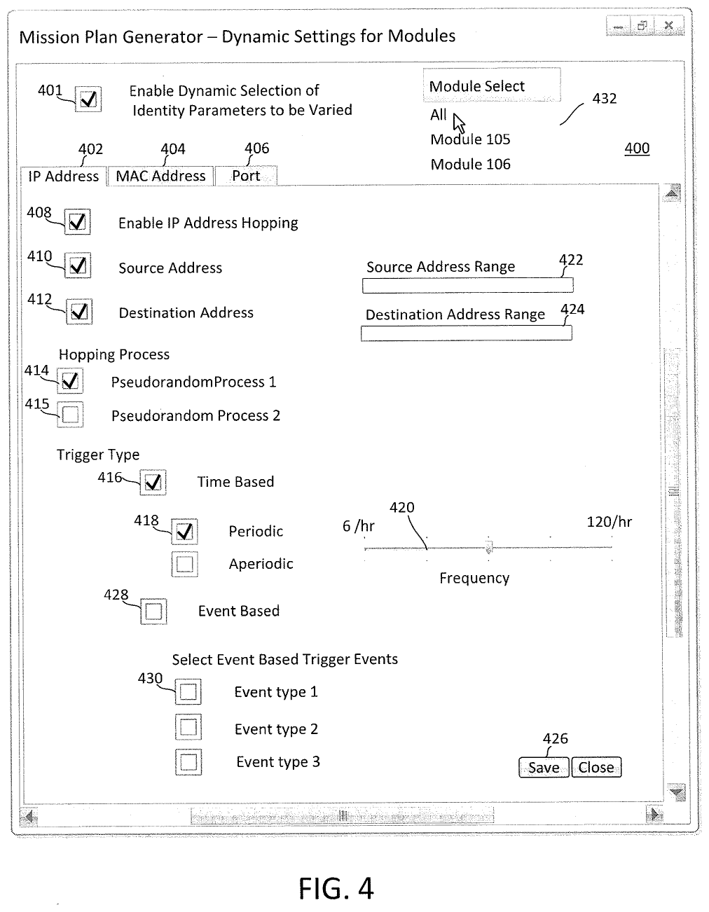

Once the network has been modeled, it can be saved and used by the network administrator to define the manner in which the various modules 105-107, 113, 114 behave and interact with one another. Referring now to FIG. 4, the NCSA can generate a dialog box 400 of which can be used to further develop a mission plan. A drop-down menu 432 can be used to select the particular module (e.g., module 105) to which the settings in dialog box 400 are to be applied. Alternatively, the network administrator can use drop-down menu 432 to indicate that the settings in dialog box 400 are intended to be applied to all modules within the network (e.g., by selecting “All” in menu 432). The process can continue by specifying whether a fixed set of IDPs will always be modified in each of the modules, or whether the set of IDPs that are manipulated shall be dynamically varied. If the selection or set of IDPs that are to be manipulated in the modules is intended to be dynamically varied, the network administrator can mark check-box 401 to indicate that preference. If the check-box 401 is not marked, that will indicate that the set of IDPs to be varied is a fixed set that does not vary over time.

The dialog box 400 includes tabs 402, 404, 406 which allow a user to select the particular IDP that he wants to work with for purposes of creating a mission plan. For purposes of this disclosure, the dialog box 400 facilitates dynamic variation of only three (3) IDPs. Specifically, these include the IP address, MAC address and Port Address. More or fewer IDPs can be dynamically varied by providing additional tabs, but the three IDPs noted are sufficient to explain the inventive concepts. In FIG. 4, the user has selected the tab 402 to work with the IP Address type of IDP. Within tab 402, a variety of user interface controls 408-420 are provided for specifying the details relating to the dynamic variation of IP addresses within the selected module. More or fewer controls can be provided to facilitate the dynamic manipulation of the IP Address type, and the controls shown are merely provided to assist the reader in understanding the concept. In the example shown, the network administrator can enable dynamic variation of IP addresses by selecting (e.g., with a pointing device such as a mouse) the check-box 408 marked: Enable IP Address Hopping. Similarly, the network administrator can indicate whether the source address, destination address or both are to be varied. In this example, the source and destination address boxes 410, 412 are both marked, indicating that both types of addresses are to be changed. The range of allowed values for the source and destination addresses can be specified by the administrator in list boxes 422, 424.

The particular pseudorandom process used to select false IP address values is specified by selecting a pseudorandom process. This selection is specified in boxes 414, 415. Different pseudorandom processes can have different levels of complexity for variable degrees of true randomness, and the administrator can choose the process that best suits the needs of the network 100.

Dialog box 400 also allows a network administrator to set the trigger type to be used for the dynamic variation of the IP Address IDP. In this example, the user has selected box 416, indicating that a time based trigger is to be used for determining when to transition to new false IP address values. Moreover, checkbox 418 has been selected to indicate that the time based trigger is to occur on a periodic basis. Slider 420 can be adjusted by the user to determine the frequency of the periodic time based trigger. In the example shown, the trigger frequency can be adjusted between six (6) trigger occurrences per hour (trigger every ten (10) minutes) and one hundred twenty (120) trigger occurrences per hour (trigger every thirty (30) seconds). In this example, selections are available for other types of triggers as well. For example, dialog box 402 includes check boxes 428, 430 by which the network administrator can select an event-based trigger. Several different specific event types can be selected to form the basis for such event-based triggers (e.g., Event type 1, Event type 2, etc.). These event types can include the detection of various potential computer network security threats. In FIG. 4, tabs 404 and 406 are similar to tab 402, but the controls therein are tailored to the dynamic variation of the MAC Address and Port value rather than the IP Address. Additional tabs could be provided for controlling the dynamic variation of other types of IDPs.

The mission plan can also specify a plan for dynamically varying the location where IDPs are modified. In some scenarios, this variable location feature is facilitated by controlling a sequence that defines when each module is in an active state or a bypass state. Accordingly, the mission plan advantageously includes some means of specifying this sequence. In some scenarios, this can involve the use of defined time intervals or time slots, which are separated by the occurrence of a trigger event.

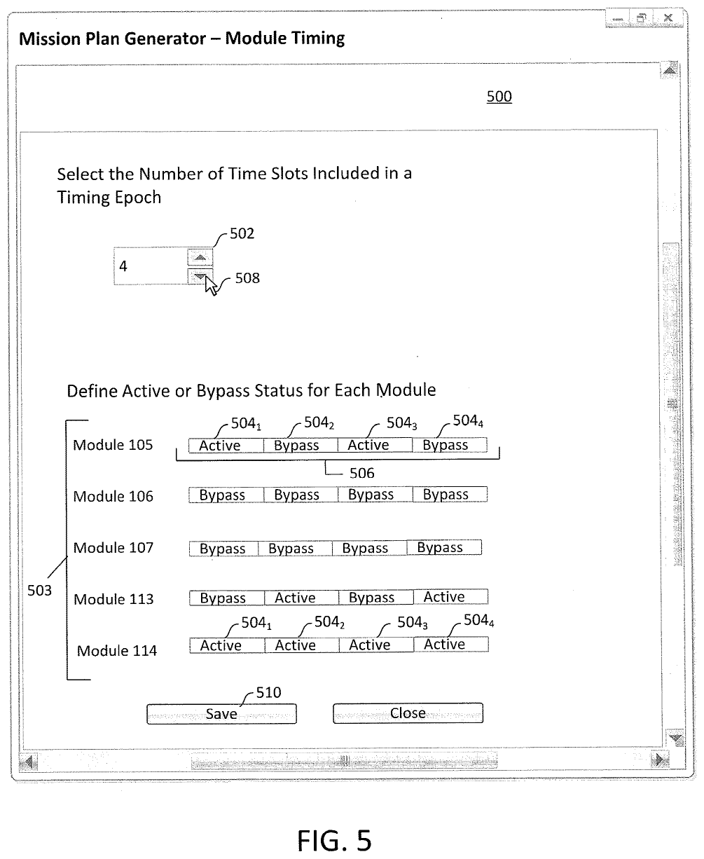

Referring now to FIG. 5, a dialog box 500 can be provided by the NCSA to facilitate coordination and entry of location sequence and timing information. Dialog box 500 can include a control 502 for selecting a number of time slots 504₁-504ₙ which are to be included within a time epoch 506. In the example illustrated, the network administrator has defined four (4) time slots per timing epoch. The dialog box 500 can also include a table 503 which includes all modules in the network 100. For each module listed, the table includes a graphical representation of available time slots 504₁-504₄ for one timing epoch 506. Recall that dynamic control over the location where IDPs are manipulated is determined by whether each module is in an active or bypass operating states. Accordingly, within the graphical user interface, the user can move a cursor 508 and make selections to specify whether a particular module is in an active or bypass mode during each time slot. In the example shown, module 105 is active during time slot 504₁ and 504₃, but is in a bypass mode during time slots 504₂, 504₄. Conversely, module 113 is active during time slots 504₂, 504₄, but is in bypass mode during time slots 504₁ and 504₃. With reference to FIG. 1, this means that manipulation of IDPs occurs at a location associated with module 105 during time slots slot 504₁ and 504₃, but occurs instead at module 113 during time slots 504₂, 504₄.

In the example shown in FIG. 5, the network administrator has elected to have module 114 always operate in an active mode (i.e., module 114 is active during all time slots. Accordingly, for data communications transmitted from client computer 101 to client computer 103, data packets will alternately be manipulated in modules 105, 113, but will always be manipulated at module 114. Finally, in this example, the network administrator has elected to maintain modules 106 and 107 in a bypass mode during time slots 504₁-504₄. Accordingly, no manipulation of IDPs will be performed at these modules during any of the defined time slots. Once the module timing has been defined in dialog box 500, the network administrator can select the button 510 to store the changes as part of an updated mission plan. The mission plan can be saved in various formats. In some scenarios, the mission plan can be saved as a simple table or other type of defined data structure that can be used by each module for controlling the behavior of the module.

### Mission Plan Generation Using a Behavior Model Library

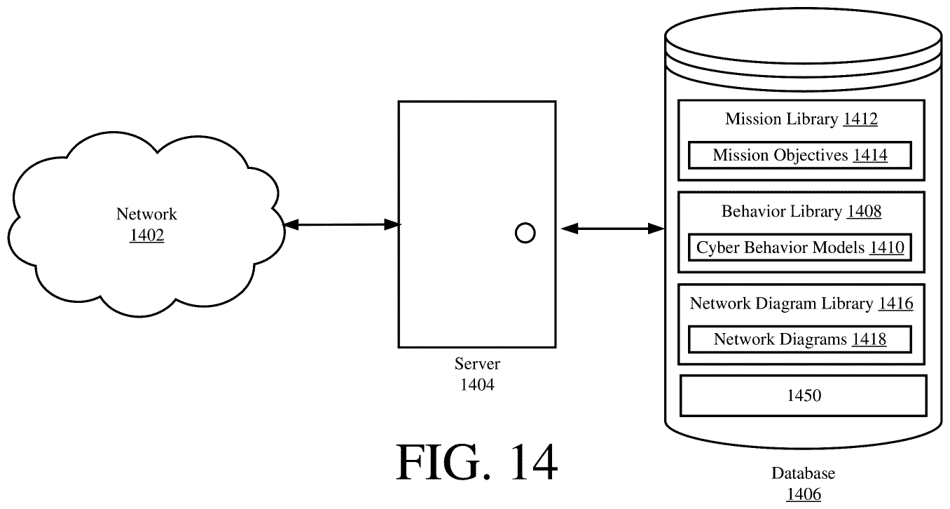

In order to effectively manage dynamic networks, one must have extensive subject matter expertise to define strategy, behavior and maneuver schemes which are to be implemented via mission plans. The present solution provides a means to decrease the complexity of mission plan creation so that mission plans can be created by those who do not have the previously mentioned extensive subject matter expertise. In this regard, a mission library 1412, a behavior library 1408 and a network diagram library 1416 are employed as shown in FIG. 14. These libraries 1408, 1412, 1416 are accessible via a server 1404 and a network 1402. The network 1402 can be the same or different network in which IDP maneuverability is employed.

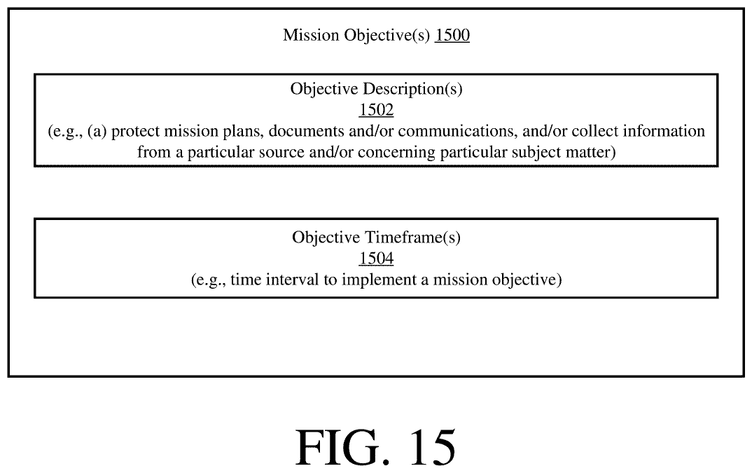

The mission library 1412 comprises a plurality of mission objectives 1414. A mission objective is an end toward which effort and action are directed or coordinated. There can be a number of mission objectives in order to achieve a mission. An exemplary architecture for a mission objective is provided in FIG. 15. As shown in FIG. 15, the mission objective comprises at least one objective description 1502 and at least one objective timeframe 1504. An objective description describes the mission objective. For example, an objective description 1502 includes, but is not limited to, protect a mission model, protect certain documents (e.g., military or corporate strategy documents), protect certain communications, collect information from a particular source, and/or collect information concerning a particular subject matter. An objective timeframe 1504 includes at least one-time interval to implement at least one mission objective.

The behavior library 1408 comprises a plurality of Cyber Behavior Models (“CBMs”) 1410. The CBMs 1410 are generally used to drive the definition and management of mission plans. The CBMs 1410 can be defined and composed based upon cyber behavior models derived from and within different communities. For example, the CBMs 1410 can be defined and composed based on maneuver theory, psychology, animal behavior, military theory, past military operations, music construction, etc. The present solution is not limited to the particulars of this example.

The behavior library 1408 allows for: the automation of CBM definitions; the use of a common language and models for deriving maneuver scheme definitions; the incorporation of lessons learned from previous missions to develop new maneuver schemes with improved resiliency; and the reuse of CBMs so that the dynamic network management is achieved efficiently and effectively.

The network diagram library 1416 includes information specifying a hardware and/or software architecture of a network. The hardware architecture can be constructed out of physical hardware and/or virtualized hardware. In this regard, the network diagram library 1416 comprises information indicating network node unique identifiers, network node types, operational capabilities of the network nodes, and/or wired connections between the network nodes. In some scenarios, the network diagram library also includes information organizing the network nodes into talkgroups or communities and/or information indicating security levels associated with the network nodes.

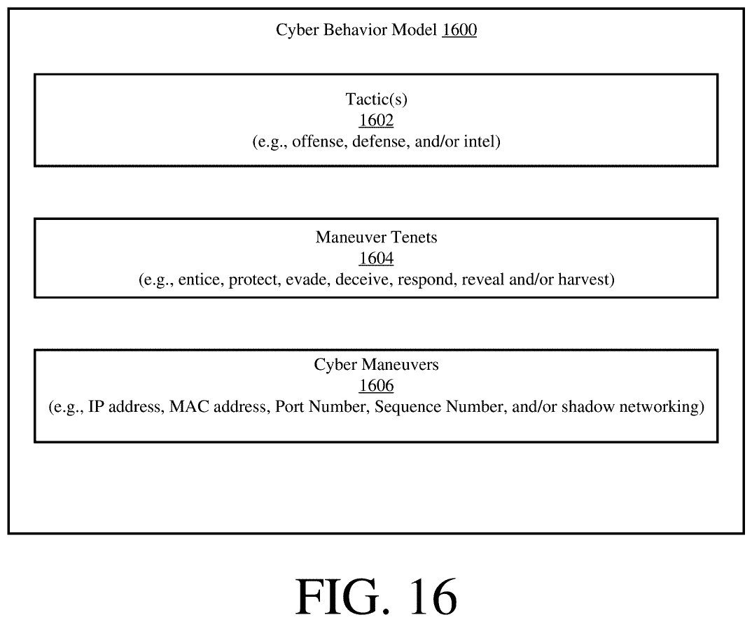

A schematic illustration of an exemplary CBM 1600 is provided in FIG. 16. As shown in FIG. 15, the CBM 1600 comprises information defining tactic(s) 1602, maneuver tenet(s) 1604, and cyber maneuvers 1606. A tactic 1602 is a strategy planned to achieve a specific end (or mission objective). For example, a tactic is offense, defense or intel (or intelligence gathering). An offensive tactic is an operation that seeks through a cyber-attack to gain information and/or disrupt operations of a given computer system (e.g., a computer system of an enemy). A defensive tactic is an operation designed to repel cyber-attacks on a given computer system, while also protecting the computer system from cyber-attacks. An intel tactic is an operation to identify and collect (or harvest) information that can provide guidance and direction to achieve the mission objective 1414.

A maneuver tenet 1604 is a principle of network maneuverability for implementing a specific offensive, defensive or intelligence collection strategy (or tactic). A maneuver tenet 1604 defines network operations for enticing a cyber-attack, protecting from a cyber-attack, evading a cyber-attack, deceiving cyber-attackers, responding to a cyber-attack, reveling a cyber-attack and/or harvesting information about a cyber-attack. The terms “entice”, “protect”, “evade”, “deceive”, “respond”, “reveal” and “harvest” are all defined below.

The phrase “entice” means to attract or tempt (like bait) by offering pleasure or advantage. Thus, the maneuver tenet for enticing a cyber-attack comprises items or objects that can be offered as enticement. The items or objects can be dynamic. In this case, a cyber behavior model is provided that describes the dynamic nature of the items or objects. A time period may also be defined during which the items or objects will be offered as bait. The item or object can include, but is not limited to, a value stored in memory at a location which is referenced by an identifier.

The phrase “protect” means to keep safe from harm or injury. In cyber parlance, it means to keep a computer safe from an attack vector reaching the computer, operating in its memory, reading its data, etc. Protection contains the elements of: {invisibility; blocking; fortifying; extinguishing}. Thus, the maneuver tenet for protecting from a cyber-attack comprises information identifying who should be allowed to communicate with each other in accordance with a given strategy. This information can identify people, organizations, entities and/or network devices that are to implement a strategy and/or have access to information associated with the strategy. For example, a maneuver tenet includes identifiers for network devices that comprise sensitive information and/or people that have the appropriate security level to access to the sensitive information. If any of the protection elements are dynamic in nature, a cyber behavior model is provided defining the dynamic nature thereof.

The word “evade” means to escape or avoid (especially by being clever or tricky). A maneuver tenet for evading a cyber-attack has the following elements: an associated movement or assignment of two possibilities (e.g., a target moves or changes from A to B and/or the attacker misaligns or misinterprets); a target; an attacker; a cyber behavior model defining the kind of movement; a velocity of movement; and a time period during which movement will exist. As such, this maneuver tenet comprises information associated with how often a network maneuver is happening, how big a maneuver space is that certain information can move within, and/or what is the overall networking address space that computers are allowed to maneuver within. For example, a maneuver tenet includes information identifying at least one IDP for which false values are to be employed, a rate at which the IDP value should be changed, and/or timeslots of a frame in which the IDP value should be changed.

The word “deceive” means to cause someone or a system to believe something is not true. Something fake can be substituted for something real. Any item in the communication model can be substituted by a fake item in the communication model (real physical equipment or virtual equipment). If any of the objects are interposed in a dynamic fashion, a cyber behavior model is provided that describes the dynamic fashion. For example, a false IP address can be substituted in place of a real IP address. A maneuver tenet for deceiving a source of a cyber-attack has the following elements: a transformation function f(x); a velocity of transformation; and a time or timeframe associated that the transformative process will operate across. Accordingly, this maneuver tenet comprises information that identifies a deception network device associated with each false IDP value that is intended to cause a cyber-attacker and/or malicious software to believe that (s)he or it has gained access to the actual network equipment of interest (e.g., the network devices implementing network maneuverability). The deception network device can be configured to capture information indicating actions of cyber-attackers and/or information useful for tracing the hackers behind a cyber-attack.

The word “respond” means to do an action in reply to a previous action. A maneuver tenet for responding to a cyber-attack has the following elements: an action; a reply to the action; a velocity; a period of sustainment for the action to exist; and a cyber behavior model (or set of cyber behavior models) defining both actions. Therefore, this maneuver tenet comprises at least one rule specifying at least one action that should be taken when a given action occurs (e.g., a malicious attack is detected). The action can include, but is not limited to, dropping a received packet (which could be the result of or including an incorrect identity parameter value for a given timeslot), forwarding the received packet to an intrusion analysis tool or honeypot analysis tool, logging information associated with the received packet, determining a source of the received packet, sending a response to the source of the received packet, notifying an appropriate authority, and/or issuing an alarm.

The word “reveal” means to cause an action, location or intent to become visible and noticed. A maneuver tenet for reveal includes items and/or objects. There is a behavior done by an object to cause an opponent (opposing object) to make visible (reveal) their: location; intent and associated behavior; strength; and/or behavior or object that the opponent is triggering on. The originating (triggering) behavior(s) and object(s) can be dynamic as well as the opponent's behavior(s) and/or object(s). A cyber behavior model is provided that described the dynamic nature of the behaviors and objects.

The word “harvest” means to identify a set of objects and collect those objects. A maneuver tenet for harvest includes items and/or objects that can be identified and collected. An associative relationship exists between the identification algorithm and the collection function of the objects. The associative relationship can be a set of mathematical functions (e.g., collect those items “=” Xⱼ, collect those items !=to xⱼ, etc.). The associative relationship can be a relationship to any of the {objectives; tactics; tenets; cyber behavior models; members of a set of maneuvers; network drawings; time frames}.

The cyber maneuvers 1606 comprise information specifying IDPs and how those IDPs are to be changed during operation of the system, as well as particulars of shadow networking techniques. In some scenarios, the cyber maneuvers 1606 can include, but are not limited to, an IP address, a MAC address, a port number, a sequence number, and/or shadow networking parameters. Shadow networking techniques are described in U.S. Pat. No. 9,075,992 to Smith et al. (“the '992 application), which is incorporated herein by reference. Any known or to be known shadow networking technique can be used herein without limitation. In some scenarios, shadow networking is used to identify, deter and/or delay malicious attacks being waged on a computer network. This is achieved by: using two (2) possible values for an IDP (e.g., an IP address) in communications to and from a network node in different timeslots of a plurality of timeslots of a time frame; comparing a value of the IDP contained in a received packet with the possible values specified for the IDP; and determining that a cyber-attack is occurring when the received packet's IDP value does not match the IDP value specified for the current timeslot.

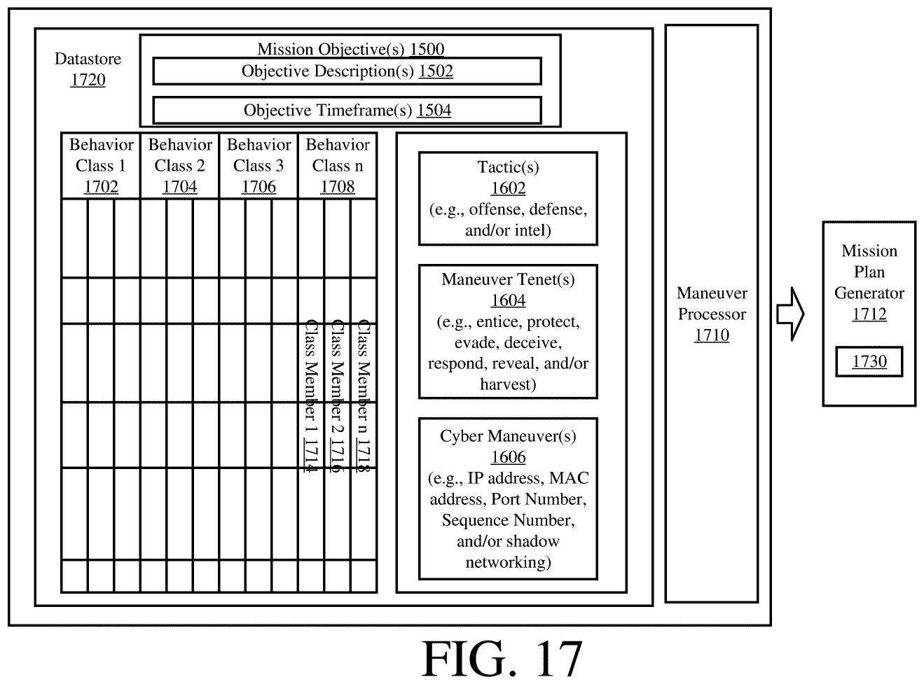

FIG. 17 provides a schematic illustration that is useful for understanding how mission plans are generated using CBMs (such as CBM 1600 of FIG. 16). During operation, a user is presented a graphical means for selecting CBM criteria. The graphical means can be presented via a computing device. An exemplary computing device 2200 is shown in FIG. 2, which will be discussed in detail below. The CBM criteria includes, but is not limited to, at least one mission objective 1500, at least one object description 1502, at least one objective time frame 1504, at least one tactic 1602, at least one maneuver tenet 1604, and at least one cyber-maneuver 1606. Each of the listed types of CBM criteria is discussed above.

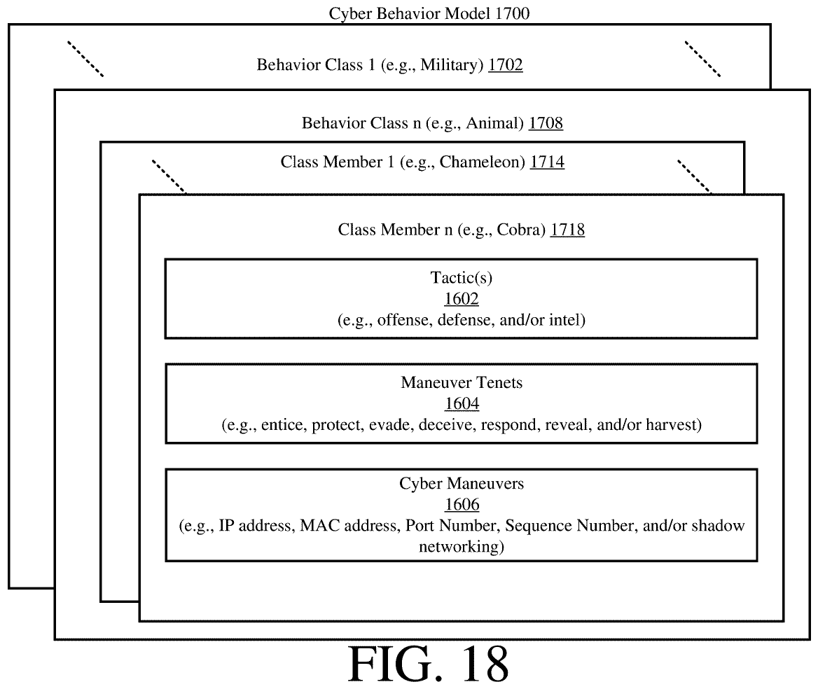

Based on the user-selection, information associated with one or more CBMs is presented to the user. This information comprises identifiers for a plurality of behavior classes 1702, 1704, 1706 and 1708. A behavior class is a class of maneuverability behavior for a network. The behavior classes include, but are not limited to, animal, military, and/or music. In each class, there are a plurality of member sub-classes 1714-1718 as shown in FIGS. 17-18. For example, the animal class includes a chameleon class member and a cobra class member. Each member sub-class 1714-1718 is defined by or associated with at least one tactic 1602, maneuver tenet 1604 and cyber-maneuver 1606.

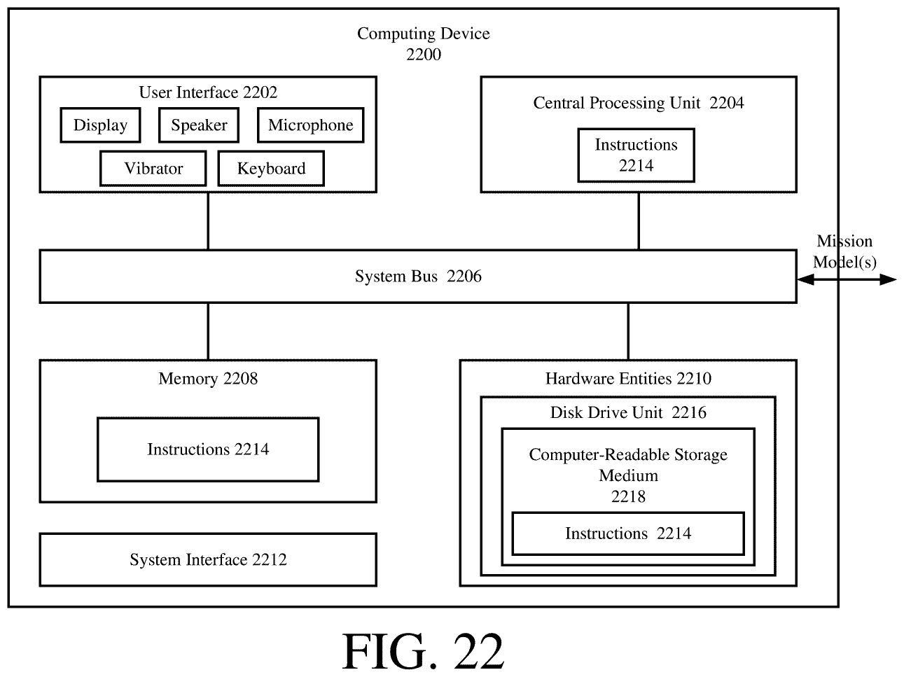

In addition to the behavior class information, a graphical means is also presented which allows the user to define time period(s) at which one or more CBMs, behavior classes and/or member sub-classes is (are) to operate. These time periods are used to define a time schedule for implementation of the CBM(s). Once the time schedule is generated, maneuver processing is performed by a maneuver processor 1710 (e.g., implemented as a CPU 2204 and/or hardware entity 2210 of a computing device 2200 shown in FIG. 22) to obtain information for the CBM(s) particulars. This information is then used by a mission plan generator 1712 (e.g., implemented as a CPU 2204 and/or hardware entity of 2210 of a computing device 2200 shown in FIG. 22) to generate or obtain a mission plan as shown by functional block 1712.

In I some scenarios, the mission plan can be generated automatically or obtained by selecting at least one mission plan from a plurality of pre-generated mission plans based on the user defined criteria. In other scenarios, the bounds of the mission plan are generated based on the user defined criteria. A user then uses the defined bounds to manually generate the mission plan. For example, the bounds define a template mission plan that can be customized by the user.

In some scenarios, the pre-generated mission plans (e.g., mission plans 1450 of FIG. 14) are stored in a data store (e.g., database 1406 of FIG. 14). The pre-generated mission models are stored so as to be associated with respective CBMs. This association can be achieved using a hierarchy structure or other relation specifying data organization (e.g., tables). Each CBM can have one or more pre-generated mission models associated therewith. Additionally, two CBMs can have one or more of the same pre-generated mission models associated therewith.

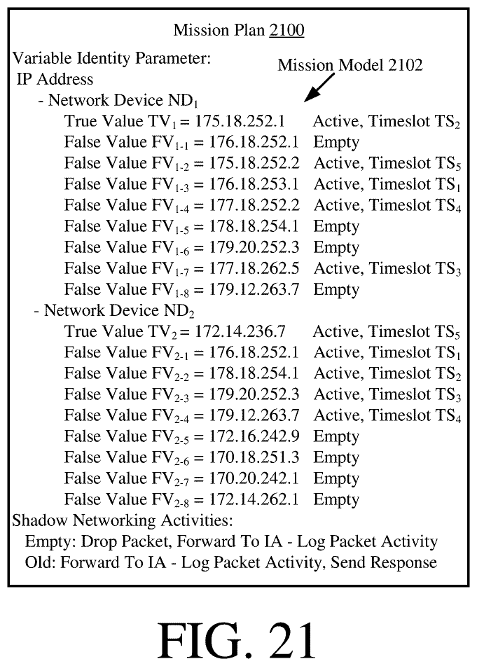

An exemplary mission plan 2100 is shown in FIG. 21. The mission plan 2100 includes at least one mission model 2102 with a plurality of possible values for a variable identity parameter (e.g., an IP address). The plurality of possible values is generated or obtained by the mission plan generator 1712. In this regard, the mission plan generator 1712 comprises an IDP false value generator 1730 employing chaotic, random and/or pseudo-random algorithms or handpicked algorithms which can be used to derive the possible values or select the possible values from a LUT. A seed value for the algorithms can include, but is not limited to, an identifier for a particular CBM or mission model. The mission model(s) is (are) then used to define the mission plan 2100.

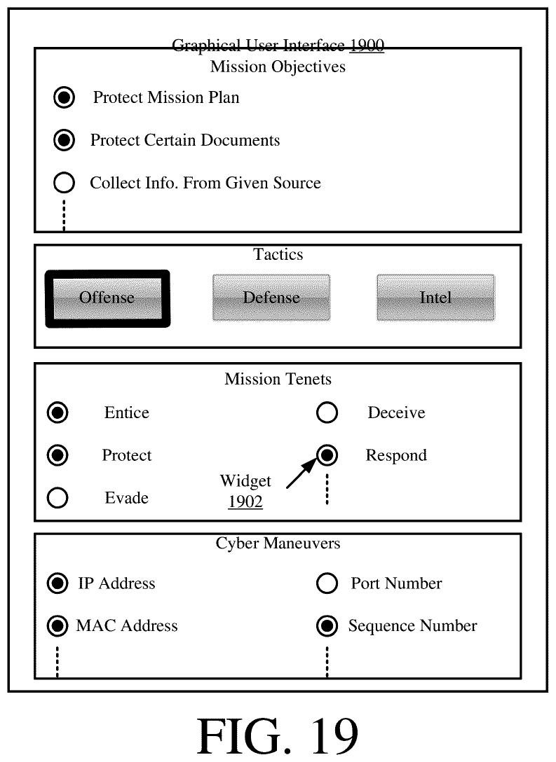

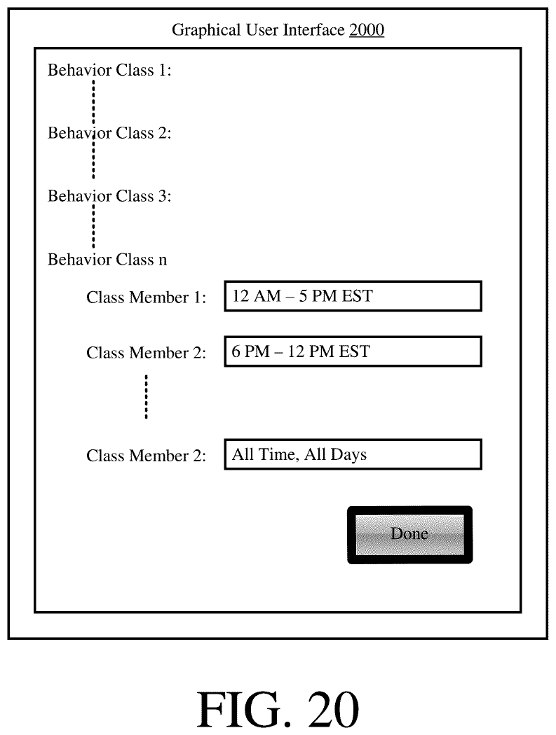

The mission plan generation can be achieved using one or more GUIs. Illustrations of exemplary GUIs 1900, 2000 are provided in FIGS. 19-20. GUIs 1900, 2000 are designed to allow a user-software interaction for selecting CBM criteria. The GUI 1900 comprises a plurality of widgets 1902 which facilitate user-software interactions for selecting mission objectives, tactics, mission tenets and/or cyber maneuvers. The GUI 2000 comprises a plurality of text boxes and/or other graphic elements that allow a user to specify times at which all or portions of a CBM are to be employed for purposes of network maneuverability. The widgets and other graphical elements can include, but are not limited to, virtual buttons, check boxes, drop down menus (not shown), scroll bars (not shown), and/or any other known or to be known graphical control element.

Referring now to FIG. 22, there is provided a schematic illustration an exemplary computing device 2200. The computing device can include, but is not limited to, a personal computer, a laptop computer, a desktop computer and/or a server. The computing device 2200 is generally configured to perform operations for providing dynamic computer networks in which cyber behavior models drive cyber mission models. As such, the computing system 2200 comprises a plurality of components 2202-2212. The computing system 2200 can include more or less components than those shown in FIG. 22. However, the components shown are sufficient to disclose an illustrative embodiment implementing the present solution. Notably, the hardware shown in FIG. 22 can include physical hardware and/or virtual hardware.

The hardware architecture of FIG. 22 represents one (1) embodiment of a representative computing device configured to facilitate the provision of a dynamic computer network in which cyber behavior models drive cyber mission models. As such, the computing system 2200 implements methods of the present solution.

As shown in FIG. 22, the computing system 2200 includes a system interface 2212, a user interface 2202 (e.g., a keyboard for data input and a display for data output), a Central Processing Unit (“CPU”) 2204, a system bus 2206, a memory 2208 connected to and accessible by other portions of the computing system 2200 through system bus 2206, and hardware entities 2210 connected to system bus 2206. System bus 2206 is also used to communicate one or more mission plans to and from the computing system 2200. At least some of the hardware entities 2210 perform actions involving access to and use of memory 2208, which can be a Random Access Memory (“RAM”), a disk driver and/or a Compact Disc Read Only Memory (“CD-ROM”). System interface 2212 allows the computing system 2200 to communicate directly or indirectly with external devices (e.g., sensors, servers and client computers).

Hardware entities 2210 can include microprocessors, Application Specific Integrated Circuits (“ASICs”) and other hardware. Hardware entities 2210 can include a microprocessor programmed to facilitate the provision of a dynamic computer network in which cyber behavior models drive cyber mission models.

As shown in FIG. 22, the hardware entities 2210 can include a disk drive unit 2216 comprising a computer-readable storage medium 2218 on which is stored one or more sets of instructions 2214 (e.g., software code) configured to implement one or more of the methodologies, procedures, or functions described herein. The instructions 2214 can also reside, completely or at least partially, within the memory 2208 and/or the CPU 2204 during execution thereof by the computing device 2200. The components 2208 and 2204 also can constitute machine-readable media. The term “machine-readable media”, as used here, refers to a single medium or multiple media (e.g., a centralized or distributed database, and/or associated caches and servers) that store the one or more sets of instructions 2214. The term “machine-readable media”, as used here, also refers to any medium that is capable of storing, encoding or carrying a sct of instructions 2214 for execution by the computing device 2200 and that cause the computing device 2200 to perform any one or more of the methodologies of the present disclosure.

Notably, the present solution can be implemented in a single computing device as shown in FIG. 22. The present solution is not limited in this regard. Alternatively, the present solution can be implemented in a distributed network system. For example, the present solution can take advantage of multiple CPU cores over a distributed network of computing devices in a cloud or cloud-like environment. The distributed network architecture ensures that the computing time of the statistics and enhanced functionality is reduced to a minimum, allowing end-users to perform more queries and to receive reports at a faster rate. The distributed network architecture also ensures that the implementing software is ready for being deployed on an organization's internal servers or on cloud services in order to take advantage of its scaling abilities (e.g., request more or less CPU cores dynamically as a function of the quantity of data to process or the number of parameters to evaluate).

### Distribution and Loading of Mission Plans

The distribution and loading of mission plans as disclosed herein will now be described in further detail. Referring once again to FIG. 1, it can be observed that the modules 105-107, 113, 114 are distributed throughout the network 100 at one or more locations. The modules are integrated within the communications pathways to intercept communications at such locations, perform the necessary manipulations, and forward data to other computing devices within the network. With the foregoing arrangement, any necessary maintenance of the modules described herein (e.g., maintenance to update a mission plan) will have the potential to disrupt network communications while the modules are replaced or reprogrammed. Such disruptions are undesirable in many situations where reliability and availability of network services is essential. For example, uninterrupted network operation can be essential for computer networks used by military, emergency services and businesses.

In order to ensure uninterrupted network operations, each module preferably has several operating states. These operating states include (1) an off state in which the module is powered down and does not process any packets, (2) an initialization state in which the module installs software scripts in accordance with the mission plan, (3) an active state in which data is processed in accordance with a current mission plan, and (4) a by-pass state in which packets can flow through the module as if the module was not present. The module is configured so that, when it is in the active state or the by-pass state, the module can receive and load an updated mission plan provided by a network administrator. The module operating states can be manually controlled by the network administrator by means of the NCSA executing, for example, on NAC 104. For example, the user can select operating states for various modules through the use of a graphical user interface control panel. Commands for controlling the operating states of the network are communicated over the network 100, or can be communicated by any other suitable means. For example, a separate wired or wireless network (not shown) can be used for that purpose.

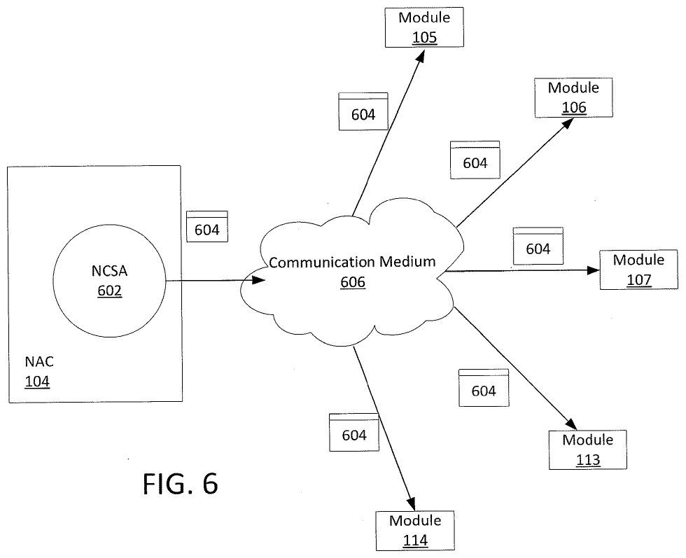

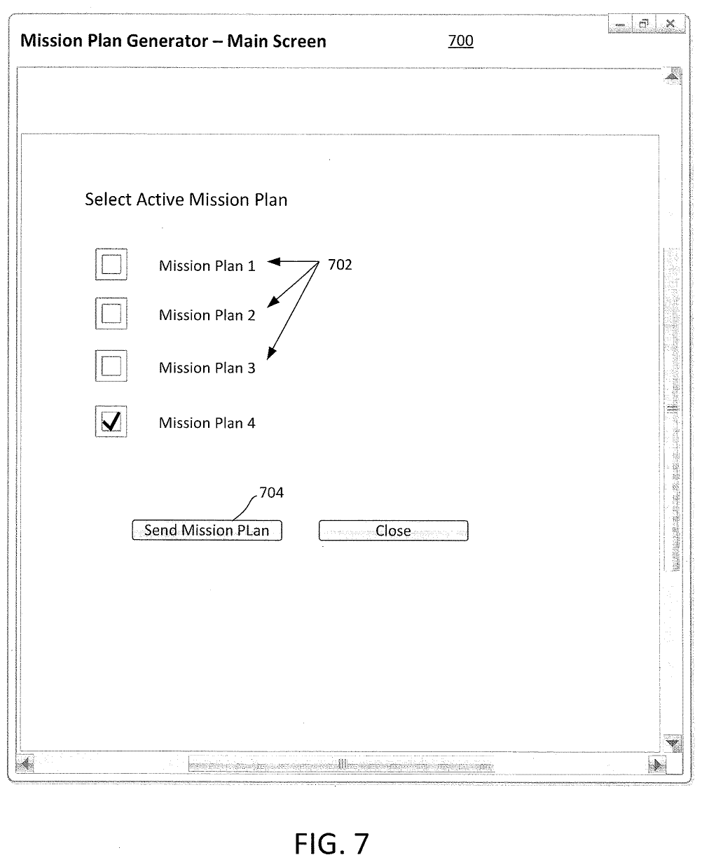

The mission plan can be loaded directly at the physical location of each module, or it can be communicated to the module from the NCSA. This concept is illustrated in FIG. 6, which shows mission plans 604 being communicated from NCSA 602 to each of the modules 105-107, 113, 114 over a communication medium 606. In the example shown, the NCSA software application is executing on NAC 104 operated by a network administrator. The communication medium can in some scenarios include in-band signaling using computer network 100. Alternatively, an out-of-band network (e.g., a separate wireless network) can be used as the communication medium 606 to communicate the updated mission plan from the NCSA to each module. As shown in FIG. 7, the NCSA can provide a dialog box 700 to facilitate selection of one of several mission plans 702. Each of these mission plans 702 can be stored on NAC 104. The network administrator can select from one of the several mission plans 702, after which they can activate a Send Mission Plan button 704. Alternatively, a plurality of mission plans can be communicated to each module and stored there. In either scenario, the user can choose one of the defined mission plans to activate.

In response to the command to send the mission plan, the selected mission plan is communicated to the modules while they are in an active state in which they are configured for actively performing dynamic modification of IDPs as described herein. Such an arrangement minimizes the time during which the network operates in the clear and without manipulating IDPs. However, the updated mission plan can also be communicated to the modules while they are in the by-pass mode, and this approach may be desirable in certain cases.

Once the mission plan is received by a module, it is automatically stored in a memory location within the module. Thereafter, the module can be caused to enter the by-pass state and, while still in that state, the module can load the data associated with the new mission plan. This process of entering into the by-pass state and loading the new mission plan data can occur automatically in response to receipt of the mission plan, or can occur in response to a command from the NCSA software controlled by the network administrator. The new mission plan preferably includes changes in the way that IDP values are varied. Once the new mission plan has been loaded, the modules 105-107, 113 and 114 can be transitioned from the by-pass mode to the active mode in a synchronized way to ensure that data communication errors do not occur. The mission plan can specify a time when the modules are to return to the active mode, or the network administrator can use the NCSA to communicate a command to the various modules, directing them to enter into the active mode. The foregoing process of updating a mission plan advantageously allows changes in network security procedures to occur without disrupting communication among the various computing devices attached to the computer network 100.

The dynamic manipulation of various IDPs at each module 105, 106, 107, 113 and 114 can be controlled by the application software executing on each module 105-107, 113, 114. However, the behavior of the application software is advantageously controlled by the mission plan.

### Exemplary Module Operations

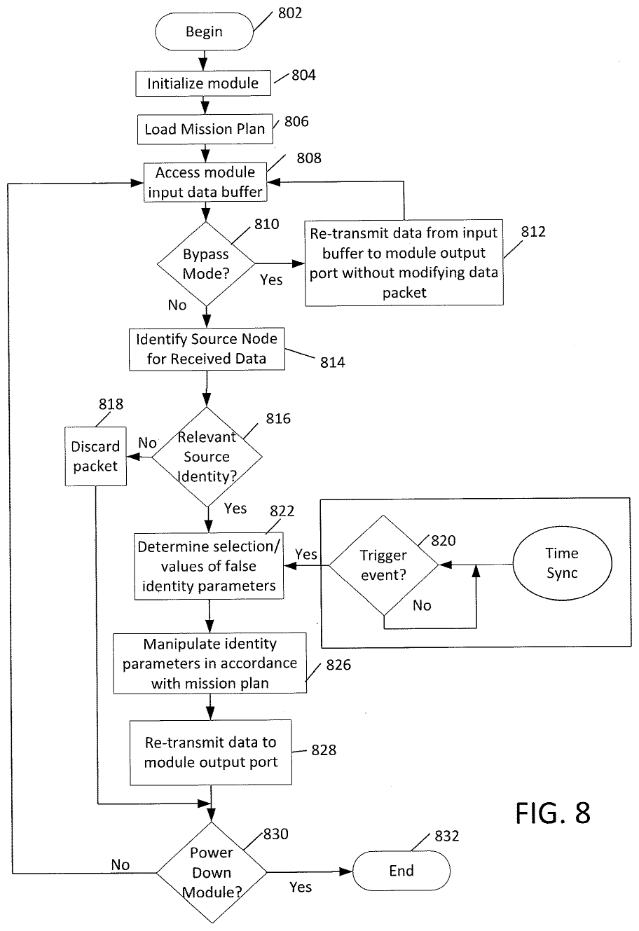

Referring now to FIG. 8, there is provided a flowchart which summarizes the operation of each module 105-107, 113, 114. To avoid confusion, the process is described with respect to communications in a single direction. For example, in the case of module 105, the single direction could involve data transmitted from client computer 101 to hub 108. In practice however, modules 105-107, 113, 114 may operate bi-directionally. The process begins at step 802 when the module is powered up and continues to step 804 where module application software is initialized for executing the methods described herein. In step 806, a mission plan is loaded from a memory location within the module. At this point, the module is ready to begin processing data and proceeds to do so at step 808, where it accesses a data packet from an input data buffer of the module. In step 810, the module checks to determine if it is in a bypass mode of operation. If so, the data packet accessed in step 808 is retransmitted in step 812 without any modification of the data packet. If the module is not in bypass mode, then it must be in its active mode of operation and continues on to step 814. In step 814, the module reads the data packet to determine the identity of a source node from which the data packet originated. In step 816, it examines the packet to determine if the source node is valid. The specified source node can be compared to a list of valid nodes to determine if the specified source node is currently valid. If it is not a valid node, then the packet is discarded in step 818. In step 820, the process checks to determine if a trigger event occurred. The occurrence of a trigger event will influence the selection of false identify values to use. Accordingly in step 822, the module determines the false identify values to use based on one or more of the trigger information, clock time and mission plan. The module then continues to step 826 where it manipulates IDPs of the data packet. Once manipulations are complete, the data packet is re-transmitted to an adjacent node from the output port of the module. In step 830, a determination is made as to whether the module has been commanded to power down. If so, the process ends at step 832. In step 808, the process continues and the next data packet is accessed from the module's input data buffer.

### Exemplary Methods For Managing A Dynamic Computer Network

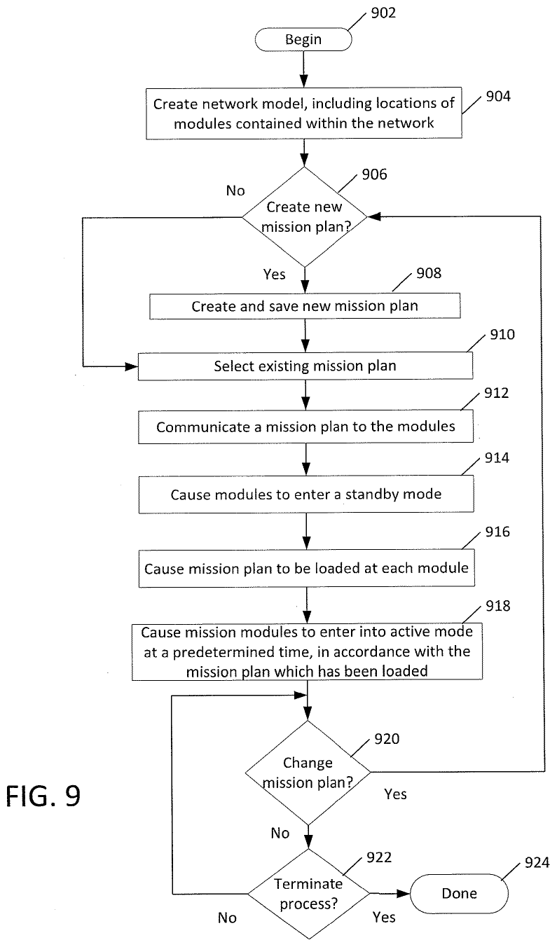

Referring now to FIG. 9, there is provided a flowchart which summarizes the methods described herein for managing a dynamic computer network. The process begins in step 902 and continues to step 904, where a network model is created (e.g., as shown and described in relation to FIG. 3). In step 906, a determination is made as to whether a new mission plan is to be created. If so, a new mission plan is created in step 908 and the process continues to step 910, where the new mission plan is selected. Alternatively, if in step 906 a desired mission plan has already been created, then the method can continue directly to step 910 where an existing mission plan is selected. In step 912, the mission plan is communicated to the modules (e.g., modules 105-107, 113, 114), where the mission plan is stored in a memory location. When the network administrator is ready to implement the new mission model, a command is sent in step 914 which causes the modules to enter a standby mode as described herein. While the modules are in this standby mode, the mission plan is loaded at step 916. Loading of the mission plan occurs at each module so that the mission plan can be used to control the operations of an application software executing on the module. In particular, the mission plan is used to control the way in which the application software performs dynamic manipulations of IDPs. In step 918, the mission modules are again caused to enter into an active operational mode in which each mission module performs manipulations of IDPs in accordance with the mission plan. Steps 914, 916 and 918 can occur in response to specific commands sent from a network administrator, or can occur automatically at each module in response to receiving the mission plan in step 912. After step 918, the modules continue performing processing in accordance with the mission plan which has been loaded. In step 920, the process continues by checking to determine if the user has indicated a desired to change the mission plan. If so, the process returns to step 906 where it continues as described above. If there is no indication that the user or network administrator wishes to change an existing mission plan, then the process determines in step 922 whether it has been instructed to terminate. If so, the process terminates in step 924. If no termination instruction is received, the process returns to step 920 and continues.

### Exemplary Architectures for Various Components

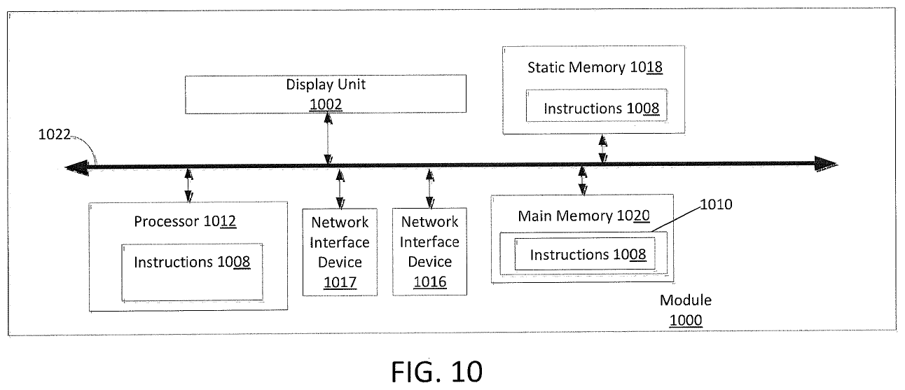

Referring now to FIG. 10, there is provided a block diagram which shows a computer architecture of an exemplary module 1000 which can be used for performing the manipulation of IDPs described herein. Module 1000 can include more or less components than that shown. For example, module 1000 can include datastore(s) (not shown). The module 1000 includes a processor 1012 (such as a Central Processing Unit (“CPU”), a main memory 1020 and a static memory 1018, which communicate with each other via a bus 1022. The computer system 1000 can further include a display unit 1002, such as a Liquid Crystal Display (“LCD”) to indicate the status of the module. The module 1000 can also include one or more network interface devices 1016, 1017 which allow the module to receive and transmit data concurrently on two separate data lines. The two network interface ports facilitate the arrangement shown in FIG. 1, where each module is configured to concurrently intercept and re-transmit data packets received from two separate computing devices on the network.

The main memory 1020 includes a computer-readable storage medium 1010 on which is stored one or more sets of instructions 1008 (e.g., software code) configured to implement one or more of the methodologies, procedures, or functions described herein. The instructions 1008 can also reside, completely or at least partially, within the static memory 1018, and/or within the processor 1012 during execution thereof by the module. The static memory 1018 and the processor 1012 also can constitute machine-readable media. In the various scenarios, a network interface device 1016 connected to a network environment communicates over the network using the instructions 1008.

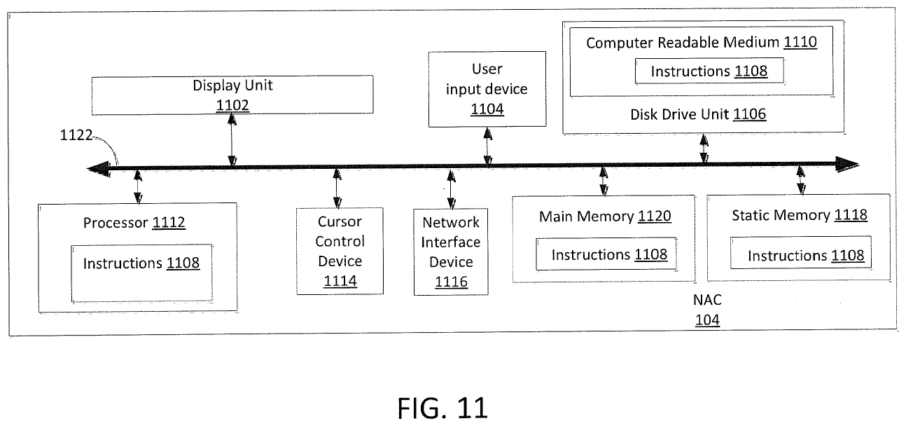

Referring now to FIG. 11, there is shown an exemplary NAC 114 in accordance with the inventive arrangements. The NAC can comprise various types of computing systems and devices, including a server computer, a client user computer, a Personal Computer (“PC”), a tablet PC, a laptop computer, a desktop computer, a control system or any other device capable of executing a set of instructions (sequential or otherwise) that specifies actions to be taken by that device. Further, while a single computer is illustrated in FIG. 11, the phrase “NAC” shall be understood to include any collection of computing devices that individually or jointly execute a set (or multiple sets) of instructions to perform any one or more of the methodologies discussed herein.

Referring now to FIG. 11, the NAC 104 includes a processor 1112 (such as a central processing unit (CPU), a disk drive unit 1106, a main memory 1120 and a static memory 1118, which communicate with each other via a bus 1122. The NAC 104 can further include a display unit 1102, such as a video display (e.g., an LCD), a flat panel, a solid state display, or a Cathode Ray Tube (“CRT”)). The NAC 104 can include a user input device 1104 (e.g., a keyboard), a cursor control device 1114 (e.g., a mouse) and a network interface device 1116.

The disk drive unit 1106 includes a computer-readable storage medium 1110 on which is stored one or more sets of instructions 1108 (e.g., software code) configured to implement one or more of the methodologies, procedures, or functions described herein. The instructions 1108 can also reside, completely or at least partially, within the main memory 1120, the static memory 1118, and/or within the processor 1112 during execution thereof. The main memory 1120 and the processor 1112 also can constitute machine-readable media.

Those skilled in the art will appreciate that the module architecture illustrated in FIG. 10 and the NAC architecture in FIG. 11, each represent merely one possible example of a computing device that can be used respectively for performing the methods described herein. However, the present solution is not limited in this regard and any other suitable computing device architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various scenarios broadly include a variety of electronic and computer systems. Some implementations of the present solution may implement functions in two or more specific interconnected hardware devices with related control and data signals communicated between and through the modules, or as portions of an application-specific integrated circuit. Thus, the exemplary system is applicable to software, firmware, and hardware implementations.

In accordance with the present solution, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein.

While the computer-readable storage medium 1010, 1110 is shown in FIGS. 10 and 11 to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but is not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

Communications with Computing Devices Outside the Dynamic Network

While the methods described herein for dynamic manipulation of IDPs can work well within a network 100, they do present some problems for communicating with computers outside the network 100. For example, computers outside of the network 100 will not be aware of the dynamic processes at work for manipulating IDPs. Accordingly, communications with computers outside the network 100 are likely to be disrupted if appropriate actions are not taken. Accordingly, the network 100 advantageously includes at least one bridge 115 which is arranged to process communications entering or leaving the network 100. The bridge ensures that such communications between computing devices within the network 100 and computing devices outside the network 100 can occur without errors.

The bridge 115 is a computing device that will have a functional block diagram that is similar to that of a module as shown in FIG. 2. The bridge 115 can also have a computer architecture that is similar to that which is shown in FIG. 10. The operations performed by the bridge 115 are similar to those performed by the modules 105-107, 113, 114. The bridge will receive data communications from network 100 and will manipulate IDPs in accordance with a mission plan before re-transmitting such data communications to a second network 124. In some scenarios, such manipulations will involve conversion of false IDPs back to true IDPs, where the true IDPs are determined based on information contained in the mission plan. Such an arrangement is sufficient where the second network does not dynamically modify IDP information.

In an alternative scenario, the second network 124 is a dynamic network that operates in a manner similar to the network 100. As such, the second network may have its own mission plan (second mission plan). In that case, the bridge will receive IDPs in a data communication from the first network, and will transform a first set of those IDPs having false values to instead have true values. The mission plan for the second network 124 can specify an entirely different dynamic network. For example, the mission plan for the second network can specify different IDPs to be modified, different trigger timing, and so on. Accordingly, the bridge will need to receive a message from the first network, correct the false values in the first set in accordance with the mission plan of the first network 100, and then dynamically modify the same (or different) IDPs in a second set in accordance with the mission plan of the second network. Once the second set of IDPs has been properly converted to false values, the data communication is transmitted to the second network.

It will be appreciated that the first set is determined in accordance with a first mission plan associated with the first network, and the second set is determined in accordance with a second mission plan associated with the second network. Similarly, the false information contained in said first set is determined in accordance with first mission plan and the false information contained in the second set is determined in accordance with the second mission plan. The first set of IDPs can be the same or different as compared to the second set of IDPs. Also, it should be appreciated that the first and second set can include all or some of the IDPs included in the data communication. The data communication will generally be a packet data communication containing a plurality of IDPs. The bridge will also receive data communications from second network 124, and will manipulate the IDPs in such data communications in accordance with the mission plan of the first network, the second network or both. For example, the bridge can receive a second data communication from the second data network, which can include a second plurality of IDPs. The second IDPs may or may not specify false information, depending on whether the second network dynamically modifies IDPs. If the second network does not dynamically modify IDPs, then the bridge only needs to use the mission plan associated with the first network to dynamically transform a set of the second plurality of IDPs to specify false information.

If the second network does dynamically modify IDPs, then the bridge will need to use the mission plan associated with the second network to convert a first set of the second plurality of IDPs (having false values) to true values. This step is preferably performed before the bridge uses the mission plan associated with the first network to transform a second set of the second plurality of IDPs to false values. The first and second set can be the same or different, and will be determined in each case by the mission plan for each network. Likewise, the transformations performed to convert IDPs to false values can be the same or different, and will depend on the mission plan associated with each network. Thereafter, the bridge will re-transmit such data communications to the network 100.

In some scenarios, the false IDPs for network 100, 124 are determined in accordance with a pseudorandom process. In that case, the pseudorandom process and/or the seed values for the pseudorandom process can be determined by the mission plan for the associated network. Likewise, the selection of IDPs to be manipulated can be determined by a pseudorandom process, where the process and/or the seed values for such process are respectively determined by the mission plan associated with each network. The bridge will make changes to the false IDP values and/or the selection of IDPs to be manipulated in accordance with the occurrence of one or more trigger event as described above with reference to the modules. Unlike the modules, the bridge 115 will need to perform such actions with respect to trigger events occurring with respect to the first and second networks.

Aside from the need to potentially manage dynamic operations associated with more than one mission plan, the operation of the bridge 115 is similar to that of the modules. Still, it should be appreciated that the operations of the bridge 115 is different as compared to the operation of the modules 105-107, 113, 114. For example, unlike the modules, the location where IDP manipulations are performed does not change in the case of the bridge 115. Instead, bridge 115 will always be in the active mode when at least one module in the network 100 is in the active mode, since the bridge forms a link with computing devices outside the network 100.

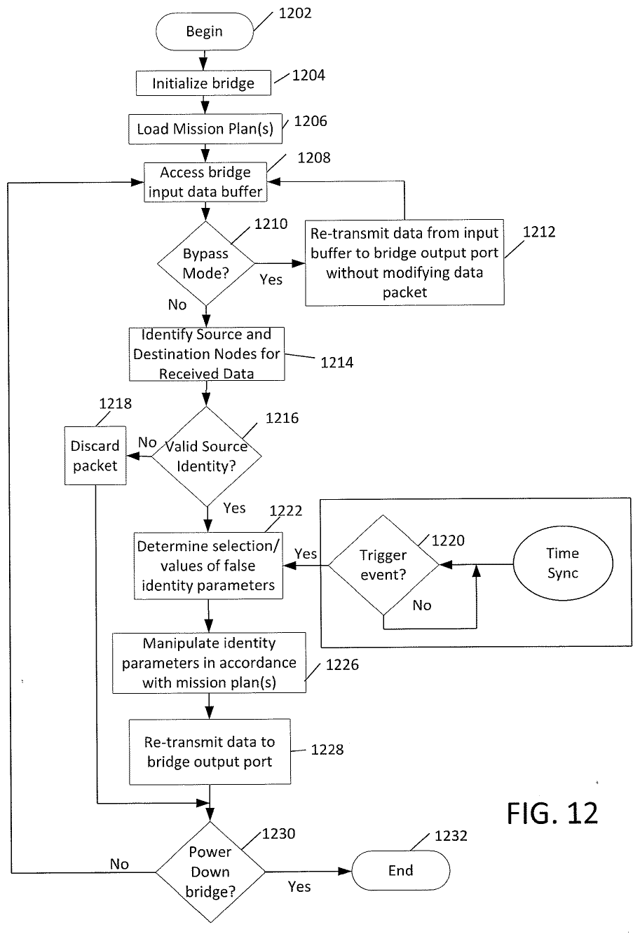

Referring now to FIG. 12, there is provided a flowchart which summarizes the operation of bridge 115. The process begins at step 1202 when the bridge is powered up and continues to step 1204 where bridge application software is initialized for executing the methods described herein. In step 1206, one or more mission plans are loaded from a memory location within the bridge. If the bridge is connected to a network that does not engage in dynamic manipulation of IDPs, then only a single mission plan is needed. However, if the bridge connects two or more networks that each dynamic modification of IDPs as described herein, then more than one mission plan will be loaded in step 1206. A first mission plan can define a dynamic manuvering of a first network and a second mission plan can define a dynamic maneuvering of a second network. At this point, the bridge is ready to begin processing data and proceeds to do so at step 1208, where it accesses a data packet from an input data buffer of the bridge. In step 1210, the bridge checks to determine if it is in a bypass mode of operation. If so, the data packet accessed in step 1208 is retransmitted in step 1212 without any modification of the data packet. If the bridge is not in bypass mode, then it must be in its active mode of operation and continues on to step 1214.

In step 1214, the bridge reads the data packet to determine the identity of a source node from which the data packet originated, and the destination node. In step 1216, the bridge examines the data packet to determine if the source node valid. This can be accomplished by comparing the source node specified in the data packet to a current list of valid source nodes. If source node information is not valid then the packet is discarded in step 1218. In step 1220, the process checks to determine if a trigger event has occurred. This is an important step because the occurrence of a trigger event can have a significant effect upon the calculation of proper false identify values. If the bridge is using two or more mission plans, this step includes determining whether trigger events have occurred with respect to either mission plan. Notably, each mission plan can involve different trigger events.

The source and destination address information of the received data is important because it is needed to permit the bridge to determine how to properly manipulate the IDPs contained within the data communication. Once this information has been determined, the bridge then continues to step 1222 where it determines a selection/values of false IDPs. The process then continues on to step 1226 at which the bridge manipulates IDPs of the data packet in accordance with one or more mission plans. Once manipulations are complete, the data packet is re-transmitted at 1228 to an adjacent node from the output port of the bridge. In step 1230, a determination is made as to whether the bridge has been commanded to power down. If so, the process ends at step 1232. Otherwise, the process returns to 1208. In step 1208, the process continues and the next data packet is accessed from the bridge's input data buffer. As explained above, the type of manipulations performed at step 1216 will depend upon the source and destination of the data communications, and whether there is one, or more than one, networks that are being dynamically maneuvered.

Types of IDPs that can be Varied

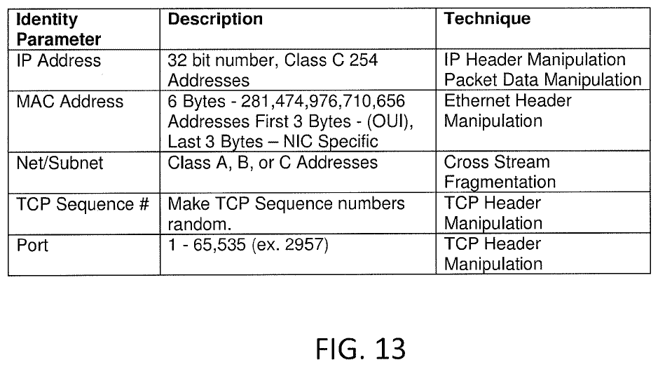

Referring now to FIG. 13, there is provided a list of various IDPs that can be manipulated in accordance with the inventive arrangements. The list is not intended to be exclusive and other IDPs can also be manipulated without limitation.

The list shown in FIG. 13 includes some IDPs that can be manipulated by the modules 105-107, 113, 114 and/or by bridge 115. Each of the parameters listed in FIG. 13 is included in a data communication included in a network using a TCP/IP communication protocol. Most of the information types listed in FIG. 13 are well known to those skilled in the art. However, a brief description of each type of information and its use as an IDP is provided herein. Also provided is a brief discussion of the ways in which each IDP can be manipulated.

IP Address. An IP Address is a numerical identifier assigned to each computing device participating in a computer network where the network uses the well known Internet Protocol for communication. The IP address can be a thirty-two (32) bit or one hundred twenty-eight (128) bit number. For purposes of the present solution, the IP address number can be changed to a false value that is selected randomly (e.g., using a pseudorandom number generator). Alternatively, the false IP address value can be randomly selected from a predetermined list of false values (e.g., a list specified by a mission plan). The source and destination IP addresses are included in TCP header portion of a data packet. Accordingly, manipulation of these values is performed by simply changing by using packet manipulation techniques which change the IP header information. When the packet arrives at a second module (the location of which can be manipulated), the false IP address values are transformed back to their true values. The second module uses the same pseudorandom process (or its inverse) to derive the true IP address value based on the false value.

MAC Address. A MAC address is a unique value assigned to a network interface device by a manufacturer and stored in an onboard ROM. For purposes of the present solution, the source and/or destination MAC address can be changed to a false value that is selected randomly (e.g., using a pseudorandom number generator). Alternatively, the false MAC value can be randomly selected from a predetermined list of false values (e.g., a list specified by a mission plan). The source and destination MAC addresses are included in IP header portion of data packet. Accordingly, manipulation of these values is performed by simply changing an Ethernet header information of each packet. When the packet arrives at a second module (the location of which can be manipulated), the false MAC address values are transformed back to their true values. A module receiving a packet will use the same pseudorandom process (or its inverse) to derive the true MAC address value based on the false value.

Network/Subnet. In some scenarios, the IP address can be thought of as a single IDP. However, an IP address is generally defined as including at least two parts which include a network prefix portion and a host number portion. The network prefix portion identifies a network to which a data packet is to be communicated. The host number identifies the particular node within a Local Area Network (“LAN”). A sub-network (sometimes referred to as a subnet) is a logical portion of an IP network. Where a network is divided into two or more sub-networks, a portion of the host number section of the IP address is used to specify a subnet number. For purposes of the present solution, the network prefix, the subnet number and the host number can each be considered to be a separate IDP. Accordingly, each of these IDPs can be separately manipulated independently of the others in a pseudorandom way. Moreover, it will be appreciated that a data packet will include a source IP address and a destination IP address. Accordingly, the network prefix, the subnet number and host number can be manipulated in the source IP address and/or the destination IP address, for a total of six different variable IDPs that can be manipulated in a pseudorandom way. A module receiving a packet will use the same pseudorandom process as an originating node (or the inverse of such process) to derive the true Network/subnet information value based on the false value.

TCP Sequence. Two client computers communicating with each other on opposite sides of a TCP session will each maintain a TCP sequence number. The sequence number allows each computer to track how much data it has communicated. The TCP sequence number is included in the TCP header portion of each packet which is communicated during the session. At the initiation of a TCP session, the initial sequence number value is randomly selected. For purposes of the present solution, the TCP sequence number can be manipulated as an IDP in accordance with a pseudorandom process. For example, the TCP sequence number can be changed to a false value that is selected randomly (e.g. using a pseudorandom number generator). When the packet is received at a different module of the network (the location of which will be dynamically varied), the TCP sequence number can be transformed from a false value back to a true value, using an inverse of the pseudorandom process.

Port Number. A TCP/IP port number is included in the TCP or UDP header portion of a data packet. Ports as used in the TCP/IP communication protocol are well known in the art and therefore will not be described herein in detail. The port information is contained within the TCP header portion of the data packet. Accordingly, manipulation of the port information is accomplished by simply modifying the TCP header information to change a true port value to a false port value. As with the other IDPs discussed here, the port number information can be manipulated or transformed to a false value in accordance with a pseudorandom process at a first module. The port information can later be transformed from a false value to a true value at a second module, using an inverse of the pseudorandom process.

In sum, as explained above, there are many parameters of maneuverability. For example, these parameters include, but are not limited to, IDPs, physical transport medium, payload data (cryptography), transport protocols, end point behavior profile, traffic profile, mathematical function (e.g., for the transformation codes for selecting false IDPs and/or rate of change of IDPs), virtual end point parameters, and/or other maneuver parameters.

### Ontogenesis Engine

The following discussion describes an ontogenesis engine that can be used in a variety of applications. These applications include, but are not limited to, cyber-maneuver applications, robotic applications, autonomous vehicle applications, ethical intelligent behavior applications, predictive behavior model applications, and/or any complex behavior-cognitive multi-agent dynamic system application (e.g., a drone system, an autonomous vehicle or robotic delivery system, ect.). The ontogenesis engine will be described below in relation to the cyber-maneuver applications simply for ease and clarity of discussion. The present solution is not limited to the particulars of the cyber-maneuver applications.

The ontogenesis engine is generally a dynamic behavior defining and control engine which captures, generates and analyzes temporal and contextual knowledge and maintains the same over time. The knowledge may change over time and/or become obsolete. The ontogenesis engine is able to recognize new knowledge, determine when the knowledge needs to be changed, and/or determine when the knowledge becomes obsolete. In response to such determination(s), the ontogenesis engine can modify the knowledge or replace the knowledge with new knowledge.

The knowledge generation of the ontogenesis engine can be integrated with an Observe Orient Decide Act (“OODA”) loop function or framework to improve contextual awareness in multiple dimensions (e.g., time, location, geospatial and haptic) and/or modify system behaviors to produce a desired result. For example, the knowledge of the ontogenesis engine can be used in an OODA loop which causes a CBM (e.g., CBM 1410 of FIG. 14, 1600 of FIG. 16, or 1700 of FIG. 17), a behavior model and/or mission plan (e.g., mission plan 2100 of FIG. 21) to be modified or revised over time.

The ontogenesis engine can be implemented by a centralized computing device (e.g., computing device 2200 of FIG. 22) or have operations that are distributed amongst a plurality of computing devices. For example, in some scenarios, operations of the ontogenesis engine are performed by the NAC 104 of FIG. 1, server 111 of FIG. 1, server 112 of FIG. 1, or another computing device of the network 100 to improve rapid, complex decision making in mission operations, planning and system configuration. However, in other scenarios, operations of the ontogenesis engine are performed by two or more of the listed devices, respectively. The present solution is not limited to the particulars of this example.

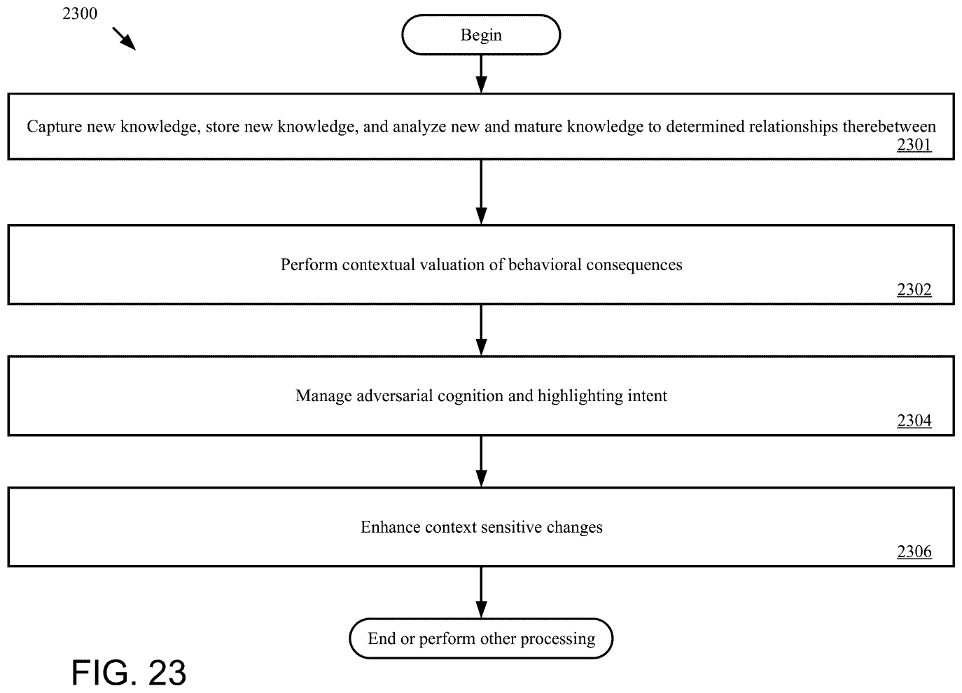

A flow diagram of an illustrative method 2300 that is performed by the ontogenesis engine is provided in FIG. 23. The present solution is not limited to the order of the operations 2304-2306 shown in FIG. 23. The operations 2304-2306 can be performed in the same or different order than that shown in FIG. 23. The order in which operations 2304-2306 is application dependent. Alternatively, the operations 2304-2306 can be discrete operations rather than connected to each other as shown in FIG. 23, can be dependent on other discrete operations, and/or relationships can be defined within the CBMs.

In accordance with method 2300, the ontogenesis engine performs automated ontogenesis (knowledge recognition/acquisition/generation) for the capture and storage of knowledge (e.g., new and existing data objects) as shown by 2301, the creation, analysis and control of contextual valuation of behavioral consequences as shown by 2302, and the enhancement of context sensitive changes as shown by 2306.

With regard to 2301, the ontogenesis engine may capture new knowledge, store new knowledge in a data store (e.g., a database), and analyze the new knowledge and mature (or old) knowledge to determine relationships therebetween. The mature (or old) knowledge comprises knowledge which was previously captured and stored in the data store. The new knowledge is captured, for example, using sensors distributed throughout a computer system or network system. The sensors can include, but are not limited to, environmental sensors, cameras, proximity sensors, biometric sensors, heat sensors, temperature sensors, humidity sensors, motion sensors, and/or location sensors. The new knowledge may additionally or alternatively be captured based on results of a data analysis in which information is inferred or derived. The relationships between new and mature knowledge may be determined based on the inferred or derived information.

With regard to 2302, the context of a given situation is determined based on the new knowledge and/or the mature knowledge previously captured, for example, in 2301. The new knowledge and/or mature knowledge can include information identifying the people or data objects associated with the situation, the behavior of the people or data objects associated with the situation, the objective and/or aims of the people or data objects associated with the situation, the vehicles associated with the situation, the purpose of vehicle operations/behaviors, the computing device(s) associated with the situation, the purpose of the computing device operations/behaviors, the network nodes associated with the situation, the purpose of network node operations/behaviors, and/or the means by which the situation is brought about. This context is also referred to herein as situational context. The terms “context” and “situational context”, as used here, refers to information that describes the reason why something is occurring, the behaviors associated with the situation, the circumstances associated with the situation, and/or the specific setting in which events occur. Techniques for determining situational context by computing devices are well known in the art, and therefore will not be described herein. Any known or to be known technique for determining situational context can be used herein without limitation.

The ontogenesis engine defines parameters, factors and/or coefficients for a plurality of different sets of actions that could occur in the situational context. For example, in the cyber maneuver applications, the situation can include, but is not limited to, enabling a network to exhibit a behavior and resultant structure to entice attack vectors from adversaries or opponents. The context can include, but is not limited to, strengthening a network prior to upgrading or strengthening a network after a coordinated attack effort. The different sets of actions can include, but are not limited to, creation of a shadow network to set one or more operations for identifying the adversary and/or obtaining an understanding of the adversary's behavior. The parameters can include, but are not limited to, false IDPs, identifiers for network nodes that are perform the IDP translations, and/or a time period for performing the IDP translations. The factors can include, but are not limited to, a number of shadow networks and/or the maneuver velocities The coefficients can include, but are to limited to, rate of maneuver of individual IDPs. The present solution is not limited to the particulars of this example.

The ontogenesis engine then simulates the sets of actions to generate predicted consequences resulting from the performance of certain behaviors by the people, vehicle(s), computing device(s) and/or network nodes in the context of the situation. Techniques for simulating sets of actions of network systems, computer systems and/or other electronic devices (e.g., vehicles) are well known in the art, and therefore will not be described herein. Any known or to be known simulation technique can be used herein. In some scenarios, computer models of the network systems, computer systems and/or other electronic devices are used to facilitate the simulations.

In the cyber maneuver scenarios, the simulations performed by the ontogenesis engine are intended to present information to adversaries in an environment and determine the intent of the adversaries utilizing various tactics (e.g., a strategy planned to achieve a specific end (or mission objective) and maneuver tenets (e.g., a principle of network maneuverability for implementing a specific offensive, defensive or intelligence collection strategy (or tactic).

The predicted consequences are then evaluated to determine their relative values. In some scenarios, the relative values are determined based on whether or not certain actions, conditions or results are reflected by the predicted consequences. For example, if the predicted consequence is more desirable to a given individual or entity, then the predicted consequence is deemed to have greater value than other predicted consequence which are less desirable to the given individual or entity. If a predicted consequence indicates that one or more individuals will incur an injury (or alternatively will not incur an injury) as a result of performance of the corresponding behavior by the individual(s)/vehicle(s)/computing device(s)/network node(s), then that predicted consequence is deemed to have less value (or alternatively greater value) than the other predicted consequence(s) which indicate that no injuries will result from performance of the corresponding behavior by the individual(s)/vehicle(s)/computing device(s)/network node(s). If a predicted consequence indicates that a monetary profit will result from performance of the corresponding behavior by the individual(s)/vehicle(s)/computing device(s)/network node(s), then the predicted consequence is deemed to have a greater value than other predicted consequence(s) that indicate a monetary loss will result from performance of the corresponding behavior by the individual(s)/vehicle(s)/computing device(s)/network node(s). If the predicted consequence indicates that benefits will be bestowed on people or entities directly or indirectly involved in the situation, then the predicted consequence is deemed to have greater value than other predicted consequence which indicate that people/entities will not experience any benefits. One or more different factors can be considered when determining the relative values of predicted consequences. Accordingly, weights may be used to reflect the factors relative importance. For example, injury is weighted greater than monetary gain. The present solution is not limited to the particulars of this example.

As a result of the evaluation, each predicted consequence may be assigned a number representing its relative value. For example, a first predicted consequence is assigned a one and a second predicted consequence is assigned a five. These two numbers one and five indicate that the second predicted consequence has a greater value then the first predicted consequence. The present solution is not limited in this regard.

With regard to 2304, an analysis is performed to determine whether an adversary or opponent would be able to recognize the intent of the behavior associated with one or more of the predicted consequences (e.g., the N predicted consequences with the greatest or least value, when N is an integer equal to or greater than one). This analysis involves: observing the behavior of the adversary or opponent; making inferences from the observed behavior about the intelligence and technological capabilities of the adversary or opponent; and using the inferences and simulations to determine whether or not the adversary or opponent is likely to recognize the intent of the behavior associated with one or more of the predicted consequences or to get the adversary to respond to a particular behavior. These actions are tools to reveal what are the aims of the adversary's behavior/intent and/or to hide the implemented behavior for protecting the network from reconnaissance by the adversary. Computer implemented methods for making inferences about the intellectual and/or technological capabilities of adversaries and/or opponents based on observed behaviors are well known in the art, and therefore will not be described herein. Any known or to be known computer implemented method for making inferences about the mental and/or technological capabilities of adversaries and/or opponents based on observed behaviors can be used herein.

Based on results of the analysis performed in 2304, a predicted consequence is selected by the ontogenesis engine. For example, the ontogenesis engine selects the predicted consequence that is associated with the least likely possibility that the adversary or opponent will recognize the intent of the behavior associated therewith. Next, the ontogenesis engine causes the behaviors associated with the selected predicted consequence to be performed by individual(s), vehicle(s), computing device(s), and/or network node(s). For example, in the cyber maneuver applications, one or more CBMs and/or mission plans is modified. In effect, the locations at which IDPs are modified within a network is changed and/or the IDPs which are to be modified in the network are changed. The present solution is not limited to the particulars of this example.

With regard to 2306, a data analysis is performed to detect changes therein. In some scenarios, the behaviors which the individual(s), vehicle(s), computing device(s) and/or network node(s) performed in 2304 cause the change in the data. In other scenarios, the change in data results from the behavior of another individual, vehicle, computing device and/or network node which was not caused by the ontogenesis engine in 2304. If the change indicates that a particular event occurred (e.g., a funny noise was generated by a car or a system error/fault was detected by a network node), then the behavior of one or more individuals, vehicles or network nodes is controlled to cause the particular event to occur once again so that more data is elicited which can be used to uncover the meaning of the change in data, what is prompting the change in the data, and/or what is the cause of the change in data. This information provides an understanding of the situational context and the sensitivity to the changes in the behavior of the individual(s), vehicle(s), computing device(s) and/or network node(s).

In the cyber-maneuver application, the above described process 2300 provides a dynamic behavioral learning engine that: acquires and revises behavioral models and activity repertoire over time; and correlates behaviors to behavior goals by leveraging scenario testing/simulation and the influence of moderating and mediating variables (for example, destruction may not be an option). The process 2300 drives the maturity of relevant behavior libraries incorporating OODA loop factual learning, and provides a measure of effectiveness and efficiency of CBMs, behavior models and/or mission plans.

Notably, human experience and processing is governed by physical limitations and artifacts of biological cognition (forgetting, narrow consciousness, attentional limits, lack of self-awareness and patterns, failure to retrieve relevant information, and/or self-interest). The ontogenesis engine augments (ameliorates cognitive and physical limitation of) humans during critical decision making (more options=more time to decide). The ontogenesis engine evolves to serve the human to decrease workload, enhance behaviors, improve decisions, accelerate changes, and increase overall human effectiveness.

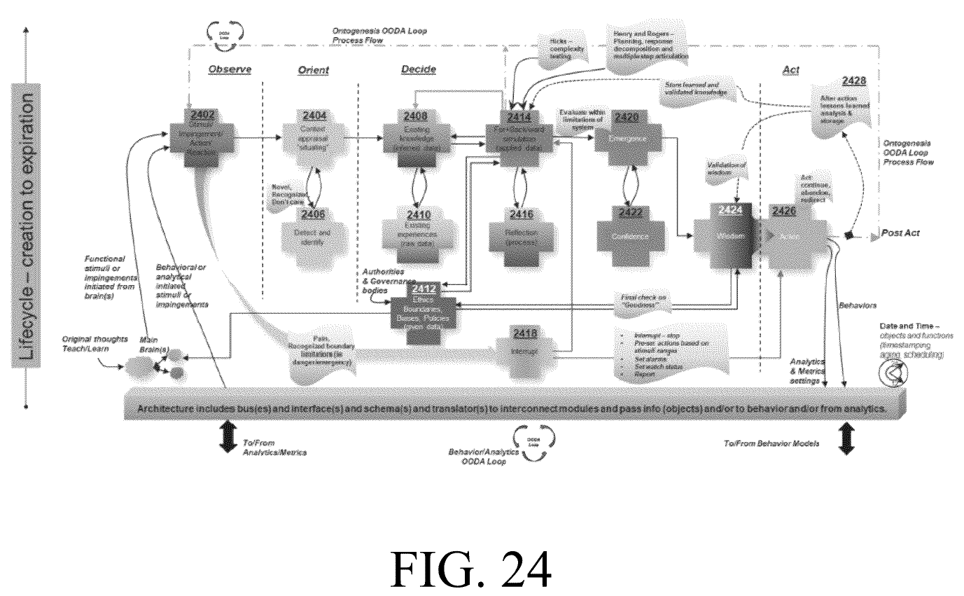

Referring now to FIG. 24, there is provided an illustration of an illustrative architecture 2400 for the ontogenesis engine. The ontogenesis engine comprises a non-transitory computer-readable storage medium comprising programming instructions that are configured to cause one or more processors (e.g., CPU 2204 of FIG. 22) to implement the process 2300. The programming instructions comprise instructions to cause operations of modules 2402-2426 to be performed in a manner similar to an OODA loop, overlaid on an OODA loop process, and/or at least partially embedded within an OODA loop of a system (e.g., system 100 of FIG. 1). For example, operation of module 2402 may correspond to the observe portion of the OODA loop, operations of modules 2402-2406 may correspond to the orient portion of the OODA loop, operations of modules 2408-2424 may correspond to the decide portion of the OODA loop, and operation of module 2426 may correspond to the act portion of the OODA loop. The term “module”, as used herein, refers to a part of a software program and/or the hardware on which the software program is loaded and run.

The operations of module 2402 involve detecting occurrences of and collecting data related to a newly detected conditions, a stimuli and/or an impingement action. The stimuli and/or impingement action can result from sensor operations, system training operations and/or system learning operations. The stimuli can include, but is not limited to, a particular event involving an individual, vehicle, computing device or network node (e.g., a vehicle crash or a network node fault/error), and/or a change in a measured surrounding environment's characteristic (e.g., heat, moisture, light, etc.). The impingement action can include, but is not limited to, a cyber-attack occurrence, a change in an object's relationship with a data object, and/or an object that changes proximity to an individual, vehicle, computing device, network node, or data object.

The operations of module 2404 involve performing an analysis of the data collected in module 2402 to determine the situational context associated with the stimuli and/or impingement action. The situational context can include, but is not limited to, a time, a location, information specifying characteristics of at least one individual, information specifying characteristics of at least one vehicle, and/or information specifying characteristics of a surrounding environment. A situational context of a given situation may be determined based on the people or data objects associated with the situation, the behavior of the people or data objects associated with the situation, the objective and/or aims of the people or data objects associated with the situation, the vehicles associated with the situation, the purpose of vehicle operations/behaviors, the computing device(s) associated with the situation, the purpose of the computing device operations/behaviors, the network nodes associated with the situation, the purpose of network node operations/behaviors, and/or the means by which the situation is brought about.

The operations of 2406 involve analyzing the data collected in 2402 to detect and identify any individual, object, and/or inferred relationship associated with the impingement action. For example, the data analysis identifies a person that is in close proximity to a given unmanned ground vehicle, identifies a vehicle that is in close proximity to a given building, identifies an unmanned aerial vehicle that is in close proximity to an air craft carrying people, and/or determines an inferred relationship between two or more data objects. The present solution is not limited to the particulars of this example.

The operations of modules 2408-2424 are performed to determine whether an action should be taken in view of the stimuli and/or impingement action, and if so what action should be taken in 2426. In a cyber-maneuver application, the action taken can include, but is not limited to, revising CBMs/behavioral models/mission plans, and revising activity repertoire.

Operations of 2408 involve analyzing an existing knowledge data store 2410 to determine if actions, given a CBM, were previously performed by an individual, vehicle and/or network node when the same or similar stimuli and/or impingement action occurred on one or more previous occasions. If so, then a determination is made as to whether the total number of stimuli and/or impingement action occurrences exceeds a threshold number. A determination may also be made as to whether the stimuli and/or impingement action occurred at least once during a threshold period of time. However, operations of 2408 also involve whether the stimuli and/or impingement action is new and/or related to another data object. If so, then a new information object and information specifying the new information object's relationship with the another data object are stored in the knowledge data store, and subsequently used in simulation operations. For example, if a new attack vector is identified and determined to be related to a previous attack vector, then a data object for the new attack vector is stored in the knowledge data store along with information indicating the relationship between the new and previous attack vectors.

If the stimuli and/or impingement action previously occurred less than or more than a threshold number of times and/or occurred within a threshold period of time, then simulation operations of module 2414 are performed using results of previous simulations associated with the particular stimuli and/or impingement action. For example, the sets of parameters, factors and/or coefficients used in previous simulations are used to generate new sets of parameters, factors and/or coefficients. At least one value of each new set has a different value than that of a corresponding previous simulation set value. In some scenarios, new sets of parameters/factors/coefficients are generated by incrementally increasing and/or decreasing at least one previous simulation's value within a pre-defined range (e.g., ±1 until the value reaches a certain level).

The new sets of parameters, factors and/or coefficients are used by module 2414 to simulate certain behaviors by individual(s), vehicle(s) and/or network nodes in the context of the situation. The simulation operations of module 2414 are performed in accordance with relevant ethical polices, ethical rules, and/or pre-defined boundary governance definitions stored in the data store (2412). The ethical policies in 2412 establish expectations for system performance, vehicle performance, network node performance, and/or individual performance. The ethical rules define mechanisms for ensuring ethical policy compliance. The boundary governance definitions describe what is included in and/or excluded from the scope of certain projects or missions. The simulation operations of 2414 produce one or more predicted consequences.

If the stimuli and/or impingement action did not previously occur more than the threshold number of times and/or did not occur within the threshold period of time, then the raw data associated with the previously performed action(s) is (are) retrieved by module 2410 from the data store. The raw data is then used in module 2414 to simulate certain behaviors by individual(s), vehicle(s), computer device(s) and/or network nodes in the context of the situation. For example, the raw data is used to generate sets of parameters/factors/coefficients to be used for the simulation of system operations in the context of the situation. The simulation operations of module 2414 are performed in accordance with relevant ethical polices, ethical rules, and/or pre-defined boundary governance definitions stored in the data store.

In the case where this is the first occurrence of the stimuli and/or impingement action, the ontogenies engine 2400 generates one or more sets of parameters/factors/coefficients to be used in the simulation operations of module 2414. The sets of parameters/factors/coefficients are generated based on a random selection scheme, an arbitrary selection scheme, an additive selection scheme, a substantive selection scheme, and/or a behavior changing scheme. The random selection scheme involves randomly selecting values from within a pre-defined range of values. The arbitrary selection scheme involves arbitrarily selecting values from within a pre-defined range of values. The additive selection scheme involves adding pre-specified amounts to a pre-defined initial value. The subtractive selection scheme involves subtracting pre-specified amounts from a pre-defined initial value. The behavior changing scheme involves using sets of values which cause different known behaviors.

After the simulations are performed, the predicted consequences are then evaluated in module 2414 to determine their relative values based on certain criteria. In some scenarios, the relative values are determined based on whether or not certain actions, conditions or results are reflected by the predicted consequences. For example, if a predicted consequence indicates that one or more individuals will incur an injury as a result of performance of the corresponding behavior by the individual(s)/vehicle(s)/computing device(s)/network node(s), then that predicted consequence is deemed to have less value than the other predicted consequence(s) which indicate that no injuries will result from performance of the corresponding behavior by the individual(s)/vehicle(s)/computing device(s)/network node(s). If a predicted consequence indicates that a monetary profit will result from performance of the corresponding behavior by the individual(s)/vehicle(s)/computing device(s)/network node(s), then the predicted consequence is deemed to have a greater value than other predicted consequence(s) that indicate a monetary loss will result from performance of the corresponding behavior by the individual(s)/vehicle(s)/computing device(s)/network node(s). If the predicted consequence is more desirable to a given individual or entity, then the predicted consequence is deemed to have greater value than other predicted consequence which are less desirable to the given individual or entity. If the predicted consequence indicates that benefits will be bestowed on people or entities directly or indirectly involved in the situation, then the predicted consequence is deemed to have greater value than other predicted consequence which indicate that people/entities will not experience any benefits. One or more different factors can be considered when determining the relative values of predicted consequences. Accordingly, weights may be used to reflect the factors relative importance. For example, injury is weighted greater than monetary gain. The present solution is not limited to the particulars of this example.

As a result of the evaluation, each predicted consequence may be assigned a number representing its relative value. For example, a first predicted consequence is assigned a one and a second predicted consequence is assigned a five. These two numbers one and five indicate that the second predicted consequence has a greater value then the first predicted consequence. The present solution is not limited in this regard. At least one of the predicted consequences is selected based on the relative values thereof. For example, the predicted consequence with the greatest or lowest value is selected. The present solution is not limited to the particulars of this example.

In module 2416, a validation is made as to whether the selected predicted consequence of the simulation operations will likely achieve a desired or particular outcome (e.g., another occurrence of the stimuli or the resolution of system error/fault). A comparison function is employed here to make this validation. The comparison function involves comparing the parameters/factors/coefficients in the set associated with the selected predicted consequence with data stored in the existing knowledge data store and/or data represented by other simulation results to determine tolerances for each parameter/factor/coefficient and the selected predicted consequence. The existing knowledge data store includes information specifying previous actions taken by individuals, vehicles, computing device(s) and/or system nodes, information specifying the results from performing those actions, and/or information specifying values of parameters, factors and/or coefficients associated with the actions.

The operations of module 2418 involve interrupting operations of the ontogenesis engine 2400 when a particular stimuli and/or impingement action is detected. As a result of the interruption, at least one pre-programmed course of action is caused by module 2426 to be taken by the system and/or the simulation operations of 2414 are re-performed using different parameters/factors/coefficients selected in accordance with the context of the stimuli and/or impingement action. In the cyber maneuver applications, the pre-programmed courses of action can include, but are not limited to, performing system operations in accordance with a given original behavior model, CBM and/or mission plan, and/or performing system operations in accordance with a given modified behavior model, CBM and/or mission plan.

The operations of module 2420 involve determining which system actions from a set of allowable actions (determined from 2414 simulation(s)) should be performed in view of the selected predicted consequence. The set of allowable actions is computed in accordance with the following set theory equations. The set theory equations are illustrated herein in relation to a cyber maneuver system application. However, the present solution is not limited in this regard, and the set theory equations shown below can be modified in accordance with any application.
S_{AA}=set of allowable actions {S_{AA}}={AA₁; . . . ; AAₓ} as determined in the simulation operations of 2414.

$$If {P}_{SA} = f ( x ) \cdot ( {N}_{A} / \vert {M}_{S} \vert ) ,$$

P_{SA} represents the probability of a successful attack on the network and is defined in U.S. patent application Ser. No. 15/362,936 (which is incorporated herein by reference in its entirety),
N_{A} represents the number of attacks,
M_{S} represents a size of maneuver space,
f(x) is a behavioral function,
f(x) Beh_{D} is a defensive behavioral functional,
f(x) Beh_{O} is an operational behavioral functional, and
f(x) Beh_{I} is an information gathering behavioral functional (e.g., like setting up a maneuverable shadow network), then

$${{\{ {S}_{AAA} \} = {S}_{AAA} \vert max \vert of [ 100 - ( Sim f ( x ) ( {Beh}_{D} ) \cdot ( {N}_{A} / \vert {M}_{S} \vert ) + {C}_{MC} ] {\vert}_{Tenet 0}^{Tenetx} , \{ {S}_{AAB} \} = {S}_{AAB} \vert max \vert of [ ( Sim f ( x ) ( {Beh}_{O} ) \cdot ( {N}_{A} / \vert {M}_{S} \vert ) + {C}_{MC} ] \vert}_{Tenet 0}^{Tenetx} , and \{ {S}_{AAC} \} = {S}_{A A C} \vert max \vert of [ ( Sim f ( x ) ( {Beh}_{I} ) \cdot ( {N}_{A} / \vert {M}_{S} \vert ) + {C}_{MC} \vert}_{Tenet 0}^{Tenet x} .$$

Given the desired ontogenic knowledge, campaign goals, and/or contextual situational environment, the construction of emergent S0

$$EmergS 0 = \vert \begin{matrix}{AA}_{A} if {AA}_{A} \geq {AA}_{B} and \geq {AA}_{C} \\ {AA}_{B} if {AA}_{B} \geq {AA}_{A} and \geq {AA}_{C} \\ {AA}_{C} if {AA}_{C} \geq {AA}_{A} and \geq {AA}_{B}\end{matrix} \vert .$$

However, given a particular growth of C_{MC}, the EmergS0 will grow over time in accordance with the following mathematical equation.

$$Emerg S 0 = {AA}_{A 1} + {AA}_{B 1} + {AA}_{C 1} , or some variant of some \\ f ( x ) [ \{ {AA}_{Ax} \} + \{ {AA}_{Bx} \} + \{ {AA}_{Cx} \} ]$$

Where C_{MC} represents a mathematical time growth value (number) determined from historical data or ontogenic insight, or algorithms within a range of {0<->x}, where higher values represent a more mature or capable actor (of actions/behaviors against the system). Lower values are derived from historical data where an action (behavior) was successful against an opposing action (behavior from an actor). In the cyber maneuver applications, the system actions can include, but are not limited to, the modification of one or more behavior models, CBMs and/or mission plans. For example, the system action involves modifying which IDPs are to be changed during a given period of time. The present solution is not limited to the particulars of this example.

The operations of module 2422 involves analyzing the system action(s) to determine a confidence level that a given result will occur in view of the set of tolerances determined 2416 and a probability of success. In some scenarios, the confidence level is computed in accordance with the following mathematical equations.

$$CL = \{ max of wn \} {\vert}_{{w}_{1} {n}_{1}}^{{w}_{x} {n}_{x}} {P}_{C} = f ( x ) \cdot CL$$

CL represents a confidence level which is optimized based on at least the tolerance values and existing knowledge of system past operations. n₁, . . . , nₓ represent parameter/factor/coefficient values. w₁-wₓ represent weighting values selected based on the respective tolerances. P_{C} represents a probability of success of the solutions being able to define and control the dynamic behavior within the defined operating envelop obtained from simulation operations. CL is determined against each simulation result using the respective tolerance values and existing knowledge of system past operations. If a set of confidence levels are above a threshold value and corresponding probabilities of successful system controls and behaviors are within an operating envelope, the system action(s) is passed to block 2424. Otherwise, the system action(s) are discarded and another iteration of 2408-2422 is performed using different parameters, factors and/or coefficients for the simulation.

The operations of module 2424 involves comparing the system action to the contents of a data store that specifies previously performed system actions and consequences thereof. The results of this comparing can provide insight into whether the system action might cause an unintended consequence which is not desirable, might cause an intended consequence which is desirable, and/or can be improved to obtain optimal consequences. If unintended consequences might occur, then a determination is made as to whether one or more ethical rules/policies and/or boundaries will still be met if the corresponding behavior is performed. The system action is not taken when the ethical rules/policies and/or boundaries will not be met. However, there are exceptions when the ethical rules/policies and/or boundaries are overridden (e.g., by an appropriate authority such as a law enforcement official). In contrast, the system action will be taken in 2426 when the ethical rules/policies and/or boundaries will still be met, and the actions and effects will be tracked over time. For example, the ontogenesis engine 2400 causes a behavior model, CBM and/or mission plan to be modified, as well as causes the system to perform operations in accordance with the modified behavior model, CBM and/or mission plan and/or causes the system to watch and measure the analytics according to U.S. patent Ser. No. 15/362,936 (which is incorporated herein by reference in its entirety). The present solution is not limited to the particulars of this example.

An after action analysis may optionally be performed in 2428 to validate the wisdom and store the data associated with the performed system action(s). Also, this after action analysis may occur over a given period of time.

The ontogenesis engine 2400 is comprised of ontogenesis memory objects, architecture components (e.g., interface(s) and service bus 2430 of FIG. 24), functions, and processes. Each module 2402-2426 is implemented by one or more of these listed components of the ontogenesis engine 2400.

An ontogenesis memory object comprises a storage space in a data store (e.g., a database or other memory) intended to keep permanently all related information about a concrete physical individual, vehicle, network node, or item. The ontogenesis memory object comprises a plurality of information segments arranged by topics. The topics are linked to each other in a mesh-like configuration, where the links represent respective associations between the topics. One or more of the topics may comprise sub-topics that are also linked to each other in a mesh-like configuration, where the links represent respective associations between the sub-topics. The information segments contained in the ontogenesis memory object can be static over time or dynamically change over time in accordance with a given application.

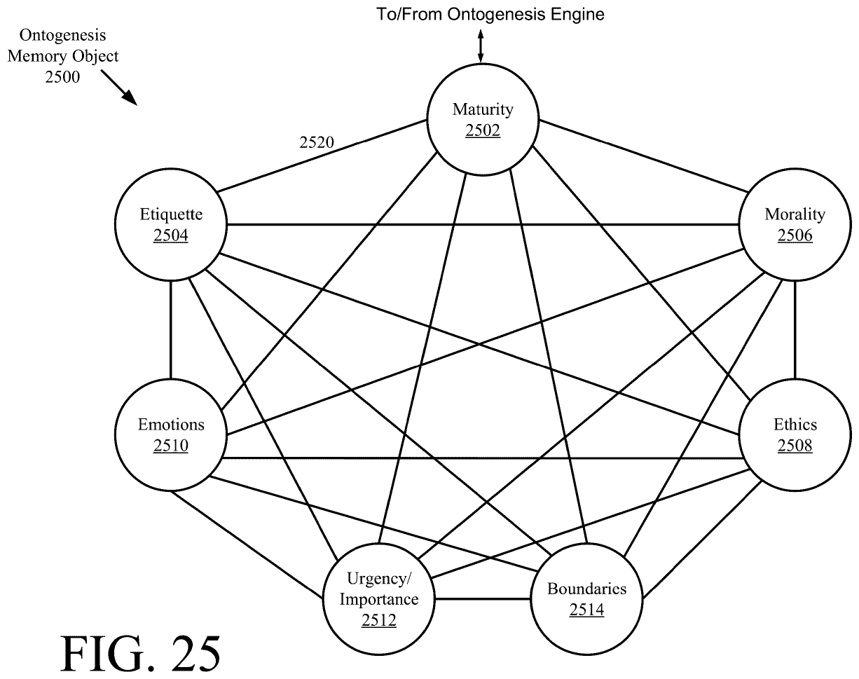

For example, in the scenario shown in FIG. 25, an ontogenesis memory object 2500 for an individual includes information segments 2502-2514 arranged by topics in a mesh-like configuration. The mesh-like configuration comprises links 2520 that represent respective associations or relationships between the topics or information segments 2502-2514. The information segment 2502 includes information associated with the individual's maturity (e.g., lifespan, age, birth date, and/or reason for birth). The information segment 2504 includes information associated with the individual's or object's etiquette. The information segment 2506 includes information associated with the individual's or object's morality. The information segment 2508 includes information associated with the individual's or object's ethics. The information segment 2510 includes information associated with the individual's or object's emotions. The information segment 2512 includes information associated with the individual's urgency or importance. The information segment 2514 includes information associated with the individual's boundaries (e.g., physical, emotional, health, and safety). The present solution is not limited to the particulars of this example.

The functions comprise the operations that access, use, analyze and/or modify the ontogenesis memory objects to facilitate the generation and maintenance of knowledge. The functions can include, but are not limited to, health checks and status checks. Health and status checks are well known in the art, and therefore will not be described herein. Any known or to be known health check and/or status check can be used herein without limitation.

The functions also include maintenance operations to adjust or replace parameter values in accordance with given applications. The maintenance operations can involve: identifying system error(s) and/or fault(s); performing simulations using different sets of parameter values to generate predicted consequences; analyzing the predicted consequences to determine the respective values thereof; selecting the predicted consequence with the greatest or lowest value; and using the set of parameter values associated with the selected predicted consequence to adjust the system so as to resolve the system error(s) and/or fault(s). The system can be adjusted by modifying or replacing one or more parameter values with the parameter values in the set associated with the selected predicted consequence.

The functions further include planning operations to determine how often the health/status checks will be performed. The health/status checks may be performed in accordance with a pre-defined schedule, at pre-defined times (e.g., every 3 months), or in reaction to a given event. For example, the system notices a contextual change in the data. In response, the schedule for health/status checks is modified in accordance with the contextual change (e.g., changed from every three months to every week).

The functions include action operations that are performed based on the cognitive simulation outcome. The action can include, but is not limited to, changing other functions of the ontogenesis engine and/or changing one or more parameters of a CBM, behavior model, and/or mission plan. The action can be performed in accordance with a system described in U.S. Pat. No. 10,243,993. The contents of which are incorporated herein by references.

In some scenarios, a health/status/progress check is caused to be performed when such an action occurs within the system. The results of the check may include, but are not limited to, analytics or other metrics which can be used in subsequent maintenance operations and/or planning operations. The progress check can be performed in accordance with a system described in U.S. patent Ser. No. 15/362,936. The contents of which are incorporated herein by references.

The processes include the program code which causes simulation activities to be performed by the ontogenesis engine 2400. The program code can implement procedures defining ways of performing simulations. The procedures can include, but are not limited to, original operating procedures, standard operating procedures, if-then-else statement procedures, step-by-step processing procedures, parallel processing procedures, morphing procedures to add/subtract/change behaviors of individuals/vehicle/network node, and/or procedures for modifying behaviors of individuals/vehicle/network node. The program code can alternatively or additionally implement functions defining ways in which actions are to be performed. The functions can include, but are not limited to, operational pausing functions, back-up functions, flight/fight functions, sacrifice for greater good functions, growth/maturity functions, and/or vetting/adjusting CBMs for cyber maneuver systems.

Given the experimentations by Hicks and Henry & Rodgers, ontogenesis architectures and program code may also implement multiple architectures of parallel processing and complexity segmentation to maintain low response times.

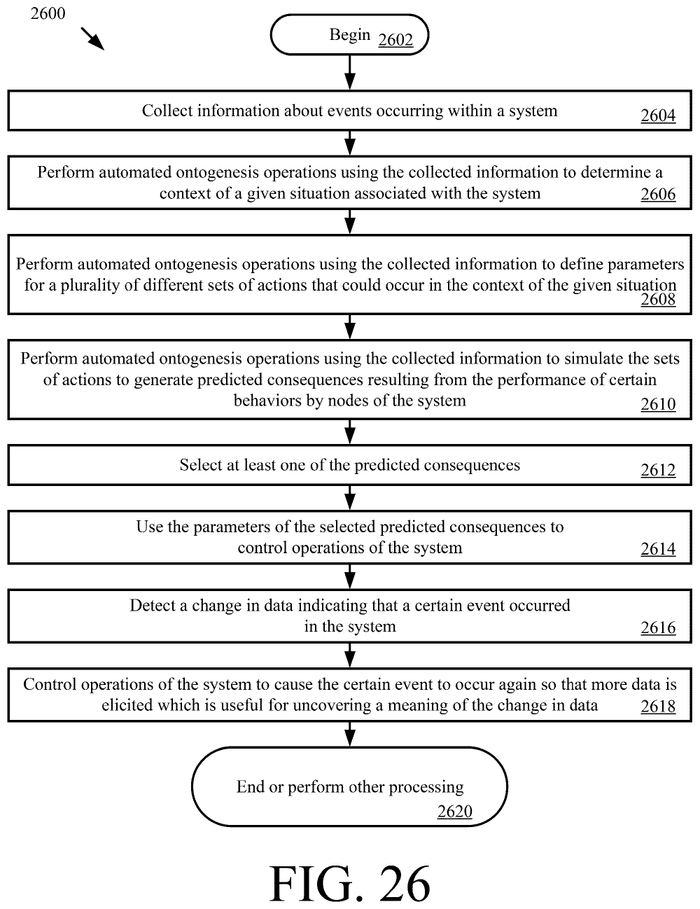

Referring now to FIG. 26, there is provided a flow diagram of an illustrative method 2600 for operating a network system (e.g., system 100 of FIG. 1). Method 2600 begins with 2602 and continues with 2604 where information about events occurring in the network system is collected. In 2606-2610, automated ontogenesis operations are performed using the collected information to determine a context of a given situation associated with the network system, define parameters for a plurality of different sets of actions that could occur in the context of the given situation, and simulate the sets of actions to generate predicted consequences resulting from the performance of certain behaviors by network nodes of the network system. The context may be defined by identities of individuals or data objects associated with the situation, behaviors of the individuals or data objects associated with the situation, objective and/or aims of the individuals or data objects associated with the situation, identifies of vehicles associated with the situation, a purpose of vehicle operations, identifies of network nodes associated with the situation, behaviors of the network nodes, a purpose of network node operations, and means by which the situation was brought about.

Upon completing the automated ontogenesis operations, at least one of the predicted consequences is selected as shown by 2612. In some scenarios, the predicted consequence is selected by: determining relative values of the predicted consequences; and selecting a predicted consequence from the predicted consequences which has a greatest or lowest value of all the relative values. Alternatively or additionally, the predicted consequence is selected by: determining whether an intent of behavior associated with each of the predicted consequences is recognizable by an adversary; and selecting a predicted consequence from the predicted consequences with an intent of behavior that is unrecognizable by the adversary. In 2614, the parameters of the selected predicted consequence are used to control operations of the network system. In cyber maneuver applications, the network system is controlled to so that a CBM, behavior model and/or mission plan is modified.

In 2616, a change in data is detected. The change indicates that a certain event occurred in the network system. Operations of the network system are controlled in 2618 so as to cause the certain event to occur again so that more data is elicited which is useful for uncovering a meaning of the change in data. Subsequently, 2620 is performed where method 2600 ends or other processing is performed (e.g., return to 2604).

### Ontogenetic AI DNA Generation

As AI continues to advance, there is a need to know how AI engines arrive at their answers (i.e., their genealogy of their reasoning) and the maturity (i.e., confidence) of their answers especially for critical mission operation success. The present solution builds genealogies with secure provenance enabling human review and comprehension via readable mappings (decision genealogies for intelligent situational awareness). This kind of technology coupled with the above-described ontogenesis engine 2400 can provide the framework defining how AI engines arrive at their answers with confidence. The DNA AI intelligence structures can be stored in physical structures (e.g., flight recorders) for post-accident analysis.

The present solution can be used in various applications. Such applications include, but are not limited to, cyber warfare, aviation, space, military, medical research, gaming, crime prediction and solving, banking and investing, business automation, entertainment and automotive.

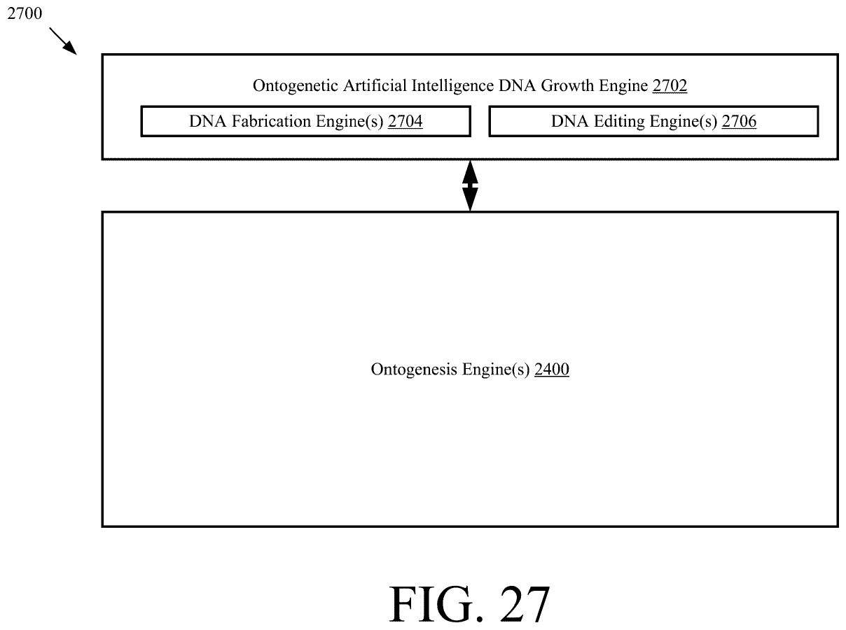

FIG. 27 provides an illustration of a system 2700 comprising an ontogenetic AI DNA growth engine 2702 that is configured to generate and/or edit ontogenetic DNA. The ontogenetic DNA may be used, for example, by the ontogenesis engine 2400 to perform some or all of the above discussed operations of one or more modules 2402-2426.

System 2700 comprises a DNA generation engine 2704 and a DNA editing engine 2706. The DNA fabrication engine 2704 is generally configured to generate ontogenetic DNA. The DNA editing engine 2706 is generally configured to enable editing of the ontogenetic DNA in a secure manner.

The ontogenetic DNA comprises an AI knowledge genealogy structure capturing the ontogenetic growth of intelligence, reasoning, decisions, wisdom, maturity and justified levels of confidence within the ontogenesis engine 2400 and/or other AI engines. The ontogenetic DNA structure contains editable backbone(s), strings and branches of intelligence reasoning and logic with embedded security. The ontogenetic DNA provides the historical source key linking intelligence, reasoning and behavior allowing: retrospective and futurespective behavior and/or mission analysis; examinations of ethical consequences, legal review and behavior replay; and paradigm shifting solution analysis.

The ontogenetic DNA may be constructed using additive graphs and set theory ontogenetic AI DNA structures with corresponding ontologies. The adaptive graphs can contain knowledge growth mappings, execution confidence analysis, graph and genealogy mathematics and editing techniques, and security protections. The knowledge growth mappings can include, but are not limited to, maturity and growth histograms. The security protections can include, but are not limited to, unique coded identifiers added to links and nodes for forgery and change protection. The security protections can support multi-path encryption for forgery highlighting.

Relationships between the ontogenetic AI DNA structures may be defined using mappings and validation techniques. Histograms and lineage examination techniques can be used for intelligence analysis, editing and adaptation strategies of ontogenetic AI DNA structures. For example, two ontogenetic AI DNA structures can be combined to form another ontogenetic AI DNA structures. A portion of an ontogenetic AI DNA structure may be removed and/or copied therefrom or added to another ontogenetic AI DNA structure. Security algorithms may be employed to protect the ontogenetic AI DNA structures from corruption or malicious modifications.

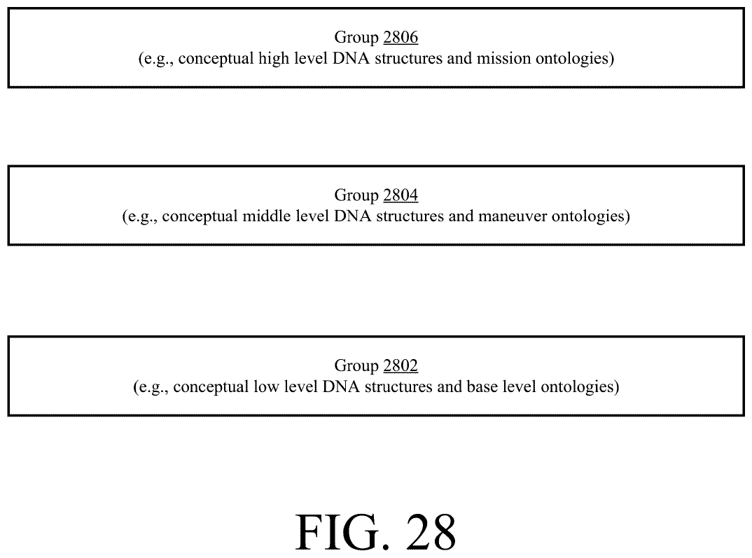

There may be one or more groups of ontogenetic DNA. For example, as shown in FIG. 28, the ontogenetic AI DNA structures can be arranged or assigned to three different groups 2802-2806. Group 2802 may comprise conceptual low level ontogenetic AI DNA structures and base level ontologies. The base level ontologies can include, but are not limited to, cybersecurity definitions and rules. For example, a base level ontology can define a cyber behavior model.

Group 2804 may comprise conceptual middle level ontogenetic AI DNA structures and maneuver ontologies. The maneuver ontologies can include, but are not limited to, maneuver definitions and rules. For example, a maneuver ontology can define a manner in which a computer network is to operate for purposes of thwarting a cyber-attack, responding to adversarial probing, or thwart adversaries' understanding of a network architecture.

Group 2806 may comprise conceptual high level ontogenetic AI DNA structures and mission ontologies. The mission ontologies can include, but are not limited to, mission definitions and rules. For example, a mission ontology can define a mission plan and/or a mission model.

The ontogenetic DNA structures of groups 2802-2806 are interconnected and interleaved to and within the modules 2402-2426 of the ontogenesis engine 2400. The ontogenetic DNA structures may be updated to maintain historical source keying between intelligence knowledge stacks, reasoning and behavior.

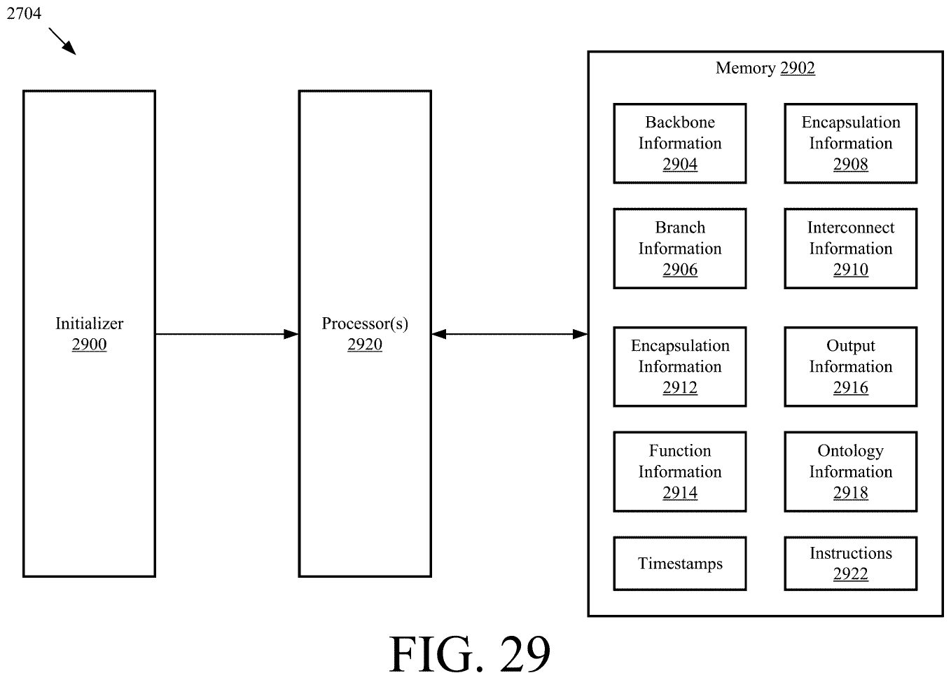

FIG. 29 provides a more detailed illustration of the DNA fabrication engine 2704. The DNA fabrication engine 2704 comprises an initializer 2900, processor(s) 2920 and a memory 2902. Information from the ontogenesis engine 2400 is provided as inputs to the DNA fabrication engine 2704, for example, via processor(s) 2920. Instructions and various information 2904-2918 are stored in memory so as to be accessible to processor(s) 2920. The memory 2902 may include datastore(s), a volatile memory and/or a non-volatile memory. One or more sets of instructions 2922 are stored in the memory 2902. The instructions 2922 can also reside, completely or at least partially, within the processor(s) 2920 during execution thereof by the DNA fabrication engine 2704. In this regard, the memory and the processor(s) can constitute machine-readable media. The term “machine-readable media”, as used here, refers to a single medium or multiple media that store the one or more sets of instructions. The term “machine-readable media”, as used here, also refers to any medium that is capable of storing, encoding or carrying the set of instructions for execution by the DNA fabrication engine and that cause the DNA fabrication engine to perform one or more of the methodologies of the present disclosure. It should be noted that the output information 2916 includes behavior models and/or analytics in addition to associated DNA information.

### Ontogenesis AI DNA Growth

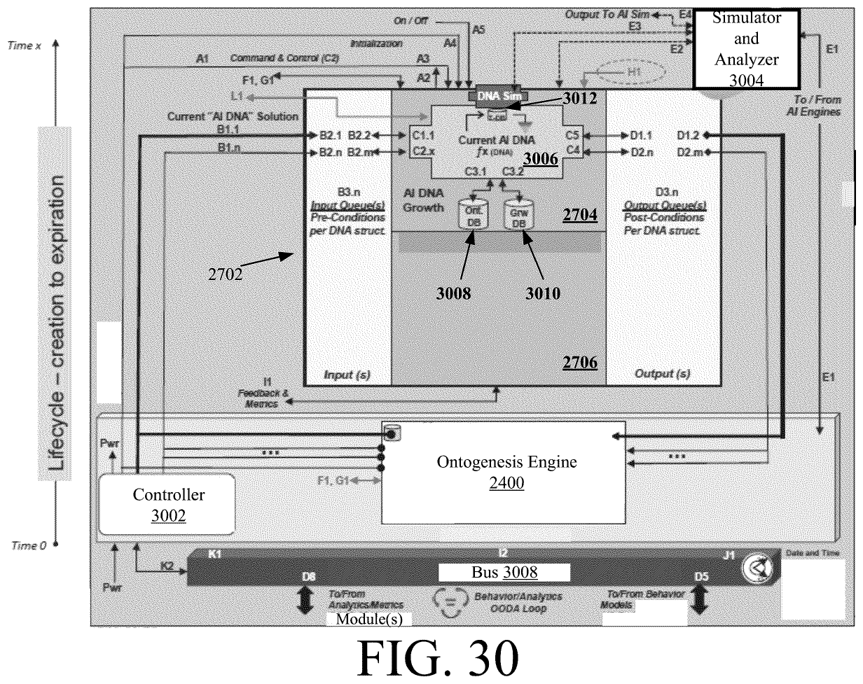

FIG. 30 provides an illustration that is useful for understanding operations of the ontogenetic AI DNA growth engine 2702 shown in FIG. 27. The ontogenetic AI DNA growth engine 2702 is communicatively connected to a controller 3002, the ontogenesis engine 2400, a simulation and analyzer 3004, and a system bus 3008. Signals are communicated between the listed components during operation of the system. These signals are categorized into the following categories: a command and control category A, a data input category B, a data category C, a data output category D, an after action analysis category E, a handshake category F, a check category G, an interrupt category H, a feedback and control metric category I, a timing category J, an architecture category K, and C2 commands L. These signals facilitate AI DNA (genealogy, histogram and structure) creation, growth and maturity in parallel and interleaved with an associated ontogenetic AI engine as time progresses from time 0 to time x. The purpose of AI DNA is to provide contextual valuation of behavioral consequences, and enhance context sensitive changes.

Signals A1, A2, A3, A4, A5 are command and control signals from the hardware power sources, the other connected brain component(s), and/or humans to start to the engines 2704, 2706 and to control the functioning of the DNA fabrication engine 2704. Signals A1-A5 comprise system functions, DNA fabrication engine processes, prioritization rules, timing signal(s), and On/Off signal(s). More specifically, signal A1 comprises C2 source commands that originate from controller 3002 and/or the ontogenesis engine 2400 and are passed to the DNA fabrication engine 2704. The source command signals A1 may be structured as Ack-NAck-NAckNack responses. Signal A2 comprises C2 input signals that command and control the processes and functions within the DNA fabrication engine 2704. Signal A3 comprises C2 response signals from the DNA fabrication engine 2704. Signal A4 comprises C2 initialization signals that interact with the DNA fabrication engine 2704 for transitioning the DNA fabrication engine 2704 from a start-up (or power-up) state to a run state. The C2 initialization signals may initiate a start sequences operational readiness of functions and processes in the DNA fabrication engine 2704. Signal A5 comprises the C2 main power signal to the DNA fabrication engine 2704. Signal A5 comprises C2 source commands that are initiated from controller 3002, ontogenesis engine 2400 and/or users and turn on or off the DNA fabrication engine 2704.

The C2 signals can be used to control various operations of the DNA fabrication engine 2704. The C2 signals can cause the DNA fabrication engine 2704 to turn on, start processing data, stop processing data, flush data, and/or turn off. The DNA fabrication engine 2704 can include, but is not limited to, computer module(s) and/or processor(s).

A C2 signal for turning on the DNA fabrication engine 2704 may cause a set of computer module(s) and f(x) processor(s) to start operations, queue(s) to be flushed, processing and memory to be zeroized, and data to not enter the queue(s) or processor(s). The C2 signal can include a command having the form TurnOn {x . . . y} (where x . . . y are things to turn on) and a response having the form TurnOn_R {x . . . y}.

A C2 signal to start processing can include a command to start functions for receiving data and/or message in queues, obtaining data and/or message from the queues, and processing the data and/or messages. The command can have the form of StartProcessing {x . . . y}, where x . . . y are things to start processing. The response can be in the form of StartProcessing_R {x . . . y}.

A C2 signal to stop processing can include a command to disable operation(s) of the f(x) processor(s), disable an ability to receive data and/or messages in queue(s), disable an ability to pass data and/or messages out of the queue(s), and stop data and/or message processing. The command can have the form of StopProcessing {x . . . y}, where x . . . y are things to stop processing. The response can have the form of StopProcessingR {x . . . y}.

A C2 signal to flush processing can include a command to flush all data from memory, processor(s) and queue(s). The command can have the form of FlushProcessing {x . . . y}, where x . . . y are things to flush processing. The response can have the form of FlushProcessing_R {x . . . y}.

A C2 signal to turn off the DNA fabrication engine 2704 may cause a set of computer module(s), process(es), processor(s) and/or queue(s) to shutdown or otherwise turn off. The command can have the form of TurnOff {x . . . y}, where x . . . y are things to turn off. The response can have the form of TurnOff_R {x . . . y}.

A C2 signal can also be associated with checking the health and status of set of running functions (including behavior f(x)), running processes, running system modules, system architecture (CPU(s), memory(ies), buss(es), message queue(s), bounds checker(s), and/or software process(es). A heartbeat function is a health and status function command run at a determined periodicity, which is charted for analytics. The command can have the form of CheckHealth {x . . . y}, where x . . . y are things to check health. The response can have the form of CheckHealth_R {x . . . y}.

A C2 signal for cleanup can include command(s) to cleanup and discard hanging process(es), stale memory(ies), and/or hanging software process(es). This means there are state models or timers/processing algorithms to track computer processing which are constantly refreshed. The command can have the form of Cleanup {x . . . y}, where x . . . y are things to Cleanup. The response can have the form of Cleanup_R {x . . . y}.

A C2 signal may also be associated with checking the status of maintenance function(s) and progress (e.g., forward, backward, or noprogress), and return an OK, NotOK, and RepairStatus message(s) with metadata {processes, memory, busses, message queues bounds checkers, SW processes, etc.}. The command can have the form of CheckMaintenance {x . . . y}. The response can have the form of CheckMaintenance_R {x . . . y}.

A C2 signal may additionally or alternatively include a command to turn on or turn off a specific maintenance function, and/or a command to start a repair of predefined software function(s) to affect software and/or computer process(es). The command can include a string of instructions for starting a repair, initializing a repair, stopping a repair, shutting down a repair, replacing a repair, building a repair, stopping a repair replacement, and/or archiving a repair.

A C2 signal for causing a reaction may include command(s) to schedule a function within the DNA fabrication engine 2704 once an event occurred (e.g., error condition, filling up message (hit a limit), etc). Schedule can be now, or time in the future based on analytics.

A C2 signal for causing a pro-action may include command(s) to schedule a function in advance. The function scheduling or triggering may not be dependent of an event occurrence. There are number of processes that can be controlled by C2 signals. Within the DNA fabrication engine 2704, in addition to the AI DNA intelligence functions, there are a series of actions or steps to be taken to produce or respond to or grow, mature, and/or evolve knowledge. Growth of intelligence has a sense of being more contextually accurate or more encompassing. Thus, this concept is applicable to information contained within the bounds of DNA fabrication engine 2704.

In the DNA fabrication engine 2704, there are points where new knowledge is created or knowledge is grown and/or matured and there are points that deal with change(s) due to knowledge that has been created and/or knowledge that is grown and/or matured elsewhere in the system (upstream), arrive at the DNA fabrication engine 2704 and attempt to flow thru the DNA fabrication engine 2704 and out of the DNA fabrication engine 2704. This yields both additive and subtractive growth processes.

This can come from, but not limited to: (a) a new, never before seen “best makeable solution” and its associated bounds and/or operating envelope(s) (which may necessitate new levels or kinds of intelligence DNA and/or it's associated DNA genealogy elements); (b) syntax checkers in pre-condition and post-condition queue(s) may need to adapt to the new item(s); and/or (c) the corresponding behavior models, metrics and analytics models may need to update the intelligence DNA genealogy elements and demarcations in view of the new item(s). Given the ontogenetic creation and/or maturity of data objects, relationships, metrics, memory, processing, and functions that operate across them, the DNA fabrication engine 2704 recognizes (by comparison math), captures, and documents growth of intelligence.

The are various sources of ontogenetic change. The presentation of change comes from the processes and functions recognizing that data is new or grown and does not fit into the data object bounds or data schema/architecture. This change is highlighted, added, and demarcated. Changes to the system could also come from positive human engagement and/or automated engagement using knowledge that may be gained from the environments and behaviors.

An original ontogenetic change and DNA growth may occur in response to a new piece of knowledge or stimuli entering the system. This ripples thru the system with each engine, memory, f(x) processing, memory, and behavior outcomes, metrics, etc. recognizing and being updated to deal with the new data objects and the associated processing, storage, etc. The schemas are expanded, updated, edited, grown, added to, subtracted, split, pruned, etc.

The system may perform a process to morph ontogenetic change through a recognition of change and an understanding of how the change should happen. In some cases, stimuli and events may cause data objects, data structures, ontology, schemas, memory, and/or processing to be outside of the normal or known operating envelope. Therefore, these items may be adjusted upward and/or outward increasing the operating envelope. The items may be additive in nature. The opposite is also possible, with the items being subtractive in nature. This is where, once the stimuli or object is measured and understood, those mentioned computer elements are morphed in an additive or subtractive manner—i.e. unlearning bad behavior.

In the additive scenario, the system obtains a data object and expands it by adding incremental values thereto. Next, “True-False” testing is utilized to validate that the data object has been created or grown enough to fit the new object. If the result goes in the wrong direction or doesn't return a true test result, different values are tested until the true test result is returned.

In a subtractive scenario, the system obtains a data object and subtracts therefrom another data object. The value of the data object may increase, decrease or stay the same. If the result goes in the wrong direction or doesn't return a true test result, different values are tested until the true test result is returned.

The C2 signal(s) may deliver prioritization rules to the DNA fabrication engine 2704. The prioritization rules may comprise rules to be followed when reading from queues and/or when performing processing operations. Higher priority objects/behaviors is/are picked up from queue(s) first and processed first. The goal of the priority algorithms is to prevent “priority inversion” (lower level priorities blocking high level priorities from processing because they were in the queues first) and allow efficient well-formed priority processing. Analytics are kept and updated to measure priority tasking processing wait times based on prioritization. This is used to apply for and harness additional resources when the established limits are approached (with a tolerance) or violated.

The C2 signal(s) may deliver timing signals. Each timing signal may be received via signals A2 and A4 and sets/synchronizes the DNA fabrication engine 2704 to time of day and the time of ontogenesis engine 2400.

A main source of the command and control signals C2 (and responses thereto) is from/to the main associated ontogenesis engine 2400 and/or controller 3002. There may be a one-to-one relationship, a one-to-many relationship, a many-to-one relationship or a many-to-many relationship between the engines of the DNA fabrication engine 2704 and ontogenesis engines 2400.

Data input signals B1.1, B1.n for the DNA fabrication engine 2704 are queued in queues B2.1, B2.n, B2.2, B2.m. Data input signal B1.1 provides an AI main model associated with a current operating ontogenesis AI engine 2400. The AI DNA structure is associated with that ontogenesis AI engine 2400 unless it is demarcated and replaced using proper authorization. Data input signal B1.n provides a link to each A1 engine element in the main A1 engine. The data input signals facilitate linkages or connections between the main AI engine and the AI DNA genealogy structure with constant updating.

The B1 input data signals can include information specifying or otherwise about the best makeable solution from the ontogenesis emergence engine 2420 and confidence engine 2422, a life span depth of ontogenesis newness, simulation solution(s), an associated situational environment, a proposed operational envelope, an associated stimuli/event which caused the simulation, prioritization rules, timing signal, and/or software algorithm(s) of engine(s) 2420, 2422. Each data input signal is added to an input queue and/or passed to an f(x) processing module of the DNA fabrication engine 2704.

The input data signals may be passed to queue B3 where pre-condition checking processes are performed for the B input data signals. The pre-condition checking processes include, but not limited to, syntax checking, completeness/fullness (ie all the parts included in the package). Signals A1-A5 have “turned on” queue B3 with rules for off nominal reaction to error conditions within the input queue (full queue/backup processing, off profile inputting/outputting, incompleteness of data set, incorrect syntax, rules for re-transmission from associated and linked Ontogenesis AI Engine, etc.). Upon completion, the B signals are provided as f(x) inputs C1.1, C2.x to a current AI DNA growth engine 3006.

The f(x) processing of the AI DNA growth engine 3006 will now be discussed. The AI DNA growth engine 3006 receives two data sets as inputs-a current ontogenetic AI DNA genealogy hierarchy and an update/interaction signaling from each associated ontogenetic AI engine and individual AI engine updates. The f(x) processing may involve, but is not limited to, storing a current DNA AI intelligence structure in a datastore, storing AI engine intelligence interaction in a datastore, checking language database, and/or checking math.

The AI DNA growth engine 3006 performs operations to grow DNA AI intelligence structure(s). In this regard, the AI DNA growth engine 3006 obtains a language and understanding of a DNA AI intelligence structure and ontologies from an ontology datastore 3008. This information is referred to as input C3.1. The AI DNA growth engine 3006 also accesses a growth datastore 3010 and obtains math for operating the DNA AI intelligence structure. This information is referred to as input C3.2. Upon receipt of B input signals, a main DNA AI intelligence structure and a linked DNA AI intelligence structure are stored in a transactional datastore 3012 according to rules. Potential changes to these DNA AI intelligence structures are examined by the AI DNA growth engine 3006 against the language, math and DNA genealogy of inputs C3.1, C3.2. Growth calculations may be performed and checked for accuracy and security.

Once validated and goodness checked, transactional commits are made using atomic processing. Upon completion of the DNA growth expansion and the inclusion of the growth demarcation calculations, the f(x) DNA growth happens with atomic processing and the DNA is updated and stored in a main memory. Acknowledgement signals C4 and C5 are sent back down to the associated A1 engine(s) via queues D1.1, D2.n, D1.2, D2.m. An updated DNA genealogy is stored in the main memory and a copy is sent to a hard disk memory and an AI engine via output queues D1.1, D1.2 to the sourcing A1 engine. Linkage complete acknowledgements are sent thru output queues D2.n, D2.m to the sourcing AI engine. In the output queues, formatting and post conditions may be validated before sending the information downstream. Any next steps are not started until both signal acknowledgements are received by the sourcing AI engine and returned to the AI DNA growth engine 3006.

The AI DNA growth engine 3006 may stay synchronized with the AI ontogenesis engine 2400. However, there are several reasons that could cause processing of the DNA fabrication engine 2704 to be stopped. For example, a human may perform a user-software interaction to cause such processing of the DNA fabrication engine 2704 to be stopped and/or so that simulation results of the simulator and analyzer 3004 may be tested by module 2412 of the AI ontogenesis engine 2400 for compliance with ethic and solution boundary rules.

The ethics and boundaries may change since the simulator 3004 received input data. In this case, the DNA fabrication engine 2704 receives the current conditions and/or new restart conditions).

Within the ethics, boundary, biases, policies, (and authorities) engine, there are different rates of changes and updates to each area, which could cause this condition. However, for the ethics and boundary engines 2412 to work efficiently and not be placed into a deadlock, early adolescent maturity decisions could be designed to include human interaction. More mature topic decisions could be paused to include new re-spins thru the engine including new adjacently related sensor data/impingements. This adjacently related sensor data could un-jam the deadlock.

Another reason is that the environment has changed around the DNA fabrication engine 2704 so solution boundaries are no longer valid. An example of this is snow on the road verse autonomous vehicle problem. The autonomous vehicle uses white lines for judging road surface. However, at a certain level of snow and traffic, the autonomous vehicle's tires go to road surface and push snow into lines. Now the autonomous vehicle sees many lines, causing the AI engines to lock as they don't know which ones to follow. A human can intervene and perform a user-software interaction to solve this issue by causing the autonomous vehicle to slow down, clue into other markers for guidance (e.g., a hump in road, detents in snow from other tires, guide posts on side of road, other moving cars), and/or pull over at an exit.

Control may be returned to stimuli and impingements (the start) and the processing may be adjusted to reflect changes in environmental stimuli (e.g., proceed with caution and reduce speed of vehicle or stop vehicle if danger is eminent). These cases reveal that there may be a need to adjust processor speed and multi-thread capabilities on the fly—as situations arise, the ontogenesis engine 2400 could be in a “heightened alert” operational state at times versus other times. This means that the ontogenesis engine 2400 may shed or pause other low level processing to handle the “alert” phases.

Yet another reason may be that the environment has changed around the DNA fabrication engine 2704 so solution boundaries are no longer valid due to potential danger. For example, a forest fire exists in a given geographical area. Impingements call for evacuation as a best simulation. Smoke and fire have closed in while the vehicle is on the road (best simulated path). However, now the environment has changed so much and/or so rapidly that there is no “non-damaging” solution. All solutions have damage associated with the predicated outcome. Thus, the system can only choose how one will be harmed or the degree to which one will be harmed. In other words, the best makcable solution and all the other makeable solutions involve damage or causality-so the ontogenesis solution is to pick the least harmful solution (the best of potential worst case solutions). No one solution is optimal. All involve some damage or casualty. So, the system selects the simulation result with the least damage to the vehicle.

Within humanity, this is often a very tough set of options to mentally wade thru. For instance, does a lifeguard enter dangerous water to try to save a drowning victim if the lifeguard might perish? Or does a General send soldiers onto a beach front to start an offensive to liberate millions, but knowing full well many will perish on the beach front? Within the ontogenesis engine 2400, the rules and logic for this sort of scenario are contained within the ethics and boundaries engine 2412. The ontogenesis engine 2400 needs to be able to recognize and calculate appropriateness (measurable analytics and costs) to put itself into harm's way if that means saving others or not. The measurable analytics and costs logic and algorithms may be contained in the DNA fabrication engine 2704.

The system may override AI engine ethics and boundaries “Stop with Solution” message and continue with a course of actions. The override option may be designed and configurable to have different allowable states and different levels of associated authorities. These can be associated with different levels of imminent danger assessments (closeness of danger and predicted magnitude of damage vs. allowable response magnitude and force). An override decision may be designed to be allowed due to imminent damage assessments levels. Imminent danger levels are an equation of override levels. For example, imminent damage levels can be defined as f(x) options {magnitude of danger; estimated time of impact; estimated impact/causality assessment} and {allowable response force type and allowable response force magnitude}. Authority levels may be directly related and proportional and configurable to override options. The ethics and boundaries engine 2412 may hold the definitions of imminent danger equation boundaries and the associated authorities for override.

There is also a case where a sensor or group of sensors: are failing and have sent or are sending data which is wrong; or sending faulty data to start or cause the whole system to walk off course; or to cause an interrupt. The deconfliction efforts of the system could include re-examining a single sensor to see if the data is within acceptable boundaries or if there are error conditions with the sensor control circuitry. If out of bounds, the sensor may remeasure the condition. If still out of bounds after remeasuring the condition, the system may examine related sensors of same or alternate types in order to find support information for a faulty sensor condition or for a normal sensor condition (sensor is good and is accurately reporting an error condition or a danger condition).

The error condition may cause a message with an error to be sent from the wisdom and action engines 2424, 2426 to the ethics and boundaries engine 3412. The ethics and boundaries engine 3412 may not recognize the message due to the error. Therefore, the ethics and boundaries engine 3412 responds with a “Stop with Solution” request with a reason therefore.

The human solution for this issue is to stop forward progress and re-examine the DNA branches. The system solution may be to start with re-measuring impingements and re-perform operations by all AI engines.

There is also a case in which a mission changes such that the goal of the simulation changes and the DNA changes. If there is an ethics change, then acceptable parameters of the simulation may change. Therefore, under normal processing, the simulation would not be valid and would need to be re-drawn.

However, there is also a case where the mission or mission constraints change after the control has passed the emergence and confidence engines 2420, 2422. When control gets to the wisdom and action engines 2424, 2426 and the check is perform by the ethics and boundaries engine 3412 against the ethics and solution boundaries, forward progress is stopped. The DNA AI intelligence structure is appropriately updated.

The human solution to this issue is to stop forward progress and re-examine the DNA branches. The system solution may be to start with re-measuring impingements and re-perform operations by all AI engines.

DNA capturing Past Wisdom and Action: Within the f(x) of the wisdom engine 2424, there is a metrics calculator that measures and tracks against past wisdom and actions to understand if this is outside bounds that can be done. The metrics calculator and analyzer may measure, capture, and analyze to understand each and the differences between: normal growth; edge of acceptable growth and rate of growth (growth can be positive or negative); growth outside normal bounds/acceptable limits; growth being walked into an overload situation or an adversary walking the bounds into a wrong direction or wrong limit(s). DNA objects may capture all these conditions. In order to understand the difference between being purposefully walked away verse environment changing at same rate, the metrics and analysis would need to have access (or query) sources of change. This might be additional parameters or parameters from second-tier sensor data capture and linkages to them. This is needed to highlight and uncover intent (just like in conversation between to people trying not to be mis-understood). Consequently, as early as possible detection of risk of danger and real danger can be obtained before damage is possible or accomplish.

The DNA editing engine 2706 may perform an after action functions. The after action functions can include, but are not limited to, simulation learning, an after action analysis, a lessons learned analysis, a bad learning analysis, and data update and storage. The simulation learning can involve testing “what if” scenarios to understand possibilities of how the intelligence genealogy grows with simulated inputs from the simulator and analyzer 3004. The after action analysis can involve a step-by-step examination thru the growth cycles upon a set of ontogenetic A1 knowledge growth or exercise. The lessons learned analysis can allows for the categorization of positive or negative growth and for the logic examination of root causes. The bad learning function may allow for changing of root cause parameters (simulating) to enable uncover and examining if a better course of action would be possible. The data update and storage function may be related to updating and storing the simulated DNA intelligence genealogies.

The system may also perform after action and lessons learned analysis and storage. The system may analyze the knowledge gained (both positive and negative) by the usage of the behavior model(s) and the analytics(s) in response to the impingements, stimuli, and normal growth. As the result of an impingement, stimuli, or growth response, each sensor and function engine may be examined to see if the system could have gained a different knowledge genealogy with a more positive outcome. Both the original responses and the after action analysis data may be stored for future reference and refinement.

In FIG. 30, there are number of E signals. Signal E1 comprises after action transaction data passed to/from to the associated AI engine and vice-versa. The ontogenetic AI engine solution passed to the ontogenetic AI DNA engine's after action analysis engine can include the following information: a simulated solution with a highest confidence value and confidence; a rating; a ranking; an associated operating envelope; an x-tuple, associated situational environment data; a proposed operational envelope; an associated stimuli/event which caused the simulation; a set of prioritization rules; a timing signal; a set of metadata describing software algorithms of the confidence and emergence engine 2420, 2422; metadata associated with the DNA fabrication engine 2704; a timestamps of outputs; behavior model(s); analytic model(s); ethics metadata; and/or interrupt metadata.

Signal E2 comprises after action and lessons learned real time data. This data can include, but is not limited to, step by step transaction data from the AI DNA growth engine 3006 passed to the after action analysis function. This data can also comprise: a solution with intelligence DNA growth genealogy; a rating; a ranking; an associated operating envelope; an x-tuple, associated situational environment; a proposed operational envelope; an associated stimuli/event which caused the simulation; prioritization rule(s); a timing signal; metadata describing the software algorithms of the confidence and emergence engine 2420, 2422; metadata associated with the DNA fabrication engine 2704; timestamps of outputs; behavior model(s); analytic model(s); ethics metadata; and/or interrupt metadata.

Signal E3 comprise information associate with a simulation Engine connectivity with AI DNA to run simulations. The purpose of signal E3 is to connect the after action analysis Engine with the AI DNA intelligence engine to run “what if” simulations and to store all the associated data. This information can include, but is not limited to, simulation step by step transaction data from the AI DNA growth engine 3006 passed to the after action analysis function. This simulation step by step transaction data can include, but is not limited to: a solution with intelligence DNA growth genealogy and simulation run # with all adjusted rules and data; a rating; a ranking; an associated operating envelope; an x-tuple, associated situational environment; a proposed operational envelope; an associated stimuli/event which caused the simulation; prioritization rules; a timing signal; metadata describing the software algorithms of the confidence and emergence engine 2420, 2422; metadata associated with the DNA fabrication engine 2704; timestamps of outputs; behavior model(s); analytic model(s); ethics metadata; and/or interrupt metadata.

Signal E4 comprises information associated with the AI DNA growth engine's 3006 after action analysis engine connectivity with the ontogenetic simulator and analyzer 30004 to run an interconnected analysis. As intelligence grows and changes or the ontogenetic AI builds new knowledge, both interconnected simulation engines can hypothesize and run “what if” scenarios in order to run full spectrum analysis and beyond boundaries in order to predict and/or plan how the DNA growth would lead you to greater maturity. The system can reach certain goals and can optimize certain unknown or known attributes. The information in signal E4 can include, but is not limited to, a solution with intelligence DNA Growth genealogy and a simulation run number with adjusted rules and data; a rating; a ranking; an associated operating envelope; an x-tuple, associated situational environment; a proposed operational envelope; an associated stimuli/event which caused the simulation; prioritization rule(s); a timing signal; the software algorithms of the confidence and emergence engine 2420, 2422; metadata associated with the DNA fabrication engine 2704; timestamps of outputs; behavior model(s); analytic model(s); ethics metadata; and/or interrupt metadata.

Control signal F1 provides a means to handoff and synchronize state machine control. Control signal F1 is issued to once again begin the “over-all” ontogenesis processing and AI DNA intelligence processing, after data is passed to queues D1.2 and D2.m and after data is passed via signal E2.

The system can be configured to perform an initial and constant check on AI DNA goodness before action/growth/security control. After data is passed into the input queues, checks are done. Goodness analytics are performed in the queues to “watch” the data. If the input data falls outside of prescribed boundaries, then a “Goodness” DNA alert is issued back down to the AI engine to pause and debug/rebuild the inputs. If the “goodness” falls within proper bounds, a G1 “Goodness” signal is issued to begin the ontogenesis processing and AI DNA Intelligence Processing again (loop back to the beginning).

Signal H1 is associated with “halt” or “interrupt” signals issues by the AI engine. When such signals are issued, incomplete data may not be committed to the databases and control may be passed back down to the AI engine. AI DNA is appropriately captured and demarked.

Signal I1 is associated with feedback and control metrics. Within AI DNA, feedback and control metrics are captured, stored and measured within the AI DNA. Signal I1 provided a means for collect metric information. This metric information can include, but is not limited to, a metric name, a periodicity, a metric source, value(s), time stamp(s), and/or metric destination(s). The requesting source is one of the brain(s), local or main in the ontogenesis engine 2400. The metric control signal may be delivered and received via bus 3008. A metrics setting may be delivered to AI DNA, while metrics may be delivered from the AI Engine.

Signal J1 is associated with timing control. Within AI DNA, timing signals are also captured, stored, and measured within the AI DNA. The main timing source transmits a timing signal through all the modules within the AI DNA growth engine 3006. This signal may be communication via bus 3008 to all the modules, or alternatively it is communicated direction to each module. Once the DNA Engine (Brain(s) or CPU) receives the timing signal, it can distribute to all modules as part of the C2 commands.

Signals K1, K2 and K3 are associated with the architecture of the AI DNA growth engine 3006. The architecture can have many forms. For example, there may be a single structure with a CPU, memory, software bus, etc. with software applications running the above processing and the AI DNA collocated with the AI engine. Alternatively, the architecture is a distributed architecture with several queue structures to pass messaging along a bus structure between the difference processes and the AI DNA distributed separately from the AI engine. The queue and bus structure can pass full data packets which are the items to be processed; pass references to memory locations where the items to be processed are located. The present solution is not limited to the particulars of these examples.

Signal K1 is associated with architecture control. The architecture may include, but is not limited to, bus(es), interface(s), schema(s) and translator(s) to interconnect modules and pass info between the ontogenetic AI DNA growth engine 2702 and the ontogenesis engine 2400.

Signal L1 can include commands for math editing instructions, history and control information. The L1 signals may contains: (1) C2 commands for math editing instructions; (2) C2 history signals; and/or (3) C2 signals to user interface(s). Signals (1) may include, but are not limited to, allowable math and math functions for AI DNA. The math and math functions can specify how to add a branch to the AI DNA, what ontology to use for the AI DNA, and/or what language to use for the AI DNA. Signals (2) contain C2 history for memory recall and examination. If the system contains a machine-to-human interface, signals (3) may contains the allowable messaging and potential error conditions.

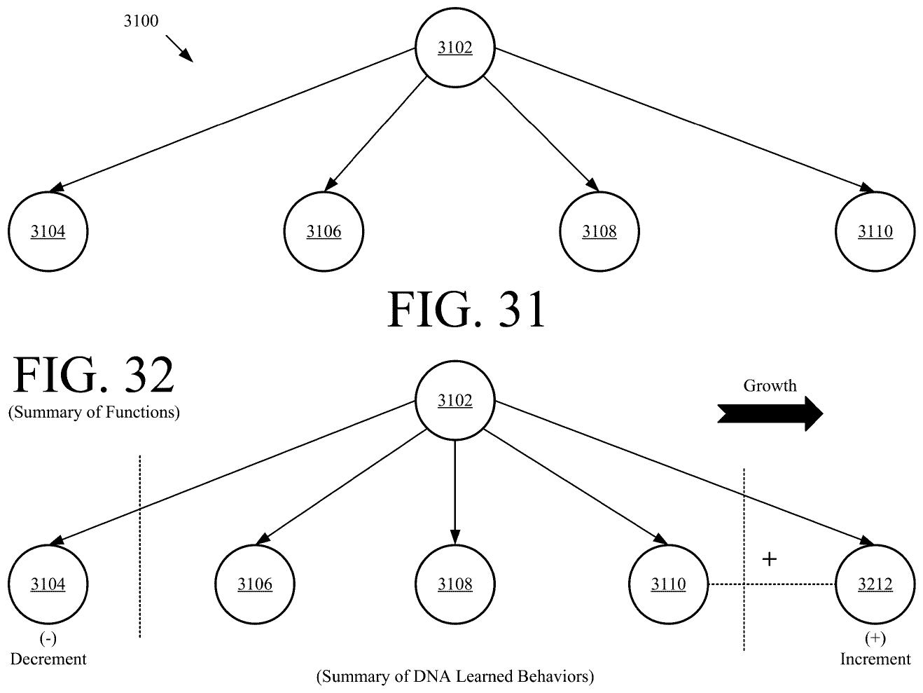

FIG. 31 provides an illustration that is useful for understanding a DNA AI intelligence structure 3100 implemented by the present solution. The DNA AI intelligence structure 3100 comprises a root data object 3102 and behavior data objects 3104, 3106, 3108, 3110. The root data object 3102 includes information concerning the electronic device implementing the ontogenesis engine 2400 and the ontogenetic AI DNA growth engine 2702. This information can include, but is not limited to, a device identifier, a device type identifier, device version information, software identifiers, software version information, software update information, hardware identifiers, hardware version information, and/or hardware update information. Each behavior data object 3104, 3106, 3108, 3110 includes information specifying a type of behavior that the electronic device is allowed and/or capable of performing. For example, the electronic device comprises an autonomous vehicle that is configured to travel forwards, travel backwards, turn right and turn left. Accordingly, the root data object 3102 includes information at least identifying the autonomous vehicle. Behavior data object 3104 includes information associated with traveling forwards. Behavior data object 3106 includes information associated with traveling backwards. Behavior data object 3108 includes information associated with turning right. Behavior data object 3110 includes information associated with turning left.

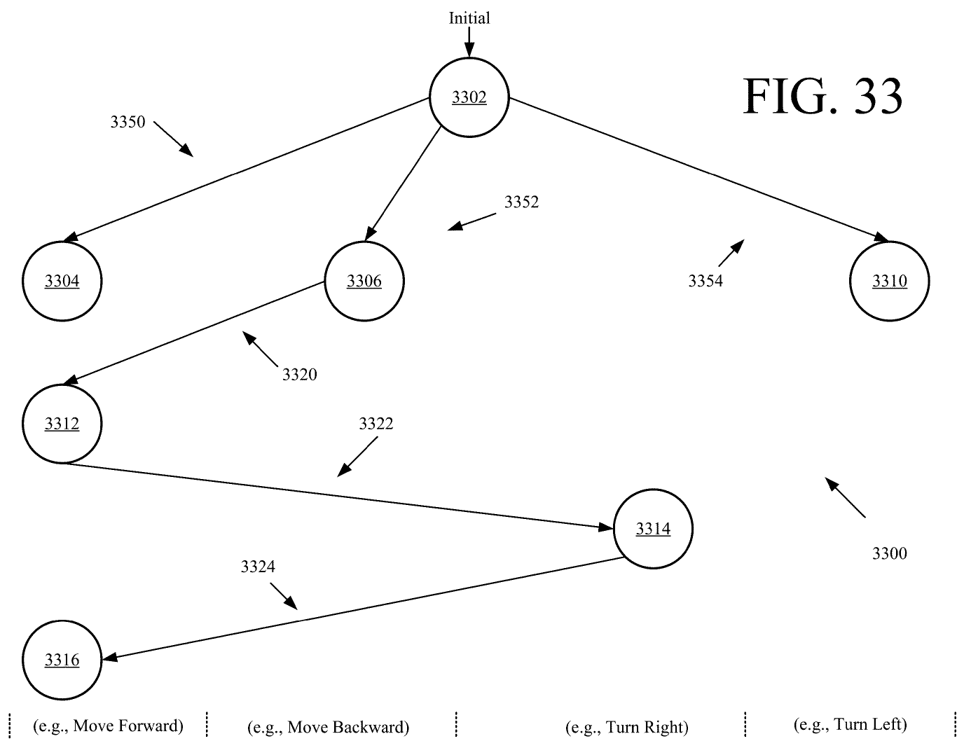

The DNA fabrication engine(s) 2704 can update the DNA AI intelligence structure 3100 throughout operation of the electronic device. The DNA AI intelligence structure 3100 can be updated by adding behavior data object(s) thereto, removing behavior data object(s) therefrom, and/or marking behavior data object(s) as being associated with behavior that the electronic device is unable to perform in an acceptable manner as defined by pre-specified criteria. The DNA AI intelligence structure updating can be based on or responsive to (i) updates to the hardware and/or software of the electronic device, (ii) actual behavior of the electronic device during use, and/or (iii) outcome(s) of the actual behavior. For example, the electronic device comprises an autonomous vehicle that actually traveled up a steep slope. A new behavior data object 3202 is added to the DNA AI intelligence structure (as shown in FIG. 32) that is associated with traveling up a steep slope. The present solution is not limited in this regard.

DNA AI intelligence structure 3100 can define the permissible or allowable parameters for the DNA ontology which can be used to fabricate other DNA AI intelligence structures. In this regard, a new DNA AI intelligence structure can be fabricated or otherwise created by the DNA fabrication engine 2704 based on DNA AI intelligence structure 3100, operations of modules 2402-2426, behaviors output from the ontogenesis engine 2400 as a result of performing one or more iterations of the operations of modules 2402-2426, and/or outcomes from performing the behaviors. The root data object of the new DNA AI intelligence structure may be the same as or similar to root data object 3102 of DNA AI intelligence structure 3100. Each behavior data object that is directly connected to the root data object of the new DNA AI intelligence structure may be the same as, similar to or otherwise associated with the behaviors specified by the behavior data objects 3104, 3106, 3108, 3110 of DNA AI intelligence structure 3100.

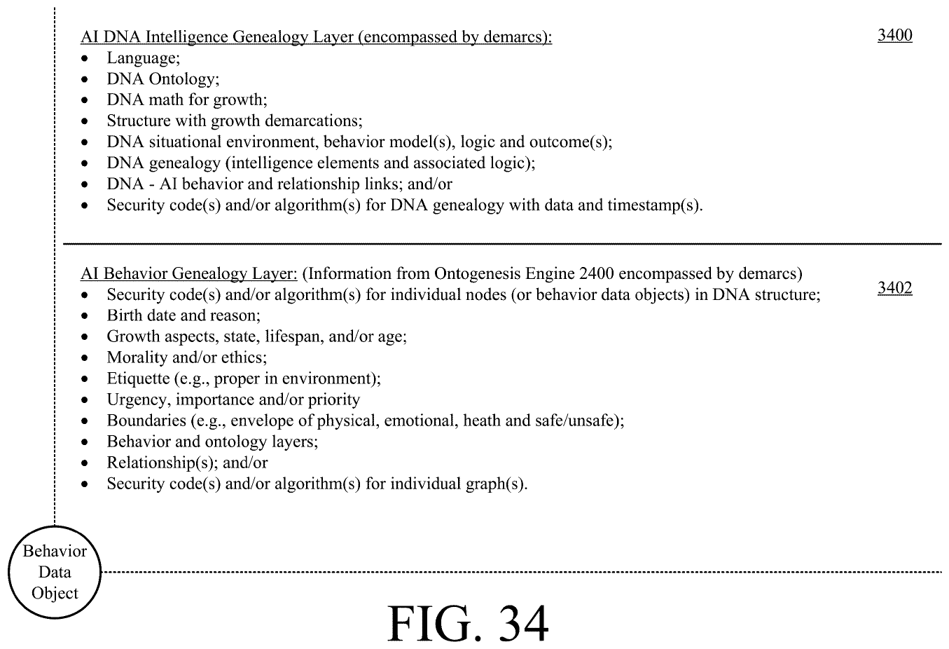

FIG. 33 provides an illustration of another DNA AI intelligence structure 3300 that was fabricated or otherwise created by the DNA fabrication engine(s) 2704. DNA AI intelligence structure 3300 is shown as being a 2D structure. However, the present solution is not limited in this regard. The DNA AI intelligence structure could alternatively be a 3D structure. The DNA fabrication engine(s) 2704 may also fabricate or otherwise create a plurality of different DNA AI intelligence structures. For example, the DNA fabrication engine(s) 2704 can create a first DNA AI intelligence structure with data objects for a first task (e.g., travel around an obstacle), and a different second DNA AI intelligence structure with data objects for a second task (e.g., climb up stairs). Alternatively, a single DNA AI intelligence structure can be created with data objects for both the first and second tasks. The present solution is not limited to the particulars of this example.

DNA structure 3300 comprises a root data object 3302 and branches 3350, 3352, 3354 of behavior data objects 3304-3316. Root data object 3302 may be the same as or similar to root data object of 3102 of FIG. 31. Each behavior data object 3304-3316 includes information associated with a respective iteration of operations performed by modules 2402-2426 of the ontogenesis engine 2400. For example, behavior data objects 3304 is associated with an iteration of operations performed by modules 2402-2426, while each of the other behavior data objects 3306-3316 is associated with a respective other iteration of operations performed by modules 2402-2426. The present solution is not limited to the particulars of this example.

Behavior data objects 3304, 3312, 3314 may each be associated with the same type of behavior (e.g., travel forwards) which behavior data object 3104 of FIG. 31 is associated. Behavior data object 3306 may be associated with the same type of behavior (e.g., travel backwards) which behavior data object 3106 of FIG. 31 is associated. Behavior data object 3314 may each be associated with the same type of behavior (e.g., turn right) which behavior data object 3108 of FIG. 31 is associated. Behavior data object 3310 may each be associated with the same type of behavior (e.g., turn left) which behavior data object 3110 of FIG. 31 is associated.

As shown in FIG. 33, there are no other behavior data objects linked or otherwise connected to each behavior data object 3304, 3310 other than the root data object 3302. This indicates that the electronic device's performance of the behavior associated with each data object 3304, 3310 did not result in achieving a goal. For example, the electronic device comprises an autonomous vehicle and the behavior associated with data object 3310 is a left turn. The autonomous vehicle attempted a left turn to travel pass an obstruction in its path. However, the left turn resulted in the autonomous vehicle hitting the obstruction rather than traveling around the obstruction. Thus, the left turn behavior did not result in the goal of traveling around or avoiding the obstruction. So, in another iteration represented by node 3306, the ontogenesis engine 2400 caused the autonomous vehicle to travel backwards a certain amount. In subsequent iterations represented by nodes 3312, 3314 and 3316, the autonomous vehicle was caused to then (i) travel forwards, (ii) turn right, and (iii) continue to travel forwards. This sequence of behaviors resulted in the autonomous vehicle traveling around and avoiding the obstruction. As such, this branch of behavior data objects 3306, 3312-3316 may be marked as “good behavior” for meeting a goal. Behavior data object 3306 may be marked as “bad behavior” for meeting the goal.

It should be noted that the links 3320, 3322, 3324 represent the relative times at which the behaviors were performed. For example, link 3320 indicates that the behavior of data object 3306 was performed prior to the behavior of data object 3312. Link 3322 indicates that the behavior of data object 3312 was performed prior to the behavior of data object 3314. Link 3324 indicates that the behavior of data object 3316 was performed after the performance of the behavior of data object 3314. The present solution is not limited to the particulars of this example.

It should also be noted that the system may demarc the start and end of each branch. With regard to branch 3350, root data object 3302 is demarc'ed as the start thereof and behavior data object 3304 is demarc'ed as the end thereof. With regard to branch 3352, root data object 3302 is demarc'ed as the start thereof and behavior data object 3316 is demarc'ed as the end thereof. With regard to branch 3354, root data object 3302 is demarc'ed as the start thereof and behavior data object 3310 is demarc'ed as the end thereof.

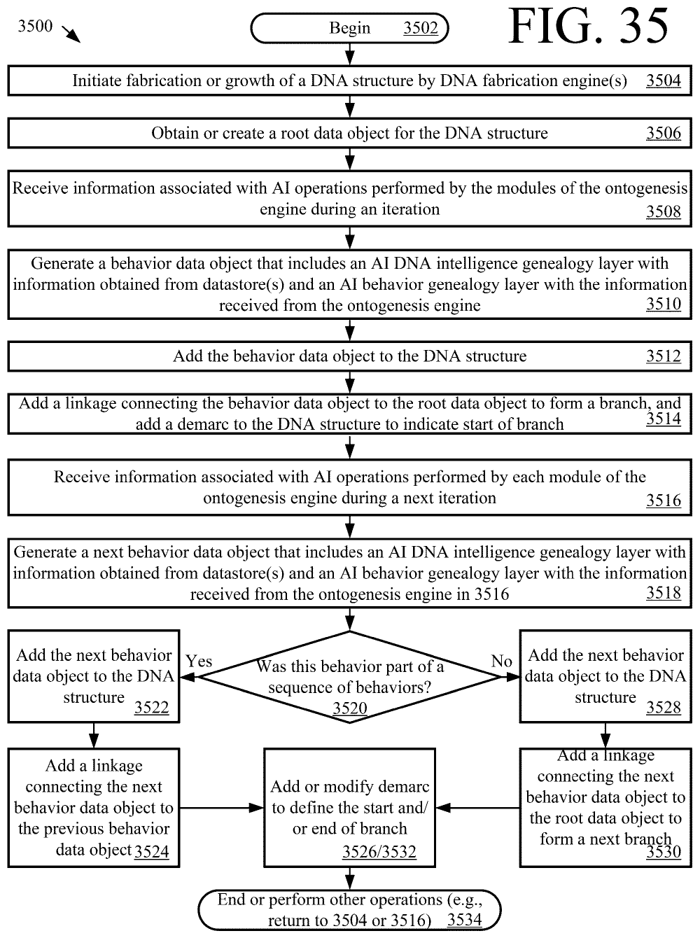

With reference to FIG. 34, each behavior data object comprises certain information and/or start/end demarcs. This information may be separated into two layers, namely an AI DNA intelligence genealogy layer 3400 and an A1 behavior genealogy layer 3402. The information contained in the AI DNA intelligence genealogy layer 3400 is stored in datastores 3008 and 3010 of FIG. 30, while the information contained in the AI behavior genealogy layer 3402 was received from the ontogenesis engine 2400 and stored in the datastores along with other information for DNA structure branches. The information of the AI DNA intelligence genealogy layer 3400 can include, but is not limited to, a human language for defining the DNA AI intelligence structure and a computer language in which the DNA AI intelligence structure is created. The human and computer languages can define an ontology, DNA math for growth, structure for growth demarcation (or demarcations for growth), DNA situational environment, behavior model(s), logic, outcome(s), DNA genealogy, DNA AI behavior and relationship links, and/or security code(s) and/or algorithm(s) for DNA genealogy with data and timestamp(s). The language can include, but is not limited to, a human language (e.g., English), a defined machine language, and/or languages encased within defined cryptography. The ontology can include, but is not limited to, a set of categories and (data) objects in subject area(s), domain(s) or layer(s) that shows the object definition, properties, and the relationships within the layers and between them. The DNA math for growth can include, but is not limited to, set theory math rules allowable for growing (expansion and/or enlargement) of the DNA branches. The default intent is to allow direct set theory math governance and management of the growth. The default intent can be restricted or expanded by the ethics engine 2412. The DNA genealogy can include structure elements with associated logic. The structure elements can include, but are not limited to, a knowledge graph with learned intelligence ontology objects and with link to or copy of associated behavior, human readable map representation, linked objects in datastore(s) (e.g., direct linking and/or indirect linking with delineated record elements), tests or certifications (e.g., summary demarc review and/or full listing review), previously delineated branches (e.g., increased behavior (added due to previous editing) or decreased behavior (decremented due to previous editing)), structured formed list (e.g., a human resume following a pre-defined template), and/or planned behavior sequenced based on the simulation(s) performed by simulator 3004 and intelligence gained. The demarcations for growth can include a label attached to a point in the DNA AI intelligence structure marking a specific point of growth or knowledge event. The DNA situational environment can include, but is not limited to, impingement summation of sensory input to the system, orientation recognition for impingement types, simulation of options, decisions that emerge from knowledge choices, wisdom and ethical and governing authority temper decisions, and tempered decisions that were used to execute actions. The DNA AI behavior relationship links can include, but are not limited to, linkage down to the associated AI engine encapsulating the associated behavior knowledge. The security information can include, but is not limited to, encryption algorithm(s), secure hash algorithm(s), maneuvering algorithm(s), and/or private algorithm(s). Any known or to be known encryption algorithm and/or secure hash algorithm can be used herein. The maneuvering algorithms may be configured to cause a frequent change with parameters (e.g., time, usage frequency, and/or behavior algorithms). The date and time stamp information may be associated with an atomic process (e.g., a database transactional commit process).

The information of the AI behavior genealogy layer 3402 can include, but is not limited to, security code(s) and/or algorithm(s) associated with an individual or object, a birth date of an individual or object, growth aspects of an individual or object, a state of an individual or object, a lifespan of an individual or object, an age of an individual or object, an individual's or object's morality, an individual's or object's ethics, an individual's or object's etiquette, behavior definition(s), an urgency for performance of behavior(s), an importance of the behavior(s), a priority of the behavior(s), individual's boundaries (e.g., physical, emotional, health, and safety), a mission ontology, a maneuver mission ontology, and/or a relationship between the individual/object and other individual(s)/object(s).

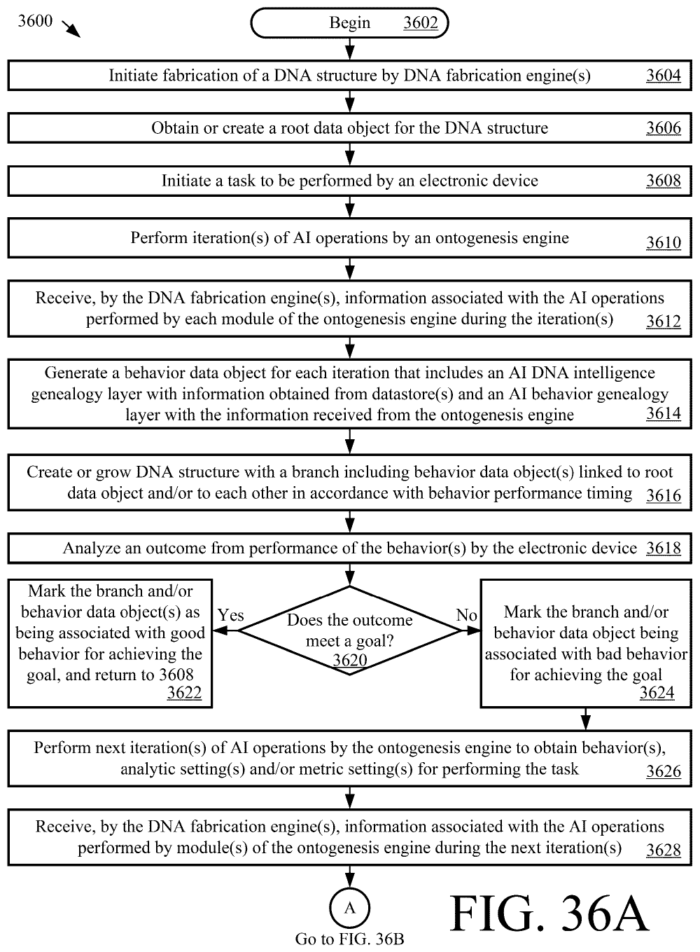

FIG. 35 provides a flow diagram of an illustrative method 3500 for fabricating or otherwise creating a DNA structure (e.g., DNA AI intelligence structure 3300 of FIG. 33) in accordance with the present solution. Method 3500 can include more or less operations or steps than that shown. The operations or steps can have the same or different order than that shown. One or more of the operations and steps can be performed by a processor. The processor can include, but is not limited to, ontogenetic AI DNA growth engine 2702, DNA fabrication engine 2704, and/or processor 2920 of FIG. 29.

Method 3500 begins with 3502 and continues with 3504 where operations are performed to initialize fabrication or growth of a DNA structure (e.g., DNA AI intelligence structure 3300 of FIG. 33) by a DNA fabrication engine (e.g., DNA fabrication engine 2704 of FIG. 27). A root data object (e.g., root data object 3302 of FIG. 33) is obtained or created in block 3506. Block 3506 can involve receiving DNA structure signal B1.1 at the DNA fabrication engine.

Information is received in block 3508 from an ontogenesis engine (e.g., ontogenesis engine 2400 of FIG. 24). The information is associated with A1 operations performed by module(s) (e.g., module(s) 2402-2426 of FIG. 24) of the ontogenesis engine. A behavior data object (e.g., behavior data object 3304, 3306 or 3310 of FIG. 33) is generated in 3510. The behavior data object includes an AI DNA intelligence genealogy layer (e.g., layer 3400 of FIG. 34) and an A1 behavior genealogy layer (e.g., layer 3402 of FIG. 34). The AI behavior genealogy layer includes some or all of the information received from the ontogenesis engine in 3508. The behavior data object is added to the DNA structure in block 3512. A linkage is added to the DNA structure that connects the behavior data object to the root data object to form a branch (e.g., branch 3350, 3352 or 3354 of FIG. 33), as shown by block 3514. The system also adds a demarc to the DNA structure to indicate a start of the branch. For example, root data object is demarc'ed as the start of the branch. The present solution is not limited in this regard. The operations of block 3512 and 3514 may comprise atomic processing.

In 3516, the DNA fabrication engine receives more information from the ontogenesis engine. This information is associated with the AI operations performed by the modules of the ontogenesis engine during a next iteration. Block 3516 can involve receiving signal B1.n at the DNA fabrication engine. A next behavior data object (e.g., behavior data object 3306, 3312, 3314 or 3316 of FIG. 33) is generated in block 3518 using this information. The next behavior data object includes an AI DNA intelligence genealogy layer (e.g., layer 3400 of FIG. 34) and an AI behavior genealogy layer (e.g., layer 3402 of FIG. 34). The AI behavior genealogy layer includes some or all of the information received from the ontogenesis engine in 3516.

The DNA fabrication engine performs operations in block 3520 to determine whether the behavior associated with the next behavior data object is part of a sequence of behaviors. If so [3530:YES], then method 3500 continues with operations of blocks 3522-3526. These operation involve: adding the next behavior data object to the DNA structure; adding a linkage connecting the next behavior data object to the previous behavior data object; and adding or modifying a demarc defining the start and/or end of the branch. If not [3530:NO], then method 3500 continues with operations of blocks 3528-3532. These operation involve: adding the next behavior data object to the DNA structure; adding a linkage connecting the next behavior data object to the root data object to form a next branch; and adding a demarc defining the start and/or end of the next branch. Subsequently, method 3500 continues to 3524 where it ends or other operations are performed (e.g., return to bock 3504 or 3516).

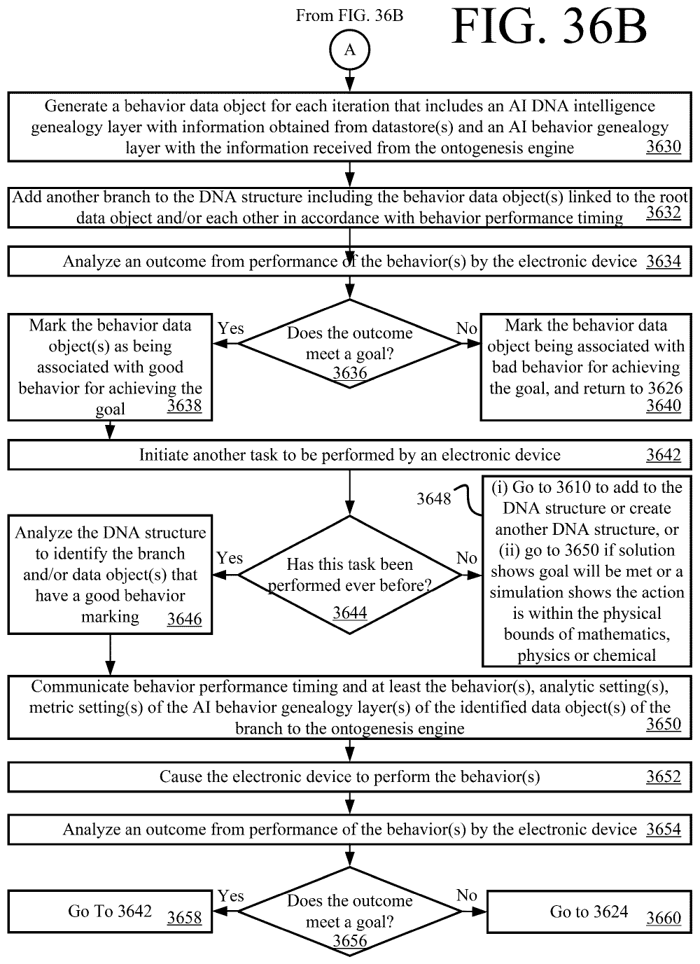

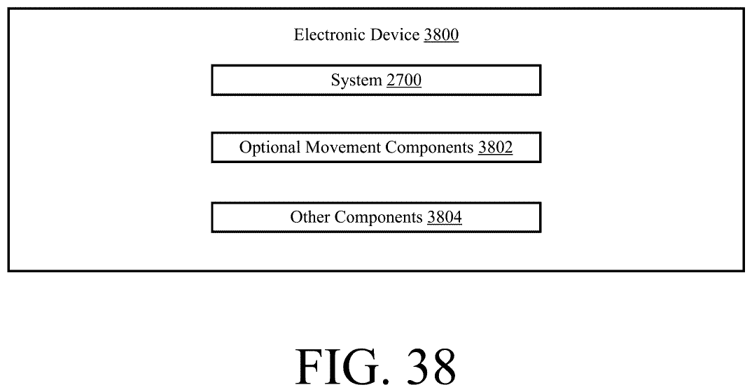

FIG. 36 provides a flow diagram of an illustrative method 3600 for operating an AI system (e.g., system 2700 of FIG. 27) in accordance with the present solution. Method 3600 can include more or less operations or steps than that shown. The operations or steps can have the same or different order than that shown. One or more of the operations and steps can be performed by a processor and/or electronic device (e.g., electronic device 3800 of FIG. 38). The processor can include, but is not limited to, ontogenetic AI DNA growth engine 2702, DNA fabrication engine 2704, and/or processor 2920 of FIG. 29.

Method 3600 begins with 3602 and continues with 3604 where the AI system performs operations to initiate fabrication of a DNA structure (e.g., DNA AI intelligence structure 3300 of FIG. 33). Next in 3606, a root data object (e.g., root data object 3302 of FIG. 33) is obtained or created for the DNA structure.

A task is initiated in block 3608, which is to be performed by the electronic device. The tasks can be expressed as a behavior statement for action in view of a stimuli and/or impingement action. For example, the task comprises having an autonomous vehicle travel around an obstacle. The present solution is not limited to the particulars of this example. Accordingly, an iteration of AI operations is performed in 3610 by an ontogenesis engine (e.g., ontogenesis engine 2400 of FIG. 24) to obtain behavior(s), analytic setting(s) and/or metric setting(s) for performing the task by the electronic device. The DNA fabrication engine receives information from the ontogenesis engine in block 3612. This information is associated with the AI operations performed in block 3610.

A behavior data object (e.g., behavior data object 3304, 3306 or 3308 of FIG. 33) is generated in block 3614 for each iteration of the AI operations performed by the ontogenesis engine. Each behavior data object includes an AI DNA intelligence genealogy layer (e.g., layer 3400 of FIG. 34) with information obtained from datastore(s) (e.g., datastore(s) 3008 and/or 3010 of FIG. 20) and an AI behavior genealogy layer (e.g., layer 3402 of FIG. 34) with the information received from the ontogenesis engine. The DNA structure is created or grown in block 3616 to include a branch (e.g., branch 3350, 3352 or 3354 of FIG. 33) with the behavior data object(s) linked to the root data object and/or to each other in accordance with behavior performance timing.

In block 3618, an analyzer (e.g., analyzer 3004 of FIG. 30) performs an analysis of an outcome from the performance of the behavior(s) by the electronic device. This analysis can involve determining whether the outcome meets a goal. For example, the analyzer can determine whether the vehicle traveled around the obstacle. The present solution is not limited to the particulars of this example. If so [3620:YES], then method 3600 continues to block 3622 wherein the DNA fabrication engine performs operations to mark the branch and/or behavior data object(s) as being associated with good behavior for achieving the goal. Method 3600 then returns to block 3608.

If not [3620:NO], then method 3600 continues to block 3624 wherein the DNA fabrication engine performs operations to mark the branch and/or behavior data object(s) as being associated with bad behavior for achieving the goal.

Next in block 3626, the ontogenesis engine performs next iteration(s) of the AI operations to obtain behavior(s), analytic setting(s) and/or metric setting(s) for performing the task. The DNA fabrication engine receives information from the ontogenesis engine in block 3628. This information is associated with the A1 operations performed by the module(s) of the ontogenesis engine during the next iteration(s). Thereafter, method 3600 continues to block 3630 of FIG. 36B.

As shown in FIG. 36B, block 3630 involves the DNA fabrication engine performs operations to generate a behavior data object for each iteration. Each behavior data object includes an AI DNA intelligence genealogy layer with information obtained from datastore(s) and an AI behavior genealogy layer with the information received from the ontogenesis engine. Another branch is added to the DNA structure in 3632. This branch includes the behavior data object(s) linked to the root data object and/or each other in accordance with behavior performance timing.

In block 3634, the analyzer performs operations to analyze an outcome from performance of the behavior(s) by the electronic device. This analysis can involve determining whether the outcome meets a goal. For example, the analyzer can determine whether the autonomous vehicle traveled around an obstacle. The present solution is not limited to the particulars of this example. If so [3636: YES], method 3600 continues to block 3638 where the DNA fabrication engine performs operations to mark the behavior data object(s) as being associated with good behavior for achieving the goal. Otherwise, the behavior data object(s) is (are) marked as being associated with bad behavior for achieving the goal, as shown by block 3640.

In next block 3642, the system initiates another task to be performed by the electronic device. For example, the task comprises traveling around an obstacle or climbing stairs. The present solution is not limited to the particulars of this example. The DNA fabrication engine then performs operations to determine whether this task has been performed ever before. This determination can be made using the DNA structure. For example, the DNA structure was created when the vehicle was attempting to perform the task at a previous time. Thus, the DNA structure may be stored so as to be associated with an identifier for the particular type of task. The DNA fabrication engine can compare the identifier of the another task to the identifier associated with the DNA structure to determine if they match each other. The DNA fabrication engine can determine that the another task was performed before when such a match exists. The DNA fabrication engine can determine that the another task was never performed before when such a match does not exist. The present solution is not limited to the particulars of this example. The decision of blocks 3642, 3644 is where (i) the AI system learns a new behavior within boundaries, (ii) learns a new behavior outside the boundaries because it was thought that performance thereof by the electronic device was not possible, or (iii) takes advantage of previously learned behavior.

If the another task has never been performed before [3644:NO], method 3600 may continue with either of two actions as by block 3648. These actions include: method 3600 going to block 3610 to add to the DNA structure or create another DNA structure; or method 3600 going to block 3650 if a solution shows that a goal will be met or a simulation shows the action is within the physical bounds of mathematics, physical or chemical field. In contrast, if the another task has been performed before [3644:YES], method 3600 continues to block 3646 wherein the DNA fabrication engine or analyzer perform operations to analyze the DNA structure to identify the branch and/or data object(s) that have a good behavior marking.

Upon completing the operations of block 3646, method 3600 continues to block 3650. Block 3650 involves communicating behavior performance timing and at least the behavior(s), analytic setting(s), metric setting(s) of the AI behavior genealogy layer(s) of the identified data object(s) of the branch to the ontogenesis engine. The ontogenesis engine then can perform operations to cause the electronic device to perform the behavior(s), as shown by block 3652.

The analyzer performs operations in block 3654 to analyze an outcome from performance of the behavior(s) by the electronic device. This analysis can involve determining whether a goal was met. If so [3656:YES], method 3600 goes to 3642 as shown by block 3658. Otherwise [3656:NO], method 3600 geos to 3624 as shown by block 3660.

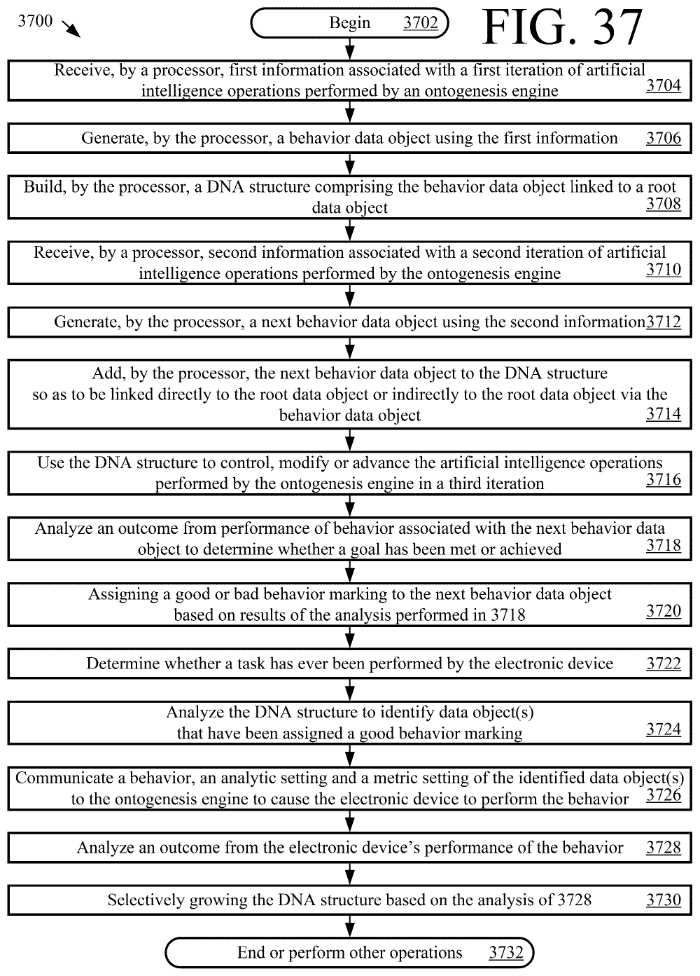

FIG. 37 provides a flow diagram of an illustrative method 3700 for controlling operations of an electronic device (e.g., electronic device 3800 of FIG. 38). The electronic device can include, but is not limited to, a vehicle, a computer system, or a communication device. Method 3700 can include more or less operations or steps than that shown. The operations or steps can have the same or different order than that shown. One or more of the operations and steps can be performed by a processor. The processor can include, but is not limited to, ontogenetic AI DNA growth engine 2702, DNA fabrication engine 2704, and/or processor 2920 of FIG. 29.

Method 3700 begins with 3702 and continues with 3704 where first information is received. The first information is associated with a first iteration of AI operations performed by an ontogenesis engine (e.g., ontogenesis engine 2400 of FIG. 24). The AI operations can include, but is not limited to, operations performed by one or more modules 2402-2426.

Next in 3706, a behavior data object (e.g., behavior data object 3304, 3306 or 3310 of FIG. 33) is generated using the first information. The behavior data object can include, but is not limited to, an AI DNA intelligence genealogy layer and an AI behavior genealogy layer. The AI behavior genealogy layer contains the first information received from the ontogenesis engine and the AI DNA intelligence genealogy layer comprising other information that was not received from the ontogenesis engine. The first information can include, but is not limited to, a security code associated with an individual or object, a birth date of an individual or object, growth aspects of an individual or object, a state of an individual or object, a lifespan of an individual or object, an age of an individual or object, an individual's or object's morality, an individual's or object's ethics, an individual's or object's etiquette, behavior definition(s), an urgency for behavior performance, a behavior importance, behavior priorities, individual's or object's boundaries, a mission ontology, a maneuver ontology, and/or a relationship between the individual or object and another individual or object. The other information can include, but is not limited to, a human language for defining the DNA structure and a computer language in which the DNA structure is created.

In 3708, a DNA structure (e.g., DNA AI intelligence structure 3300 of FIG. 33) is built, fabricated or otherwise created. The DNA structure comprises the behavior data object linked to a root data object (e.g., root data object 3302 of FIG. 33). The root data object comprises information concerning the electronic device being controlled to take one or more actions determined by the ontogenesis engine in view of a stimuli and/or an impingement action. For example, if the electronic device is a vehicle, it can be controlled to take actions to travel forward, travel backwards, stop traveling, increase speed, decrease speed, turn left, turn right, and/or climb stairs in view of changes in an environment and/or road conditions. The present solution is not limited to the particulars of this example.

In 3710, second information is received. The second information is associated with a second iteration of AI operations performed by the ontogenesis engine. A next behavior data object is generated in 3712 using the second information. The next behavior data object is added to the DNA structure so as to be linked directly to the root data object or indirectly to the root data object via the behavior data object, as shown by 3714. A linkage between the behavior data object and the next behavior data object may specify a temporal order of at least two behaviors that the electronic device is able to perform. In some scenarios, block 3714 involves: determining if a behavior associated with the next behavior data object is part of a sequence of behaviors; and deciding that the next behavior data object should be indirectly linked to the root data object via the behavior data object when a determination is made that the behavior associated with the next behavior data object is part of the sequence of behaviors.

The DNA structure may be used in 3716 to control, modify or advance the artificial intelligence operations performed by the ontogenesis engine in a third iteration. For example, the DNA structure can be used to (i) bypass the AI operations of one or more modules 2402-2426 of the ontogenesis engine 2400, (ii) cause a simulation to be performed prior to initiating the third iteration, and/or (iii) limiting the actions or behaviors that the ontogenesis engine 2400 can possibly output in the third iteration. This is an important feature of the present solution since it allows for an improvement in the A1 system that results in reduced computational intensity and reduced resource intensity.

In 3718, the system analyzes an outcome from performance of behavior associated with the next behavior data object to determine whether a goal has been met or achieved. For example, the system analyzes sensor data to determine whether the vehicle successfully traveled around an obstacle. The sensor data can be generated by sensors (e.g., components 3804 of FIG. 38) of the vehicle. Movement of the vehicle can be performed in accordance with any known or to be known technique. Movement components (e.g., movement components 3802 of FIG. 38) can facilitate such vehicle movement. The movement components can include, but are not limited to, wheels, brakes, gears, motors, engines, and/or axels. The present solution is not limited to the particulars of this example. In 3720, a good or bad behavior marking is assigned to the next behavior data object based on results of the analysis performed in block 3718.

In 3722, the system determines whether a task has ever been performed by the electronic device. For example, the system determines whether the vehicle has traveled around a particular obstacle or traveled from a particular start location to a particular destination location. The present solution is not limited to the particulars of this example. When a determination is made that the task as not ever been previously performed by the electronic device, the system may start another iteration of the AI operations by the ontogenesis engine.

When a determination is made that the task as been previously performed by the electronic device, the system analyzes the DNA structure to identify data object(s) that has (have) been assigned a good behavior marking. Behavior(s), analytic setting(s) and metric setting(s) of the identified data object(s) are communicated to the ontogenesis engine to cause the electronic device to perform the behavior.

An outcome from the electronic device's performance of the behavior may be analyzed in 3728. The DNA structure may be selectively grown based on results of the analysis of block 3728. For example, another behavior data object may be added to the DNA structure when the analysis indicates that a goal was not met as a result of the vehicle performing the behavior. Additionally or alternatively, a good behavior marking of existing behavior data objects may be changed to a bad behavior marking. The present solution is not limited in this regard. Subsequently, method 3700 continues to 3732 where it ends or other operations are performed (e.g., return to 3702).

### Ontogenesis AI DNA Growth and Editing

Ontogenesis AI DNA editing enables analysis and sibling inherited DNA intelligence. Ontogenesis AI DNA editing is implemented using intelligence structure editing functions F (x) and math. The inputs to the functions F (x) can include, but are not limited to, DNA structures, corresponding attributes, corresponding ontology dictionaries, and corresponding security dictionaries. The functions F (x) may have the following parameters: a real DNA parameters, original DNA parameters, DMA maturity and rate of change (growth), DNA weight and density, and/or security levels and changes. The functions F (x) may be configured to implement comparison operations. The outputs of the functions F (x) can include answers to F (x) and/or answers to what levels of attributes.

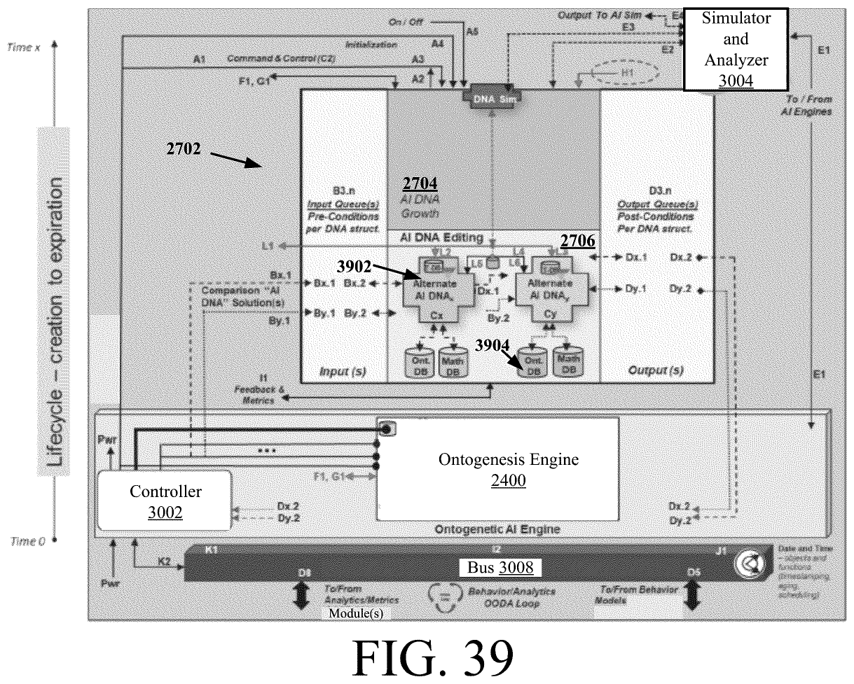

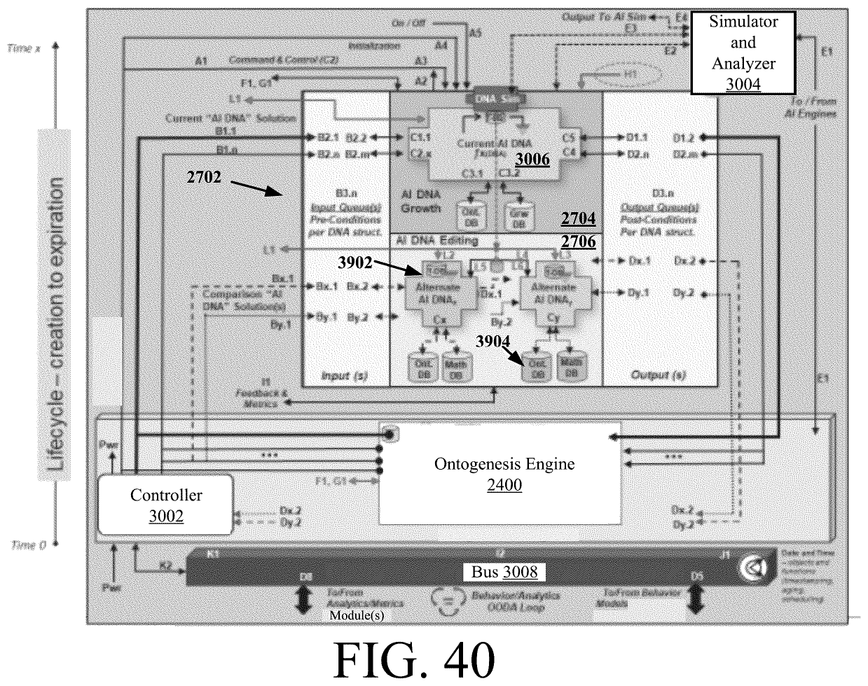

FIGS. 39-40 provide illustrations that show the DNA editing engine(s) 2706 in more detail. The DNA editing engine 2706 comprise DNA editor(s) 3902 and datastore(s) 3904. The ontogenetic AI DNA editing engine(s) 2706 is communicatively connected to a controller 3002, the ontogenesis engine 2400, a simulation and analyzer 3004, and a system bus 3008. Signals are communicated between the listed components during operation of the system. These signals are categorized into the following categories: a command and control category A, a data input category B, a data category C, a data output category D, an after action analysis category E, a handshake category F, a check category G, an interrupt category H, a feedback and control metric category I, a timing category J, an architecture category K, and C2 and user commands L. The user commands L may be from a human or another A1 system. These signals facilitate AI DNA editing.

Signals A1, A2, A3, A4, A5 are command and control signals from the hardware power sources, the other connected brain component(s), and/or humans to start to the engines 2704, 2706 and to control the functioning of the DNA editing engine 2706. Signals A1-A5 comprise system functions, DNA fabrication engine processes, prioritization rules, timing signal(s), and On/Off signal(s). More specifically, signal A1 comprises C2 source commands that originate from controller 3002 and/or the ontogenesis engine 2400 and are passed to the DNA editing engine 2706. The source command signals A1 may be structured as Ack-NAck-NAckNack responses. Signal A2 comprises C2 input signals that command and control the processes and functions within the DNA editing engine 2706. Signal A3 comprises C2 response signals from the DNA editing engine 2706. Signal A4 comprises C2 initialization signals that interact with the DNA editing engine 2706 for transitioning the DNA fabrication engine 2704 from a start-up (or power-up) state to a run state. The C2 initialization signals may initiate a start sequences operational readiness of functions and processes in the DNA editing engine 2706. Signal A5 comprises the C2 main power signal to the DNA editing engine 2706. Signal A5 comprises C2 source commands that are initiated from controller 3002, ontogenesis engine 2400 and/or users and turn on or off the DNA editing engine 2706.

The C2 signals can be used to control various operations of the DNA editing engine 2706. The C2 signals can cause the DNA editing engine 2706 to turn on, start processing data, stop processing data, flush data, and/or turn off. The DNA editing engine 2706 can include, but is not limited to, computer module(s) and/or processor(s).

A C2 signal for turning on the DNA editing engine 2706 may cause a set of computer module(s) and f(x) processor(s) to start operations, queue(s) to be flushed, processing and memory to be zeroized, and data to not enter the queue(s) or processor(s). The C2 signal can include a command having the form TurnOn {x . . . y} (where x . . . y are things to turn on) and a response having the form TurnOn_R {x . . . y}.

A C2 signal to start processing can include a command to start functions for receiving data and/or message in queues, obtaining data and/or message from the queues, and processing the data and/or messages. The command can have the form of StartProcessing {x . . . y}, where x . . . y are things to start processing. The response can be in the form of StartProcessing_R {x . . . y}.

A C2 signal to stop processing can include a command to disable operation(s) of the f(x) processor(s), disable an ability to receive data and/or messages in queue(s), disable an ability to pass data and/or messages out of the queue(s), and stop data and/or message processing. The command can have the form of StopProcessing {x . . . y}, where x . . . y are things to stop processing. The response can have the form of StopProcessingR {x . . . y}.

A C2 signal to flush processing can include a command to flush all data from memory, processor(s) and queue(s). The command can have the form of FlushProcessing {x . . . y}, where x . . . y are things to flush processing. The response can have the form of FlushProcessing_R {x . . . y}.

A C2 signal to turn off the DNA editing engine 2706 may cause a set of computer module(s), process(es), processor(s) and/or queue(s) to shutdown or otherwise turn off. The command can have the form of TurnOff {x . . . y}, where x . . . y are things to turn off. The response can have the form of TurnOff_R {x . . . y}.

A C2 signal can also be associated with checking the health and status of set of running functions (including behavior f(x)), running processes, running system modules, system architecture (CPU(s), memory(ies), buss(es), message queue(s), bounds checker(s), and/or software process(es). A heartbeat function is a health and status function command run at a determined periodicity, which is charted for analytics. The command can have the form of CheckHealth {x . . . y}, where x . . . y are things to check health. The response can have the form of CheckHealth_R {x . . . y}.

A C2 signal for cleanup can include command(s) to cleanup and discard hanging process(es), stale memory(ies), and/or hanging software process(es). This means there are state models or timers/processing algorithms to track computer processing which are constantly refreshed. The command can have the form of Cleanup {x . . . y}, where x . . . y are things to Cleanup. The response can have the form of Cleanup_R {x . . . y}.

A C2 signal may also be associated with checking the status of maintenance function(s) and progress (e.g., forward, backward, or noprogress), and return an OK, NotOK, and RepairStatus message(s) with metadata {processes, memory, busses, message queues bounds checkers, SW processes, etc.}. The command can have the form of CheckMaintenance {x . . . y}. The response can have the form of CheckMaintenance_R {x . . . y}.

A C2 signal may additionally or alternatively include a command to turn on or turn off a specific maintenance function, and/or a command to start a repair of predefined software function(s) to affect software and/or computer process(es). The command can include a string of instructions for starting a repair, initializing a repair, stopping a repair, shutting down a repair, replacing a repair, building a repair, stopping a repair replacement, and/or archiving a repair.

A C2 signal for causing a reaction may include command(s) to schedule a function within the DNA editing engine 2706 once an event occurred (e.g., error condition, filling up message (hit a limit), etc). Schedule can be now, or time in the future based on analytics.

A C2 signal for causing a pro-action may include command(s) to schedule a function in advance. The function scheduling or triggering may not be dependent of an event occurrence. There are number of processes that can be controlled by C2 signals. Within the DNA editing engine 2706, in addition to the AI DNA intelligence functions, there are a series of actions or steps to be taken to produce or respond to or edit, grow, mature, and/or evolve knowledge. Growth of intelligence has a sense of being more contextually accurate, contains history and/or learned intelligence, or more encompassing. Thus, this concept is applicable to information contained within the bounds of DNA editing engine 2706.

In the DNA editing engine 2706, there are points where new knowledge is created and/or knowledge is edited, and/or knowledge is grown and/or matured. There are points that deal with change(s) due to knowledge that has been created and/or knowledge that is edited, grown and/or matured elsewhere in the system (upstream), arrive at the DNA editing engine 2706 and attempt to flow thru the DNA editing engine 2706 and out of the DNA editing engine 2706. This yields overall both additive and subtractive growth processes.

This can come from, but not limited to: (a) a new, never before seen “best makeable solution” and its associated bounds, operating envelope(s) (which may necessitate new levels or kinds of intelligence DNA and/or it's associated DNA genealogy elements) and and/or hoping beyond its associated bounds and/or operating envelope(s); (b) syntax checkers in pre-condition and post-condition queue(s) may need to adapt to the new item(s); and/or (c) the corresponding behavior models, metrics and analytics models may need to update the intelligence DNA genealogy elements and demarcations in view of the new item(s). Given the ontogenetic creation and/or maturity of data objects, relationships, metrics, memory, processing, and functions that operate across them, the DNA editing engine 2706 recognizes (by comparison math), captures, and historically documents edited intelligence and the growth of intelligence.

The are various sources of ontogenetic change. The presentation of change comes from the processes and functions recognizing that data is new, edited or grown and does not fit into the data object bounds or data schema/architecture. This change is highlighted, added, and demarcated. Changes to the system could also come from positive human engagement and/or automated engagement using knowledge that may be gained from the environments and behaviors.

An original ontogenetic change and DNA growth may occur in response to a new piece of knowledge or stimuli entering the system. This ripples thru the system with each engine, memory, f(x) processing, memory, and behavior outcomes, metrics, etc. recognizing and being updated to deal with the new data objects and the associated processing, storage, etc. The schemas are expanded, updated, edited, grown, added to, subtracted, split, pruned, etc.

The system may perform a process to morph ontogenetic change through a recognition of change and an understanding of how the change should happen. In some cases, stimuli and events may cause data objects, data structures, ontology, schemas, memory, and/or processing to be outside of the normal or known operating envelope. Therefore, these items may be adjusted upward and/or outward increasing the operating envelope. The items may be additive in nature. The opposite is also possible, with the items being subtractive in nature. This is where, once the stimuli or object is measured and understood, those mentioned computer elements are morphed in an additive or subtractive manner—i.e., unlearning bad behavior.

In the additive scenario, the system obtains a data object and expands it by adding incremental values thereto. Next, “True-False” testing is utilized to validate that the data object has been created or grown enough to fit the new object. If the result goes in the wrong direction or doesn't return a true test result, different values are tested until the true test result is returned.

In a subtractive scenario, the system obtains a data object and subtracts therefrom another data object. The value of the data object may increase, decrease or stay the same. If the result goes in the wrong direction or doesn't return a true test result, different values are tested until the true test result is returned.

The C2 signal(s) may deliver prioritization rules to the DNA fabrication engine 2704. The prioritization rules may comprise rules to be followed when reading from queues and/or when performing processing operations. Higher priority objects/behaviors is/are picked up from queue(s) first and processed first. The goal of the priority algorithms is to prevent “priority inversion” (lower level priorities blocking high level priorities from processing because they were in the queues first) and allow efficient well-formed priority processing. Analytics are kept and updated to measure priority tasking processing wait times based on prioritization. This is used to apply for and harness additional resources when the established limits are approached (with a tolerance) or violated.

The C2 (J)_signal(s) may deliver timing signals. Each timing signal may be received via signals A2 and A4 and sets/synchronizes the DNA fabrication engine 2704 to time of day and the time of ontogenesis engine 2400.

A main source of the command and control signals C2 (and responses thereto) is from/to the main associated ontogenesis engine 2400 and/or controller 3002. There may be a one-to-one relationship, a relationship between the engines of the DNA editing engine(s) 2706 and ontogenesis engines 2400.

Data input signals Bx.1, By. In for the DNA editing engine 2706 are queued in queues Bx.2, By.2. Data input signal Bx.1 provides an AI editing main model associated with a current operating ontogenesis AI engine 2400. The AI DNA structure is associated with that ontogenesis AI engine 2400 unless it is demarcated and replaced using proper authorization. Data input signal By.1 provides a link to each additional AI DNA model. The data input signals facilitate linkages or connections between the main AI editing engine and the AI DNA genealogy structure with constant updating. A rejection notice may be sent due to quality checks or some other defined reasons. Upon checking for proper pre-conditions and proper DNA structure, the signal Bx.1 and/or By. In is passed to a queue.

Data input signal Bx.1 can include, but is not limited to, a best makeable solution, a linked Ai DNA genealogy structure, life span depth of ontogenesis newness, metadata about simulation solution(s), associated situational environment, proposed operational envelope, associated stimuli/event which caused the simulation, prioritization rules, timing signal, metadata describing situational awareness of the emergence and confidence engines 2420-2422 (including life span depth of ontogenesis newness of each element). Data input signal By.1 can include, but is not limited to, best makeable solution, linked Ai DNA genealogy structure, life span depth of ontogenesis newness, metadata about simulation solution(s), associated situational environment, proposed operational envelope, associated stimuli/event which caused the simulation, prioritization rules, timing signal, metadata describing situational awareness of the emergence and confidence engines 2420-2422 (including life span depth of ontogenesis newness of each element).

The input data signals Bx.1 and By.1 may be passed to queue B3.n where pre-condition checking processes are performed for the B input data signals. The pre-condition checking processes include, but not limited to, syntax checking, completeness/fullness (i.e., all the parts included in the package including proper DNA structure). Signals A1-A5 have “turned on” queue B3 with rules for off nominal reaction to error conditions within the input queue (full queue/backup processing, off profile inputting/outputting, incompleteness of data set, incorrect syntax, rules for re-transmission from associated and linked Ontogenesis AI Engine, etc.). Upon completion, the B signals are provided to Bx.2 f(x) AI editing main or secondary By.2 editing engine 3902.

The f(x) processing of the DNA editing engine 2706 will now be discussed. The DNA editing engine 2706 receives a data set including the current and active ontogenetic AI DNA genealogy hierarchy structure, a data stet including a copy of a single main ontogenetic AI DNA genealogy hierarchy structure, and a data set including a current ontogenetic AI DNA genealogy hierarchy structure and update/interaction signaling from each associated ontogenetic A1 engine and individual AI engine updates. The command and control signals may also be input into the AI DNA edit engine datastore(s) 3904 along with the ontology and language and math for the editing rules.

The f(x) processing of the DNA editing engine 2706 can involve: storing current editing DNA main structure and secondary editing DNA structure in each engine's perspective memory; checking the language database and associated language against both DNA structures; checking allowable math and associated math against both DNA structures; receiving, checking and parsing signal from L1 into L2 and L3; and examining both DNA structures starting with the main DNA structure according to the math rules. In some scenarios, a branch in the main DNA structure is selected and moved to L5. A corresponding branch in the secondary DNA structure is examined, selected and pulled into editing memory along L6 at point L4. In other scenarios, the main DNA structure is pseudo modified by the simulator 3004 at point L4, and what if tests are run or backed out from the main if the atomic transaction process has not been completed. The DNA structure(s) may be edited according to the math rules in the math database and the edit signals arriving from L1. Upon analysis (which might include human interaction or AI simulation to prove out assumptions as good), the main DNA structure is updated atomically and saved in engine memory via output queues to sourcing AI engine (Cx and Cy to Dx.1-Dx.2 and Dy.1-Dy.2). In the output queues, formatting and post conditions are validated before sending downstream. Ack and main” DNA structures are saved back down to AI engine hard disk hardware memory. An Ack check is done between main DNA structures. Next steps may not be started until both signal acknowledgements are sent down to receive sourcing A1 engine and received back.

In the AI DNA editing engine 2706, a main DNA genealogy may be edited with a different branch. The AI DNA editing engine 2706 may remain synchronized with the ontogenesis engine 2400 for (1) real-time comparison against history or (2) non-real-time operations (e.g., edit on a copy of a main DNA structure), or (3) editing operations on a simulation copy from the simulator 3004. There are several reasons that could cause a good to go edit solution in the AI DNA editing engine 2706 to be stopped. The reasons can include, but are not limited to, (a) a simple test condition step, (b) an ethics and boundary change, (c) an environment change, (d) a danger change, (c) failing sensor(s), (f) a changing DNA from mission or ethics changes after passing simulation, and/or (g) a DNA capturing past wisdom and action.

With regard to reason (a), the simulator 3004 may have a good to go simulation solution that would be stopped on purpose for testing within the ethics and boundaries engine 2412. A human or other A1 system may validate the stop, restart or reset simulation and/or operations of the AI DNA editing engine 2706. Appropriate demarcations may be added to the ontogenetic AI DNA growth engine 2702. Learning may be gained from the start and stop simulations requiring modifications to branches of a DNA structure and/or the addition/subtraction to branches of the DNA structure.

With regard to reason (b), the ethics and boundaries may be changed and the AI DNA editing engine 2706 may receive current conditions (e.g., restart conditions). Within the ethics and boundary engine 2412, there may be different rates of changes and updates to each area, which could cause this condition. However, for the ethics and boundary engine 2412 to operate efficiently and not be placed into a deadlock, early adolescent maturity decisions may be designed to include human interaction. More mature topic decisions may be paused to include re-cycles thru engine operations including new adjacently related sensor data/impingements. This adjacently related sensor data may un-jam the deadlock or redirect the processing.

With regard to reason (c), if an environment changes around the ontogenesis engine 2400, solution boundaries may no longer be valid causing operations of the AI DNA editing engine 2706 to stop. For example, there may be snow on the road or an autonomous vehicle problem. The autonomous vehicle may use white lines for judging road surface. However, at a certain level of snow and traffic, the vehicle tires may push snow into lines. Now the autonomous vehicle visualizes many lines, causing the ontogenesis engine 2400 to lock since it is unable to know which lines are to be followed. This may be addressed by manually causing the autonomous vehicle to slow down, use other road features for guidance, pull over to the side of the road, and/or stop driving. The other road features can include, but are not limited to, humps in road, detents in snow from other tires, guideposts on side of road, and/or other moving cars. Control may be return to engine 2402 to adjust processing to reflect changes in environmental stimuli. For example, the autonomous vehicle may be caused to proceed with caution, reduce speed, or stop if danger is eminent.

With regard to reason (d), if an environment changes around the ontogenesis engine 2400, the solution boundaries may no longer be valid due to potential danger. For example, there is a forest fire. Impingements call for evacuation as a best simulation. However, now smoke and fire have become closer to a given location while the engine is on the road (best simulated path). However, now the environment has changed so much and/or so rapidly that there is no “non-damaging” solution. All solutions have damage associated with the predicated outcome. Selecting how one will be harmed or the degree to which one will be harmed is the only way forward. In other words, the best makeable solution and all the other makeable solutions involve damage or causality. So, the ontogenesis solution is to select the least harmful solution (e.g., the best of potential worst case solutions).

Within humanity, this is often a very tough set of options to mentally wade thru. For instance, does a lifeguard enter dangerous water to try to save a drowning victim if the lifeguard might perish? Or does a General send soldiers onto a beach front to start an offensive to liberate millions, but knowing full well many will perish on the beach front? Within the AI ontogenesis engine 2400, the rules and logic for these scenarios are contained within the ethics and boundaries engine 2412. The ontogenesis engine 2400 is configured to recognize and calculate appropriateness (measurable analytics and costs) to put itself into harm's way if that means saving others or not. The measurable analytics and costs logic and algorithms may be contained in the AI DNA growth engine 2704.

There are many solutions to this issue such as: hold steady course based on best last data set; speed up and gamble to bust thru fire wall and get to other side with limited damage (i.e., make best decision with limited data and estimate damage outcome and knowing that some damage will occur); and/or slow down while recalculating—may result in more damage due to a sustained timeframe in a danger zone. DNA growth may be updated with where to assign control. Operations of the ontogenesis engine 2400 may be overridden and another course of action taken. The override feature is designed and configurable to have different allowable states and different levels of associated authorities. These can be associated with different levels of imminent danger assessments (e.g., closeness of danger and predicted magnitude of damage vs. allowable response magnitude and force). An override decision may be designed to be allowed due to imminent damage assessments levels. Imminent danger levels may be an equation of override levels=f(x) options {magnitude of danger; estimated time of impact; estimated impact/causality assessment} AND {allowable response force type and allowable response force magnitude}. The authority levels may be directly related, proportional and configurable to override options. The ethics and boundaries engine 2412 may hold the definitions of imminent danger equation boundaries and the associated authorities for override.

With regard to reason (c), sensor(s) may be failing and sending data which is inaccurate or faulty. This may cause an interrupt. Deconfliction efforts may include re-examining a single sensor to see if the data is within acceptable boundaries or if there are error conditions with the sensor control circuitry. If out of bounds, then the sensor may be controlled to re-measure the condition. If the sensor data value(s) is (are) still out of bounds, the the system may examine related sensors of same or alternate types in order to find support information for a faulty sensor condition or for a normal sensor condition. A normal sensor condition may include, but is not limited to, a sensor accurately reporting an error condition or a danger condition. When there is an error condition, a message may be sent from the wisdom and action engine(s) 2424-2426 to the ethics and boundary engine 2412. The ethics and boundary engine 2412 may cause the ontogenesis engine 2400 from stopping with the current solution in response to the message. The analyzer 3004 may also perform an analysis of the DNA structure to determine whether it should be modified or otherwise updated. The ontogenesis engine 2400 may then re-start its operations using the modified and/or updated DNA structure.

With regard to reason (f), a change in a DNA structure may result from mission or ethics changes after passing calculation and/or simulation. If a mission changes, the goal of the simulation changes and possibly the DNA structure changes. If ethics change, the acceptable parameters of the simulation changes. Therefore, under normal processing, the simulation may not be valid any longer.

However, there is also a case where the mission or mission constraints change after the control has passed the emergence and confidence engine(s) 2420-2422. When control arrives at the wisdom and action engine(s) 2424-2426, a check may be performed again the ethics and boundaries. The DNA structure may be passed to the DNA editing engine 2706 for updating based on or responsive to results of the check. Forward progress of the ontogenesis engine's operations may be stopped and restarted using the updated DNA structure.

With regard to reason (g), a DNA structure captures pass wisdom and action. Within the f(x) of the wisdom engine 2424, there may be a metrics calculator that measures and tracks against past wisdom and actions to understand if this is outside permissible or otherwise allowable bounds. The metrics calculator and analyzer may be configured to measure, capture, and analyze to understand each branch of the DNA structure, the differences between the branches of the DNA structure, and/or the differences in any mark-ups to a main DNA structure. This understanding may be used to determine: edges of acceptable growth and rate of growth (growth may be positive or negative); whether growth of a DNA structure is outside normal bounds and/or acceptable limits; whether growth of a DNA structure is moving towards an overload situation or in a wrong direction in relation to bound(s) or limit(s). For many areas, there may be mathematical functions and a set of parameters which describe elastic distance and rates of change. DNA objects may be configured to capture one or more of these conditions.

The simulator and analyzer 3004 may perform an after action analysis of DNA structure(s). The after action analysis can involve: performing simulated learning (e.g., testing what if scenarios) to understand possibilities of how the intelligence genealogy changes and grows with editing and with simulated inputs generated thereby. Upon a set of ontogenetic AI knowledge growth or exercise, the simulator and analyzer 3004 may perform a step-by-step examination thru the cycles after AI actions. The simulator and analyzer 3004 may perform a lessons learned analysis that involves an analysis, comparison, and categorization of positive or negative growth of DNA structure(s) and/or a logic examination of root causes for the growth of the DNA structure(s). The simulator and analyzer 3004 may identify bad growth of the DNA structure(s) and parameters that caused the bad growth. The parameters may be changed to avoid such bad growth in the future. Results of the after action analysis, step-by-step examination, and/or lessons learned analysis may be stored in datastore of the ontogenetic AI SNA grown engine 2702.

The simulator and analyzer 3004 may also perform after action and lessons learned analysis and storage operations. Metrics and analytics may be captured regarding full set of data elements for the purpose of analyzing the knowledge gained (both positive and negative) by the usage of the behavior model(s) and the analytics(s) output from the ontogenesis engine 2400 in response to the impingements, stimuli, and normal growth. As the result of an impingement, stimuli, or growth response, operations of each sensor and function engine may be examined to determine whether a better solution could have been derived by the ontogenesis engine 2400 which may have resulted in a more positive outcome. Results from this analysis may be stored in datastores of the AI system 2700.

Signals E1 can include, but are not limited to, after action transaction data. Signals E1 may be passed to and from associated AI engine(s). Solution(s) of the ontogenesis engine 2400 may be passed to the ontogenetic AI DNA growth engine 2700 via signals E1. E1 signals can include, but are not limited to: a simulated solution with highest confidence value and confidence, a rating, a ranking, and associated operating envelope, an x-tuple, associated situational environment, proposed operational envelope, associated stimuli and/or event which caused the simulation, prioritization rules, timing signal, metadata describing situational awareness of the emergence and confidence engines 2420-2422, metadata of the DNA fabrication engine(s) 2704, timestamps of outputs, behavior model(s), analytic model(s), ethics metadata, and/or interrupt metadata.

Signals E2 can include, but are not limited to, after action and lessons learned real time data, transaction data from the DNA fabrication engine 2704, and/or transaction data from the DNA editing engine 2706. The transaction data from engine(s) 2704, 2706 may be pass to the simulator and analyzer 3004 and/or stored in datastore(s) 3904. Signals E2 can include: a solution with intelligence DNA growth genealogy, rating, ranking, associated operating envelope, associated situational environment, proposed operational envelope, associated stimuli and/or event which caused the simulation, prioritization rules, timing signal, metadata describing situational awareness of the emergence and confidence engines 2420-2422, metadata for the DNA fabrication engine(s) 2704, timestamps of outputs, behavior model(s), analytic model(s), ethics metadata, and/or interrupt metadata.

Signal E3 may be used to connect the simulator and analyzer 3004 with the AI DNA structures for use in simulations. The purpose of signal E3 is to connect the analyzer 3004 with the ontogenetic AI DNA intelligence DNA growth engine 2702 to facilitate what if simulations. Simulation results may be stored in datastores of the AI system 2700. Signal E3 may also be used to pass DNA editing data to the simulator 3004. Simulation transaction data from the DNA editing engine 2706 may be passed to the simulator 2004 via signal E3 and/or stored in datastores. Growth data may also be passed if both engines 2704, 2706 are running in parallel. Signal E3 can include, but is not limited to, solution with intelligence DNA growth genealogy and simulation run number with adjusted rules and data, rating, ranking, associated operating envelope; associated situational environment, proposed operational envelope, associated stimuli and/or event which caused the simulation, prioritization rules, timing signal, metadata describing situational awareness of the emergence and confidence engines 2420-2422, metadata associated with the DNA fabrication engine 2704, timestamps of outputs, behavior model(s), analytic model(s), ethics metadata, enveloping security algorithms, and/or interrupt metadata.

Signal E4 provides a means to connect the DNA editing engine 2706 with the analyzer 3004 to facilitate interconnected simulation and/or lessons learned analysis. As intelligence edits, grows, and changes or the ontogenesis engine 2400 acquires new knowledge, both interconnected simulation engines 3004 can hypothesize and run what if scenarios in order to run full spectrum analysis and beyond boundaries in order to predict and/or plan how the DNA growth would lead to greater maturity, including instant intelligence learning. This can lead to goals being reached and optimization of certain unknown or known attributes. Signal E4 can include, but is not limited to, solution with intelligence DNA growth genealogy and simulation run number with all adjusted rules and data, rating, ranking, associated operating envelope, associated situational environment, proposed operational envelope, associated stimuli and/or event which caused the simulation, prioritization rules, timing signal, metadata describing situational awareness of the emergence and confidence engines 2420-2422, metadata associated with the DNA fabrication engine 2704, timestamps of outputs, behavior model(s), analytic model(s), ethics metadata, enveloping security algorithms, and/or interrupt metadata.

Signal F1 is used for handoff of state machine control. After data is passed to Dx.2 and Dy.2 and after data is passed to E2 After action analysis, then a control signal is issued over F1 to begin the over-all ontogenesis processing and AI DNA intelligence processing again (loop back to the beginning).

Signal G1 is used for an initial and constant check on AI DNA goodness before action, growth and security control. After data is passed into input queues B3.n, checks are done. Goodness analytics are performed in the queues B3.n to watch the data. If the input data falls outside of prescribed boundaries, then a goodness DNA alert is issued back to the AI ontogenesis engine 2400 to pause and debug/rebuild the inputs to the ontogenetic AI DNA growth engine 2702. If the goodness falls within proper bounds, a G1 goodness signal is issued to begin the over-all ontogenesis processing and AI DNA intelligence processing again (loop back to the beginning).

Signal H1 is used as an interrupt on function(s) control. Sometimes, there are halt or interrupt signals issued by the AI ontogenesis engine 2400 and/or ontogenetic AI DNA growth engine 2702. When this happens, incomplete data is not committed to the datastores and control is passed back to the A1 ontogenesis engine 2400. AI DNA is appropriately captured and demarc'd.

Signal I1 is used for feedback and control metric control. Within AI DNA, feedback and control metrics are captured, stored, and measured within the ontogenetic AI DNA growth engine 2702. The metrics may be delivered and received from the architecture bus 17. Metric setting may be provided to the DNA editing engine 2700, and metrics may be provided to the AI ontogenesis engine 2400.

Signal J1 is used for timing control. Within AI DNA, tTiming signals are also captured, stored, and measured within the AI DNA. The main timing source transmits a timing signal through all the modules within the DNA editing engine 2706. One standard architecture is that this signal is put into the main message bus and sent to all the modules or it is connected into each module directly. Once the DNA fabrication engine 2704 receives the timing signal, it can distribute to all modules as part of the C2 commands.

Signals K1-2 are used for architecture messaging. The architecture of the DNA editing engine 2706 may be of several types: single structure with CPU, memory, software bus, etc. with software applications running the above processing and AI DNA collocated with the ontogenesis engine 2400; or a distributed architecture with several queue structures to pass messaging along a bus structure between the different processes and the AI DNA distributed separately from the ontogenesis engine 2400. The queue and bus structure can pass full data packets which are the items to be processed, pass references to memory locations where the items to be processed are located, or pass combinations thereof.

Signal K1 is used for architecture control. The architecture includes bus(es), interface(s), schema(s) and translator(s) to interconnect modules and pass info (objects) and/or to behavior and/or from analytics and between the ontogenetic AI DNA growth engine 2702 and the ontogenesis engine 2400.

Signal K1 is used for communicating commands for math editing instructions, C2 history (also to user interface) and control. Signal L1 may include, but is not limited to, the following items: (i) C2 commands for Math Editing Instructions; (ii) C2 history; and/or (iii) C2 to a potential user interface (human or other A1 system) is equipped. K1 signals with item (i) contain all the allowable math and math functions allowable by the DNA editing engine(s) 2706. For example, how to add a branch to a DNA structure, what ontology to use when editing a DNA structure, what language to use when editing a DNA structure, what prioritization of security codes to use, etc. K1 signals with item (ii) contain the C2 history for memory recall and examination. K1 signals with item (iii) contain allowable messaging and potential error conditions if the system comprises a machine-to-human interface or AI machine-to-AI machine interface.

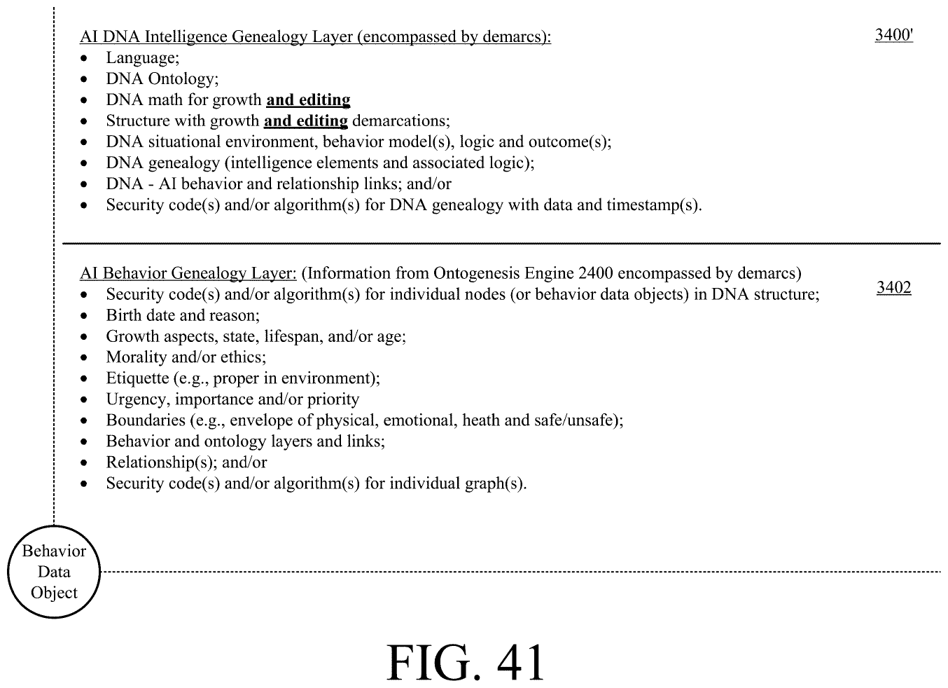

As noted above in relation to FIG. 34, each behavior data object comprises certain information, start demarcations and/or end demarcations. This information may be separated into two layers, namely an AI DNA intelligence genealogy layer 3400 and an AI behavior genealogy layer 3402. The information in one or both of these layers may be modified to facilitate DNA structure editing by the DNA editing engine(s) 2706. For example, as shown in FIG. 41, the AI DNA intelligence genealogy layer may be modified to additionally comprise DNA math for editing and structure with editing demarcations. The modified AI DNA intelligence genealogy layer is referenced by number 3400′.

Each DNA editor 3902 of the DNA editing engine(s) 2706 is configured to (i) analyze a single AI DNA structure at any given time and/or (ii) compare two or more AI DNA structures to each other at any given time. In the first case (i), a DNA editor 3902 receives an AI DNA structure, examines the branches (e.g., branched 3350, 3352, 3354 of FIG. 33) in the AI DNA structure, identifies which branch(es) has (have) attributes that could be changed or are associated with sub-performance(s) or extra performance(s), and store information associated with the identified branch(es) for later editing of the AI DNA structure. Thereafter, a next AI DNA structure may be analyzed. So, the DNA editor 3902 can analyze AI DNA structures in a sequential manner.

In the second case (ii), the DNA editing engine 2706 receives two or more AI DNA structures and an associated editing request. Additional editing requests may be in a series and come with time spaces. The AI DNA structures can include, but are not limited to, AI DNA structures fabricated by the DNA fabrication engine(s) 2704, simulated AI DNA structure(s) from the simulator 3004, and/or AI DNA structures of another AI system in a network of AI systems. For example, the current A1 system is a first autonomous vehicle of a plurality of autonomous vehicles that are communicatively connected to each other via a network (e.g., the Internet). This networked AI system allows autonomous vehicles to learn from each other and share learned knowledge with each other.

Based on the contents of the editing request, one of the AI DNA structures is considered a main AI DNA structure that is to be edited in view of the other AI DNA structures. The DNA editing engine 2706 compares the branches of the main AI DNA structure with the branches of the other AI DNA structure(s). Based on the comparison operations, the DNA editing engine 2706 performs operations to (1) identify which branch(es) contain(s) the attributes that are desired, (2) whether the identified branch(es) are contained in the main AI DNA structure or another one of the AI DNA structures, and (3) whether the main AI DNA structure should be edited in view of the identified branch(es). The main AI DNA structure may be edited by, for example: adding the identified branch(es) in its (their) entirety; adding only a portion of an identified branch thereto as a new branch or a sub-branch to an existing branch thereof; adding link(es) (actual or simulated) between existing data objects thereof; trimming or otherwise removing existing branch(es) therefrom; re-marking existing branch(es) therein as being associated with “bad behavior”; adding or modifying start and end demarcations; adding editing demarcations; changing encryption algorithms for branch(es) or sub-branch(es); and/or marking branch(es) or sub-branch(es) as being associated with invalid behavior due to an expiration of defined time period, a change in a mission, and/or a change in ethic or policy rule(s). In this way, the AI system of the present solutions implements sibling inherited DNA intelligence.

An editing demarcation is a label attached to an edge or end of an AI DNA branch or sub-branch that is being highlighted to be added to or subtracted from another DNA genealogy. A growth demarcation is a label attached to a point in the AI DNA structure marking a specific point of growth or knowledge event. Either type of demarcation may be inside or outside the other one.

Set theory math rules may be employed to facilitate the above-described editing operations of the DNA editing engine 2706. The set theory math rules allow for (i) identifying interested in whole or parts of branches in AI DNA structures, (ii) copying identifying interested whole or parts of AI DNA branches (e.g., making an equality copy) into a main AI DNA structure; adding or subtracting identified interested whole or parts of AI DNA branches to an existing main AI DNA branch; updating appropriate values of an AI DNA structure; and/or updating security mechanism(s). After calculations are complete, the DNA editing engine 2706 may write into the main AI DNA structure via an atomic process. The default intent is to allow direct set theory math governance and management of the edit, but it may be restricted or expanded by the ethics rules engine 2412. An AI DNA branch may be inserted into the main AI DNA structure. Given behavior models, there may be an importance to the insertion point in the main AI DNA structure. The genealogy structure may be reoriented to highlight a particular behavior mode or learned behavior.

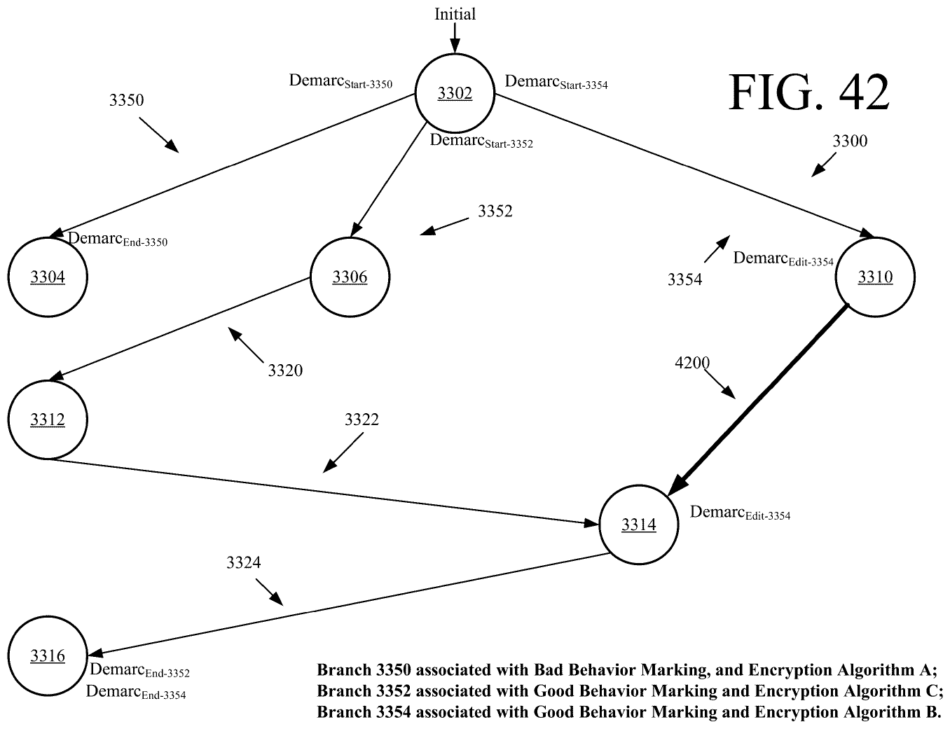

FIGS. 42-46 provide illustrations that are useful for understanding editing of a DNA structure by the DNA editor(s) 3902 of the DNA editing engine(s) 2706. As can be seen in FIG. 42, a link 4200 has been added between data objects 3310 and 3314 of AI DNA structure 3300. Link 4200 may be a copy of a link in another AI DNA structure to which the AI DNA structure 3300 was compared by the DNA editing engine(s) 2706. The other AI DNA structure may be a simulated AI DNA structure received from simulator 3004, an AI DNA structure fabricated by the DNA fabrication engine 2704, or an AI DNA structure received from another AI system in a network of AI systems. Edit demarcations have also been added to mark the addition of link 4202 to the AI DNA structure 3300. The end demarcation for branch 3354 has also been moved from data object 3310 to data object 3316. In this regard, it should be noted that the links indicate a temporal order in which actions, tasks or behaviors associated with the data objects are to be performed. So, new link 4202 of branch 3354 indicates that the temporal sequencing of actions, tasks or behaviors associated with the data objects 3310, 3314. The actions, tasks or behaviors associated with the data objects 3310 are to be performed prior to the actions, tasks or behaviors associated with the data object 3314.

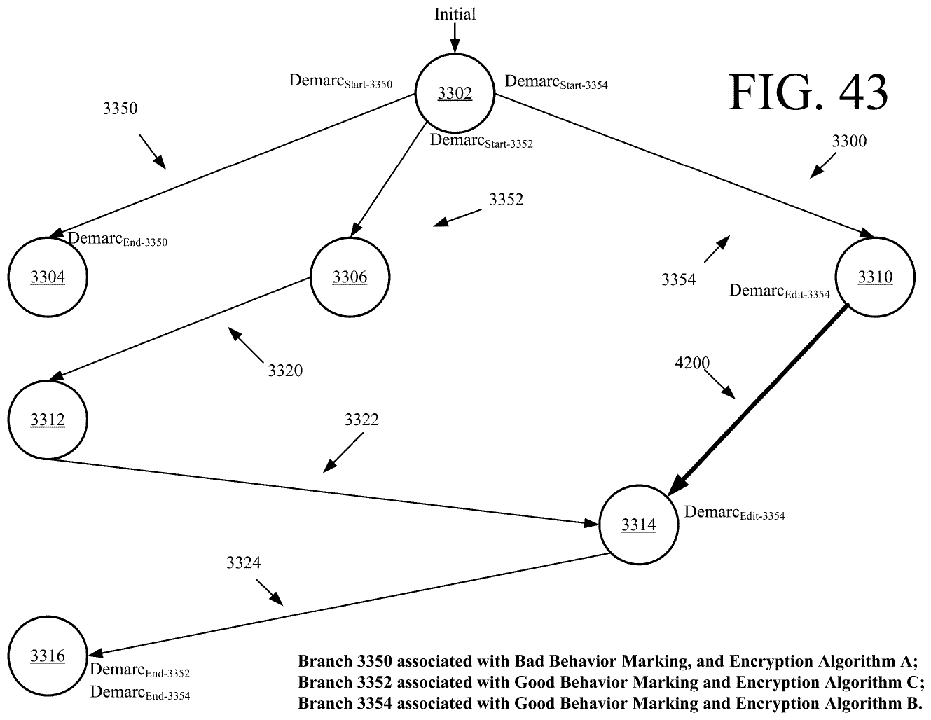

As shown in FIG. 43, the AI DNA structure 3300 has been edited by changing the good behavior marking associated with branch 3350 to a bad behavior marking and changing the manner in which the information of branch 3352 is encrypted. Originally the information of branch 3352 was encrypted in accordance with an encryption algorithm A, but now is encrypted in accordance with a different encryption algorithm C.

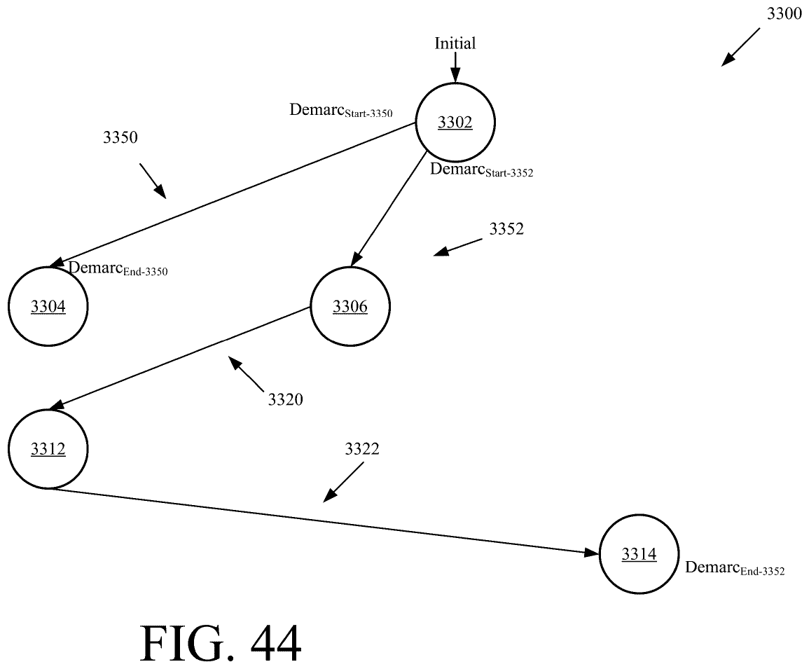

As shown in FIG. 44, branch 3354 has been subtracted or otherwise removed from AI DNA structure 3300. The present solution is not limited in this regard. The branch may alternatively remain in the AI DNA structure and be deprecated so that it is not used in subsequent operations. Data object 3316 and link 3324 have been trimmed from branch 3352. As such, the end demarcation for branch 3352 has been moved to data object 3314.

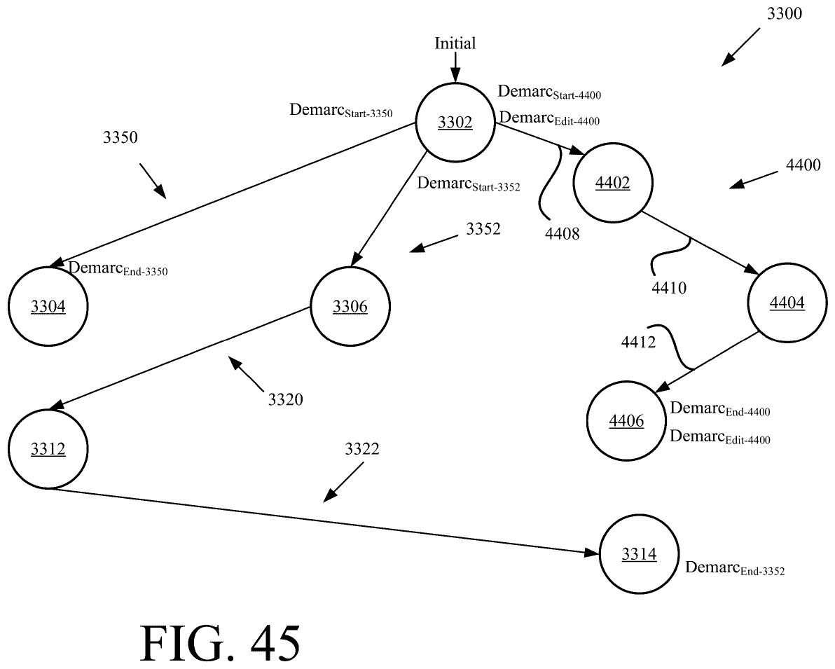

As shown in FIG. 45, a new branch 4400 has been added to AI DNA structure 3300. New branch 4400 may be a copy of an entire branch in another AI DNA structure or a copy of only a portion of a branch in another AI DNA structure. New branch 4400 starts with existing data object 3302. New branch 4400 may additionally include, but is not limited to, data objects 4402, 4404, 4406 and links 4408, 4410. The data objects 4402, 4404, 4406 and links 4408, 4410 specify actions, tasks and/or behaviors that the AI system is to be performed in a sequential order. For example, branch 4400 specifies that an autonomous vehicle is to turn right, turn left and stop. The present solution is not limited to the particulars of this example. Growth demarcations and edit demarcations are added to the AI DNA structure 3300 for the new branch 4400. New branch 4400 starts with data object 3302 and ends with data object 4406.

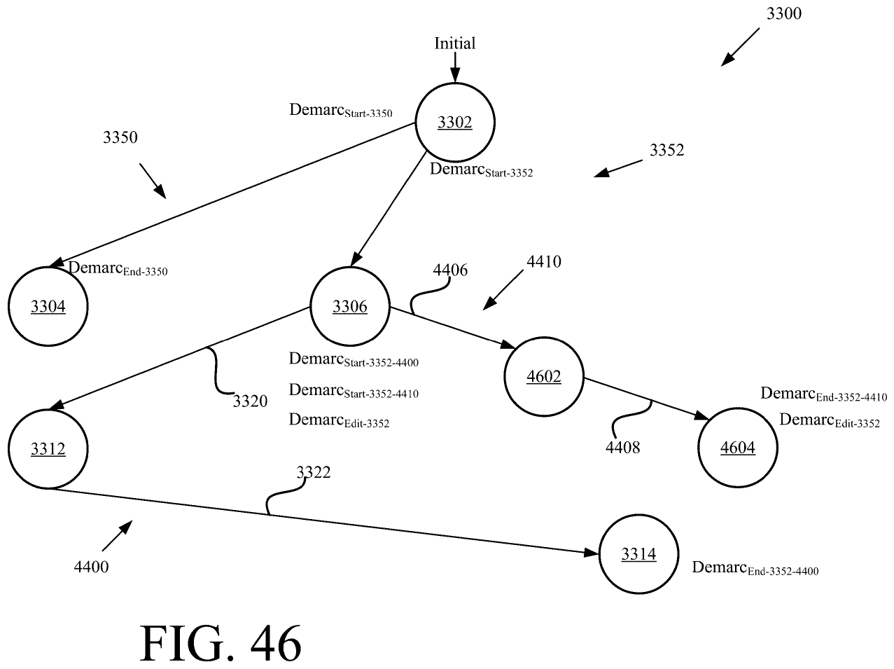

As shown in FIG. 46, the AI DNA structure 3300 has been edited to add a new sub-branch 4410 to branch 3352. Sub-branch 4410 may be a copy of an entire branch in another AI DNA structure or only a portion of a branch in another DNA structure. The good behavior markings (stored in objects) may also be stored in relation to sub-branch 4410. Branch 3352 now includes two sub-branches 4400 and 4410 which both start with data object 3306. The end demarc Damarc_{End-3352} for branch 3352 has been removed or replaced. In this regard, the AI DNA structure 3300 now comprises start and end demarcs for the two sub-branches. These start and end demarcs are referenced by Damarc_{Start-3352-4400}, Damarc_{End-3352-4400}, Damarc_{Start-3352-4410}, and Damarc_{Start-3352-4410}. Edit demarcs are also added to the AI DNA structure 3300 for branch 3352. The edit demarcs are referenced by Damarc_{Edit-3352}.

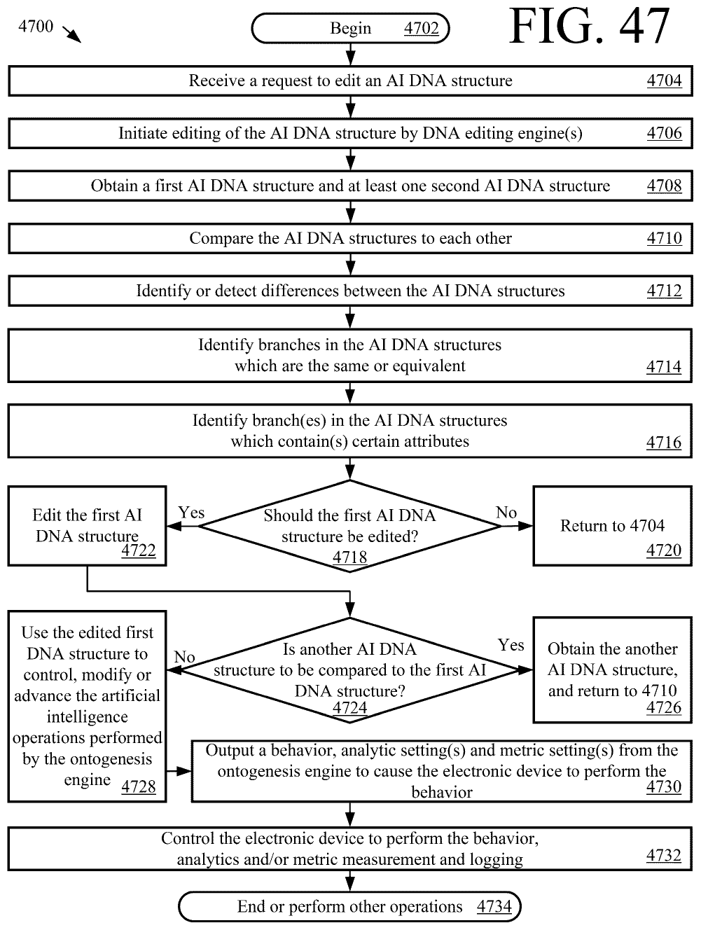

FIG. 47 provides a flow diagram of an illustrative method 4700 for analyzing and/or editing an AI DNA structure and controlling an AI system using the same. Method 4700 can include more or less operations that that shown in FIG. 47. All or a portion of method 4700 may also be added to, incorporated with, performed after, and/or performed concurrently method 3500 of FIG. 35, 3600 of FIGS. 36 and/or 3700 of FIG. 37. Method 4700 begins with 4702 and continues with 4704 wherein the DNA editing engine 2706 receives a request to analyze and/or edit an AI DNA structure (e.g., AI DNA structure 3300 of FIG. 33). The request may be in response to, for example, a user-software interaction with the A1 system, expiration of a specified period of time, a change in the AI DNA structure or another AI DNA structure, a completion of or a change in a mission for the AI system, a change in ethic and/or policy rules, and/or completion of a simulation by simulator 3004. The DNA editing engine 2706 initiates editing of the AI DNA structure in response to the request, as shown by 4706.

Next in 4708, the DNA editing engine 2706 receives or otherwise obtains a first AI DNA structure and at least one second AI DNA structure. The first AI DNA structure is considered the main or primary AI DNA structure that is to be analyzed and/or edited. The second AI DNA structure is considered the secondary AI DNA structure that is to be used for analyzing and/or editing the first AI DNA structure. The second AI DNA structure can include, but is not limited to, an AI DNA structure fabricated by the DNA fabrication engine(s) 2704, a simulated AI DNA structure received from the simulator 3004, an AI DNA structure received from another electronic device in a network of electronic devices, or an AI DNA structure received from another AI system in a network of AI systems. The network of electronic devices can include, but are not limited to, robotic systems (e.g., articulating arms, autonomous vehicles, etc.) and/or other devices (radios, mobile phones, computing devices, etc.).

In block 4710, the DNA editing engine 2706 performs operations to compare the branches (e.g., branches 3350, 3352, 3354 of FIG. 33) of the first AI DNA structure (e.g., AI DNA structure 3300 of FIG. 33) with the branches of the second AI DNA structure. These comparison operations allow the DNA editing engine 2706 to identify or detect differences between the two AI DNA structures (as shown by block 4712), as well as identify branches in the two AI DNA structures which are the same or equivalent (as shown by block 4714). A difference in the AI DNA structures may be, for example, that a branch or link exists in one of the AI DNA structures but not in the other one of the AI DNA structures. An equivalent branch may refer to a branch of an AI DNA structure which is associated with a task or goal that is the same as the task or goal associated with a branch of another AI DNA structure. For example, two equivalent branches specify different ways to successfully achieve the same task or goal. The present solution is not limited to the particulars of this example.

The comparison operations also allow the DNA editing engine 2706 to identify which branch(es) of the first and second AI DNA structures contain(s) certain attributes (as shown by block 4716). The attributes can include, but are not limited to, a start action or behavior, an end action or behavior, a total number of sequential actions or behaviors, an associated good behavior marking, an associated cryptographic algorithm, a total number of AI system successful performances of the behavior defined by a branch, a number of sub-branches, a time that the branch was fabricated or added to the AI DNA structure, an ability for a branch to be edited in any manner or a given manner, and/or a state of the branch (e.g., has the branch been edited or is it still in its original fabricated form).

Based on the results of operations in blocks 4712-4716, the DNA editing engine 2706 determines whether the first AI DNA structure should be edited in view of the second AI DNA structure and/or other information (for example, an L1 signal received from another AI system recommending that a particular branch be subtracted, deprecated or re-utilized). The other information can include, but is not limited to, an expiration of defined time period, a change in a mission plan, a change in a security level of a mission plan, and/or a change in ethic or policy rule(s). For example, the DNA editing engine 2706 may determine the first AI DNA structure should be edited when: (i) the second AI DNA structure comprises at least one link, at least one branch, and/or at least one sub-branch that the first AI DNA structure does not have; (ii) the first and second AI DNA structures have a same or equivalent branch or sub-branch with different security settings (e.g., different cryptographic algorithms); and/or (iii) the first and second AI DNA structures have a same or equivalent branch or sub-branch with different associated behavior markings (e.g., one has an associated good behavior marking while the other has an associated bad behavior marking). Otherwise, the DNA editing engine 2706 may determine that the first AI DNA structures should not be edited in view of the second AI DNA structure. When this occurs [4718:NO], method 4700 returns to 4704 as shown by block 4720.

In contrast, when a determination is made that the first AI DNA structure should be edited [4718: YES], method 4700 continues to block 4722 wherein the DNA editing engine 2706 performs operations to edit the first AI DNA structure. The operations can include, but are not limited to: adding a copy of an entire branch from the second AI DNA structure to the first AI DNA structure as a new branch or sub-branch; adding a copy of a portion of a branch from the second AI DNA structure to the first AI DNA structure as a new branch or sub-branch; adding a copy of a link from the second AI DNA structure to the first AI DNA structure as a new link; removing a branch or sub-branch from the first AI DNA structure that is the corresponds to, is the same as and/or an equivalent to a branch or sub-branch in the second AI DNA structure; removing a link from the first AI DNA structure; modifying growth demarcs for one or more branches or sub-branches in the first AI DNA structure; adding edit demarcs to one or more branches, sub-branches and/or lines of the first AI DNA structure; changing an encryption algorithm for one or more branches or sub-branches in the first AI DNA structure; and/or changing a behavior quality marking (e.g., a good behavior marking or a bad behavior marking) associated with one or more branches or sub-branches in the first AI DNA structure.

Upon completing the operations of block 4722, method 4700 continues to block 4724 where the AI system determines or checks whether another AI DNA structure is to be compared to the first AI DNA structure. If so [4724: YES], then method 4700 continues to block 4726 where the another AI DNA structure is obtained and the process returns to block 4710.

If not [4724:NO], then method 4700 continues to block 4728 where the edited first AI DNA structure is used to control, modify or advance the AI operations performed by the ontogenesis engine 2400. For example, the edited first AI DNA structure can be used to (i) bypass the AI operations of one or more modules 2402-2426 of the ontogenesis engine 2400 in a current or next iteration thereof, (ii) cause a simulation to be performed prior to initiating the current or next iteration, and/or (iii) limiting the actions or behaviors that the ontogenesis engine 2400 can possibly output in the current or next iteration. This is an important feature of the present solution since it allows for an improvement in the AI system by implementing sibling inherited DNA intelligence that results in reduced computational intensity and reduced resource intensity.

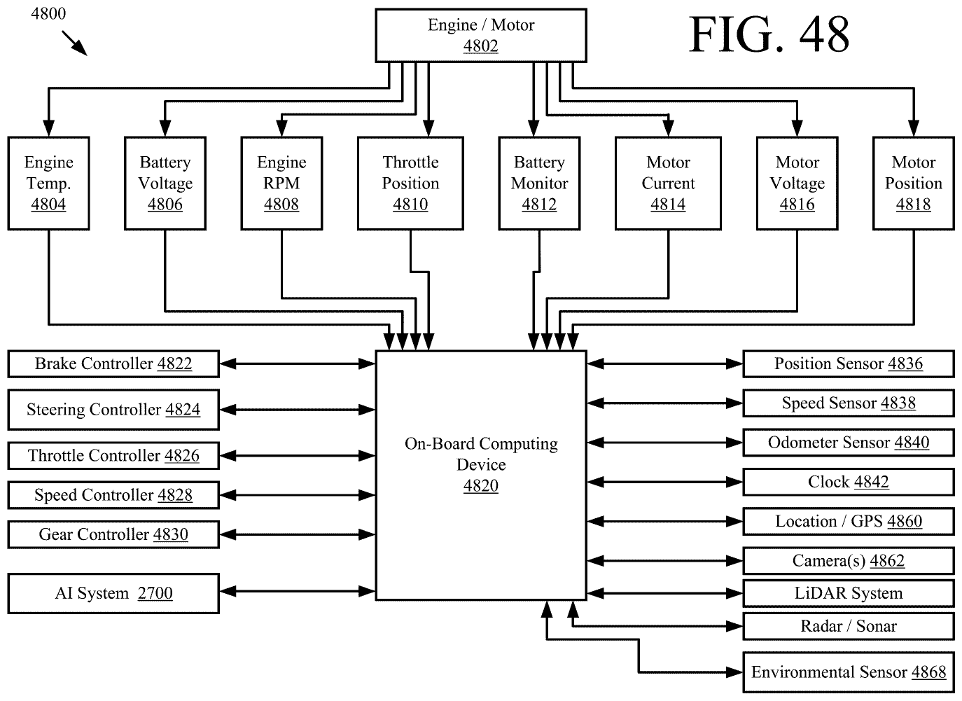

In block 4730, the ontogenesis engine 2400 outputs a behavior, analytic setting(s) and metric setting(s) to cause the electronic device (e.g., an autonomous vehicle) to perform the behavior (e.g., maneuver around an obstacle, and/or drive from a start location to a destination location). The electronic device is controlled in 4732 to perform the behavior, analytics and/or metric measurements and logging. Any known or to be known technique for controlling operations of an electronic device can be used here. For example, in the scenario of FIG. 48, the electronic device comprises a robotic system 4800 with an on-board computing device 4820 configured to control movement operations thereof. The on-board computing device 4820 is communicatively connected to the AI system 2700 of FIG. 27. Upon completing the operations of block 4732, method 4700 continues with block 4734 where it ends or other operations are performed (e.g., return to block 4702).

FIG. 48 provides an illustration of an architecture for an illustrative robotic system 4800 implementing the present solution. Electronic device 3800 can be the same as or similar to robotic system 4800. Robotic system 4800 can include, but is not limited to, an autonomous vehicle with or without a payload. The payload can include, but is not limited to, an articulating arm.

Robotic system 4800 includes an engine or motor 4802 and various sensors 4804-4818 for measuring various parameters of the robotic system. The robotic system can include, but is not limited to, mobile platforms. The sensors may include, but are not limited to, an engine temperature sensor 4804, a battery voltage sensor 4806, an engine Rotations Per Minute (RPM) sensor 4808, a throttle position sensor 4810, a battery monitoring system 4812, motor current sensor 4814, motor voltage 4816 sensor, motor position sensors 4818, position sensors 4836, a speed sensor 4838, and/or an odometer sensor 4840. Each of the listed sensors are well known. The robotic system 4800 also may have a clock 4842 that the system uses to determine robotic system time during operation.

The robotic system 4800 also can include various sensors that operate to gather information about the environment in which the robotic system is traveling. These sensors may include, but are not limited to: a location sensor 4848; and image-based perception sensors 4862. The sensors also may include environmental sensors 4868. The image-based perception sensors may enable the robotic system to detect objects that are within a given distance range of the robotic system 600 in any direction, while the environmental sensors collect data about environmental conditions within the robotic system's area of travel.

The on-board computing device 4820 can be the same as or similar to computing device 2200 of FIG. 22 described above. The on-board computing device 620 may be configured to control: braking via a brake controller 4822; direction via a steering controller 4824; speed and acceleration via a throttle controller 4826 or a motor speed controller 4828; a differential gear controller 4830; and/or other controllers.

In view of the forgoing discussion, the present solution concerns implementing systems and methods for controlling operations of an electronic device. The methods comprise: obtaining, by a processor, a first artificial intelligence DNA structure and a second artificial intelligence DNA structure (wherein each of the first and second artificial intelligence DNA structures comprising at least one branch defined by data objects connected to each other by one or more links, at least one of said data objects in said branch specifying one or more actions of the electronic device that were determined by an ontogenesis engine in view of a stimuli or an impingement action); analyzing, by the processor, the first artificial intelligence DNA structure and the second artificial intelligence DNA structure to detect any differences therebetween; selectively editing, by the processor, the first artificial intelligence DNA structure based on the differences; using the first artificial intelligence DNA structure, which has been selectively edited, to control, modify or advance artificial intelligence operations of the ontogenesis engine; and/or controlling behavior of the electronic device in accordance with an output of the ontogenesis engine as a result from performance of the artificial intelligence operations using the first artificial intelligence DNA structure which was edited.

The first artificial intelligence DNA structure may comprise an artificial intelligence DNA structure fabricated by a DNA fabrication engine of the electronic device. The second artificial intelligence DNA structure may comprise another artificial intelligence DNA structure fabricated by the DNA fabrication engine, a simulated artificial intelligence DNA structure, or an artificial intelligence DNA structure received from another electronic device in a network of electronic devices.

The selectively editing may further be based on an expiration of a defined time period, a change in a course of action plan, a change in a security level of a course of action plan, or a change in an ethic or policy rule. The selectively editing may comprise: adding a copy of an entire branch from the second artificial intelligence DNA structure to the first artificial intelligence DNA structure as a new branch or as a new sub-branch of an existing branch; adding a copy of a portion of a branch from the second artificial intelligence DNA structure to the first artificial intelligence DNA structure as a new branch or as a sub-branch of an existing branch; adding a copy of a link from the second artificial intelligence DNA structure to the first artificial intelligence DNA structure as a new link; removing a branch or sub-branch from the first artificial intelligence DNA structure that corresponds to a branch or sub-branch in the second artificial intelligence DNA structure; removing a link from the first artificial intelligence DNA structure; modifying one or more growth demarcations for one or more branches or sub-branches in the first artificial intelligence DNA structure; adding edit demarcations to one or more branches, sub-branches and/or links of the first artificial intelligence DNA structure; changing an encryption algorithm for one or more branches or sub-branches in the first artificial intelligence DNA structure; and/or changing a behavior quality marking associated with one or more branches or sub-branches in the first artificial intelligence DNA structure.

The present solution also concerns a system comprising: a processor; and a non-transitory computer-readable storage medium comprising programming instructions that are configured to cause the processor to implement a method controlling operations of an electronic device. The programming instructions comprise instructions to: obtain a first artificial intelligence DNA structure and a second artificial intelligence DNA structure (wherein each of the first and second artificial intelligence DNA structures comprising at least one branch defined by data objects connected to each other by one or more links, at least one of said data objects in said branch specifying one or more actions of the electronic device that were determined by an ontogenesis engine in view of a stimuli or an impingement action); analyze the first artificial intelligence DNA structure and the second artificial intelligence DNA structure to detect any differences there between; selectively edit the first artificial intelligence DNA structure based on the differences; use the first artificial intelligence DNA structure, which has been selectively edited, to control, modify or advance artificial intelligence operations of the ontogenesis engine; and/or control behavior of the electronic device in accordance with an output of the ontogenesis engine as a result from performance of the artificial intelligence operations using the first artificial intelligence DNA structure which was edited.

The first artificial intelligence DNA structure may comprise an artificial intelligence DNA structure fabricated by a DNA fabrication engine of the electronic device. The second artificial intelligence DNA structure may comprise another artificial intelligence DNA structure fabricated by the DNA fabrication engine, a simulated artificial intelligence DNA structure, or an artificial intelligence DNA structure received from another electronic device in a network of electronic devices.

The first artificial intelligence DNA structure may be selectively edited based further on an expiration of defined time period, a change in a course of action plan, a change in a security level of a course of action plan, or a change in an ethic or policy rule. The first artificial intelligence DNA structure may be selectively edited by: adding a copy of an entire branch from the second artificial intelligence DNA structure to the first artificial intelligence DNA structure as a new branch or as a new sub-branch of an existing branch; adding a copy of a portion of a branch from the second artificial intelligence DNA structure to the first artificial intelligence DNA structure as a new branch or as a sub-branch of an existing branch; adding a copy of a link from the second artificial intelligence DNA structure to the first artificial intelligence DNA structure as a new link; removing a branch or sub-branch from the first artificial intelligence DNA structure that corresponds to a branch or sub-branch in the second artificial intelligence DNA structure; removing a link from the first artificial intelligence DNA structure; modifying one or more growth demarcations for one or more branches or sub-branches in the first artificial intelligence DNA structure; adding edit demarcations to one or more branches, sub-branches and/or links of the first artificial intelligence DNA structure; changing an encryption algorithm for one or more branches or sub-branches in the first artificial intelligence DNA structure; and/or changing a behavior quality marking associated with one or more branches or sub-branches in the first artificial intelligence DNA structure.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described scenarios. Rather, the scope of the present solution should be defined in accordance with the following claims and their equivalents.

We claim:

1. A method for controlling operations of an electronic device, comprising:
obtaining, by a processor, a first artificial intelligence DNA structure and a second artificial intelligence DNA structure, each of the first and second artificial intelligence DNA structures comprising at least one branch defined by data objects connected to each other by one or more links, at least one of said data objects in said branch specifying one or more actions of the electronic device that were determined by an ontogenesis engine in view of a stimuli or an impingement action;
analyzing, by the processor, the first artificial intelligence DNA structure and the second artificial intelligence DNA structure to detect any differences therebetween;
selectively editing, by the processor, the first artificial intelligence DNA structure based on the differences; and
using the first artificial intelligence DNA structure, which has been selectively edited, to control, modify or advance artificial intelligence operations of the ontogenesis engine.

2. The method according to claim 1, wherein the first artificial intelligence DNA structure comprises an artificial intelligence DNA structure fabricated by a DNA fabrication engine of the electronic device, and the second artificial intelligence DNA structure comprises another artificial intelligence DNA structure fabricated by the DNA fabrication engine, a simulated artificial intelligence DNA structure, or an artificial intelligence DNA structure received from another electronic device in a network of electronic devices.

3. The method according to claim 1, wherein the selectively editing is further based on an expiration of defined time period, a change in a mission plan, a change in a security level of a mission plan, or a change in an ethic or policy rule.

4. The method according to claim 1, wherein said selectively editing comprises adding a copy of an entire branch from the second artificial intelligence DNA structure to the first artificial intelligence DNA structure as a new branch or as a new sub-branch of an existing branch.

5. The method according to claim 1, wherein said selectively editing comprises adding a copy of a portion of a branch from the second artificial intelligence DNA structure to the first artificial intelligence DNA structure as a new branch or as a sub-branch of an existing branch.

6. The method according to claim 1, wherein said selectively editing comprises adding a copy of a link from the second artificial intelligence DNA structure to the first artificial intelligence DNA structure as a new link.

7. The method according to claim 1, wherein said selectively editing comprises removing or deprecating a branch or sub-branch from the first artificial intelligence DNA structure that corresponds to a branch or sub-branch in the second artificial intelligence DNA structure.

8. The method according to claim 1, wherein said selectively editing comprises removing a link from the first artificial intelligence DNA structure.

9. The method according to claim 1, wherein said selectively editing comprises: modifying one or more growth demarcations for one or more branches or sub-branches in the first artificial intelligence DNA structure; adding edit demarcations to one or more branches, sub-branches and/or links of the first artificial intelligence DNA structure; changing an encryption algorithm for one or more branches or sub-branches in the first artificial intelligence DNA structure; or changing a behavior quality marking associated with one or more branches or sub-branches in the first artificial intelligence DNA structure.

10. The method according to claim 1, further comprising controlling behavior of the electronic device in accordance with an output of the ontogenesis engine as a result from performance of the artificial intelligence operations using the first artificial intelligence DNA structure which was edited.

11. A system, comprising:
a processor;
a non-transitory computer-readable storage medium comprising programming instructions that are configured to cause the processor to implement a method controlling operations of an electronic device, wherein the programming instructions comprise instructions to:
obtain a first artificial intelligence DNA structure and a second artificial intelligence DNA structure, each of the first and second artificial intelligence DNA structures comprising at least one branch defined by data objects connected to each other by one or more links, at least one of said data objects in said branch specifying one or more actions of the electronic device that were determined by an ontogenesis engine in view of a stimuli or an impingement action;
analyze the first artificial intelligence DNA structure and the second artificial intelligence DNA structure to detect any differences therebetween;
selectively edit the first artificial intelligence DNA structure based on the differences; and
use the first artificial intelligence DNA structure, which has been selectively edited, to control, modify or advance artificial intelligence operations of the ontogenesis engine.

12. The system according to claim 11, wherein the first artificial intelligence DNA structure comprises an artificial intelligence DNA structure fabricated by a DNA fabrication engine of the electronic device, and the second artificial intelligence DNA structure comprises another artificial intelligence DNA structure fabricated by the DNA fabrication engine, a simulated artificial intelligence DNA structure, or an artificial intelligence DNA structure received from another electronic device in a network of electronic devices.

13. The system according to claim 11, wherein the first artificial intelligence DNA structure is selectively edited based further on an expiration of defined time period, a change in a mission plan, a change in a security level of a mission plan, or a change in an ethic or policy rule.

14. The system according to claim 11, wherein the first artificial intelligence DNA structure is selectively edited by adding a copy of an entire branch from the second artificial intelligence DNA structure to the first artificial intelligence DNA structure as a new branch or as a new sub-branch of an existing branch.

15. The system according to claim 11, wherein the first artificial intelligence DNA structure is selectively edited by adding a copy of a portion of a branch from the second artificial intelligence DNA structure to the first artificial intelligence DNA structure as a new branch or as a sub-branch of an existing branch.

16. The system according to claim 11, wherein the first artificial intelligence DNA structure is selectively edited by adding a copy of a link from the second artificial intelligence DNA structure to the first artificial intelligence DNA structure as a new link.

17. The system according to claim 11, wherein the first artificial intelligence DNA structure is selectively edited by removing or deprecating a branch or sub-branch from the first artificial intelligence DNA structure that corresponds to a branch or sub-branch in the second artificial intelligence DNA structure.

18. The system according to claim 11, wherein the first artificial intelligence DNA structure is selectively edited by removing a link from the first artificial intelligence DNA structure.

19. The system according to claim 11, wherein the first artificial intelligence DNA structure is selectively edited by: modifying one or more growth demarcations for one or more branches or sub-branches in the first artificial intelligence DNA structure; adding edit demarcations to one or more branches, sub-branches and/or links of the first artificial intelligence DNA structure; changing an encryption algorithm for one or more branches or sub-branches in the first artificial intelligence DNA structure; or changing a behavior quality marking associated with one or more branches or sub-branches in the first artificial intelligence DNA structure.

20. The system according to claim 11, wherein the programming instructions further comprise instructions to control behavior of the electronic device in accordance with an output of the ontogenesis engine as a result from performance of the artificial intelligence operations using the first artificial intelligence DNA structure which was edited.
